(19) United States
(12) Patent Application Publication
(10) Pub. No.: US 2026/0320052 A1
(43) Pub. Date: Oct. 15, 2026

(54) PROMPT ENRICHMENT USING A NETWORK GRAPH DATA STRUCTURE-BASED ARCHITECTURE FOR REDUCED HALLUCINATION OUTPUTS OF A LARGE LANGUAGE MODEL

(71) Applicant: Altana Technologies, Inc., Brooklyn, NY (US)

(72) Inventors: Evan Smith, New York, NY (US); Ian Cadieu, Stamford, CT (US); Peter Swartz, New York, NY (US); Vipul Pavan Gagrani, San Jose, CA (US); Alok Goel, San Mateo, CA (US); Annie Hao Dang, Brooklyn, NY (US)

(73) Assignee: Altana Technologies, Inc., Brooklyn, NY (US)

(21) Appl. No.: 19/641,444

(22) Filed: Apr. 7, 2026

Related U.S. Application Data
(60) Provisional application No. 63/786,083, filed on Apr. 9, 2025.

(51) Int. Cl. G06F 16/2455; G06F 16/28

(52) U.S. Cl. CPC G06F 16/2455; G06F 16/285

(57) ABSTRACT

Systems and methods for reduced hallucination classification by constraining a large language model based on a network graph data structure are disclosed. A server can include a network graph data structure, a classification model, a large language model, and a task agent in communication with the network graph data structure, the classification model, and the large language model. The server can be configured to receive a request comprising an identification of a networked item; execute the task agent to execute the classification model and the large language model to generate a composite set of candidate classification codes; retrieve a description of each candidate classification code of the composite set of candidate classification codes; execute the large language model to generate a selected candidate classification code; and update the network graph data structure based on the selected candidate classification code for the networked item.

### CROSS-REFERENCE TO APPLICATIONS

This application claims the benefit of priority to U.S. Provisional Application No. 63/786,083, filed Apr. 9, 2025, the entirety of each of which is incorporated by reference herein.

### BACKGROUND

Large Language Models (LLMs) are artificial intelligence systems trained on vast amounts of text data. They are capable of generating human-like text for many useful applications, including answering questions, summarizing articles, holding conversations, and generating content.

However, a common issue that arises with LLMs is known as a “hallucination.” Hallucinations occur when the model generates information or details that may seem believable but are actually incorrect, misrepresented, or entirely made up. This problem becomes more serious and frequent when the model is fed long, detailed, or complicated input instructions or context, such as when the model is fed large set of records from different data sources for classification. Instead of consistently relying solely on the input provided, the model may unintentionally produce false or misleading statements, making the information unreliable.

Hallucinations can lead to significant challenges, especially when LLMs are deployed in fields where accuracy is critical, such as value chain management and technical documentation. Mistakes or inaccuracies in these areas can lead to confusion and reduced trust in systems.

### SUMMARY

Conventional large language model (LLM) classification systems typically operate on unstructured textual inputs without incorporating real-time structured relational context from a network graph data structure. When a classification depends on the relationship of a given networked item to both a source node and a destination node, and on the broader node contexts in which those nodes reside, prior systems fail to extract and integrate this information into the model's inference process. Without this grounding, LLM outputs are prone to hallucinations, producing classifications that may be syntactically coherent but are factually incorrect. This absence of integrated, structured context leads to elevated misclassification rates and diminished trust in automated decision-making for workflows where accuracy is critical.

In certain embodiments described herein, a computing system resolves these deficiencies by executing a task agent to traverse a network graph in real time to identify a networked item's corresponding source node, destination node, and surrounding node contexts, assembling this graph-derived context into a structured prompt. The prompt, containing textual descriptions and contextual identifiers, is transmitted to the large language model, which generates both a classification and a confidence score for the networked item. The computing system evaluates the score against thresholds to determine whether to output the classification in a user interface or to seek supplemental item characteristics from external sources for re-classification. In some cases, the computing system stores misclassification records and retrains the large language model using the feedback data. By embedding structured, verifiable graph relationships into LLM prompts and coupling them with confidence-based output control, the disclosed embodiments materially reduce hallucinations and deliver accurate, contextually grounded classifications, thereby providing a concrete technical improvement over prior large language model classification techniques.

In some aspects, the techniques described herein relate to a system for classification by constraining a large language model based on a network graph data structure for reduced hallucinations, including: a server including, in memory: a network graph data structure storing a network of nodes and edges between the network of nodes, the network graph data structure digitally representing types of relationships between entities represented by the network of nodes and networked items, the network of nodes including pairs of nodes each including a source node connected with a destination node by an edge data structure including at least a classification for a particular networked item transferred from the source node to the destination node; a large language model trained based at least on identifications of the pairs of nodes and the classifications for the particular networked items from the edge data structures of the pairs of nodes in the network graph data structure; and a task agent in communication with the network graph data structure and the large language model; and the server configured to: receive, from a computing device, a request including an identification of a networked item; execute the task agent to: identify, using the identification of the networked item, one or more sub-graph data structures of nodes each corresponding to the networked item and connected by a set of edges from a plurality of sub-graph data structures stored in a network graph data structure; perform a query through one or more edges of each of the one or more sub-graph data structures of nodes to identify a source node and a destination node for the networked item, the networked item transferring from the source node to the destination node; generate a prompt including features of the networked item including a text description of the networked item and identifiers of the source node and the destination node for the networked item; execute the large language model using the prompt to generate a classification and a confidence score for the classification; and based on the confidence score for the classification, generate a user interface identifying the classification and the networked item for presentation at the computing device.

In some aspects, the techniques described herein relate to a system, wherein the server is further configured to: identify a source node context including identifications of one or more nodes connected with the source node and a destination node context including identifications of one or more nodes connected with the destination node; and generate the prompt by inserting the source node context and the destination node context into the prompt for input into the large language model. In some aspects, the techniques described herein relate to a system, wherein the server is further configured to: train the large language model to generate confidence scores for classifications of networked items based on a training data set including identifications of source nodes and destination nodes for networked items identified from the network graph data structure and labels indicating classifications for the networked items.

In some aspects, the techniques described herein relate to a system, wherein the server is further configured to: add an edge between a first node and a second node in the network graph data structure indicating the first node is a source node for a transport of a networked item to the second node as a destination node; and retrain the large language model using identifications of the first node and the second node and a classification for the networked item.

In some aspects, the techniques described herein relate to a system, wherein the server is further configured to: train the large language model to generate confidence scores for classifications of networked items based on a training data set including identifications of edges between the source node and a first set of nodes of a first sub-graph data structure and edges between the destination node and a second set of nodes of a second sub-graph data structure. In some aspects, the techniques described herein relate to a system, wherein the server is further configured to: identify the source node and the destination node from the network graph data structure based on both nodes sharing an edge with a networked item node representing the networked item.

In some aspects, the techniques described herein relate to a system, wherein the server is further configured to: determine that the confidence score for the classification exceeds a threshold; and generate the user interface identifying the classification and the networked item for presentation at the computing device in response to the determination. In some aspects, the techniques described herein relate to a system, wherein the server is further configured to: execute the large language model using the prompt to generate confidence scores for a plurality of classifications; and select the classification for the networked item based on the confidence score satisfying a criterion relative to the other confidence scores.

In some aspects, the techniques described herein relate to a system, wherein the server is further configured to: determine that the confidence score for the classification is less than a threshold; execute a search engine across the Internet using the identifier of the networked item to retrieve one or more characteristics of the networked item; and generate the prompt by inserting the retrieved characteristics into the prompt for input into the large language model. In some aspects, the techniques described herein relate to a system, wherein the server is further configured to: determine that a vagueness score for the text description of the networked item is less than a threshold; execute a search engine across the Internet using the identifier of the networked item to retrieve one or more characteristics of the networked item; and generate the prompt by inserting the retrieved characteristics into the prompt for input into the large language model.

In some aspects, the techniques described herein relate to a system, wherein the server is further configured to: receive a set of descriptions of networked items and corresponding classifications; and train the large language model using the set of descriptions and classifications. In some aspects, the techniques described herein relate to a system, wherein the server is further configured to: determine that a classification prediction for a historical networked item transport was a misclassification; store a record of the classification prediction, the cause of the prediction, and an indication of the misclassification in a database; and execute the large language model using the prompt to generate the confidence score for the classification based on the stored indication of the misclassification.

In some aspects, the techniques described herein relate to a system, wherein the server is further configured to: determine identify one or more features of the networked item and one or more electronic records stored in a retrieval augmented generation database that, in combination, had a positive impact on the generated classification of the networked item; and generate the user interface to include the identified one or more features and identifications of the one or more or more electronic records. In some aspects, the techniques described herein relate to a method for classification using a large language model based on a network graph data structure, including: receiving, by one or more processors from a computing device, a request including an identification of a networked item; identifying, by the one or more processors using the identification of the networked item, one or more sub-graph data structures of nodes each corresponding to the networked item and connected by a set of edges from a plurality of sub-graph data structures stored in a network graph data structure, the network graph data structure including a graph data structure storing a network of nodes and edges between the network of nodes digitally representing types of relationships between entities represented by the network of nodes and networked items; performing, by the one or more processors, a query through one or more edges of each of the one or more sub-graph data structures of nodes to identify a source node and a destination node for the networked item, the networked item transferred from the source node to the destination node; generating, by the one or more processors, a prompt including features of the networked item including a text description of the networked item and identifiers of the source node and the destination node for the networked item; executing, by the one or more processors, a large language model using the prompt to generate a classification and a confidence score for the classification; and based on the confidence score for the classification, generating, by the one or more processors, a user interface identifying the classification and the networked item for presentation at the computing device.

In some aspects, the techniques described herein relate to a method, wherein performing the query includes: identifying, by the one or more processors, a source node context including identifications of one or more nodes connected with the source node and a destination node context including identifications of one or more nodes connected with the destination node; and wherein generating the prompt includes inserting, by the one or more processors, the source node context and the destination node context into the prompt for input into the large language model. In some aspects, the techniques described herein relate to a method, further including: training, by the one or more processors, the large language model to generate confidence scores for classifications for networked items based on a training data set including identifications of source nodes and destination nodes for networked items identified from the network graph data structure and labels indicating classifications for the networked items.

In some aspects, the techniques described herein relate to a method, further including: subsequent to training the large language model, adding, by the one or more processors, an edge between a first node of the network graph data structure and a second node of the network graph data structure indicating the first node is a first source node for a first transport of a first networked item to the second node as a first destination node; and responsive to the addition, retraining, by the one or more processors, the large language model using identifications of the first node and the second node and a first classification for the first networked item. In some aspects, the techniques described herein relate to a method, further including: training, by the one or more processors, the large language model to generate confidence scores for classifications for networked items based on a training data set including identifications of edges between the source node and a first set of nodes of a first sub-graph data structure generated for the source node and edges between the destination node and a second set of nodes of a second sub-graph data structure generated for the destination node.

In some aspects, the techniques described herein relate to non-transitory computer-readable media storing instructions that, when executed by one or more processors of a server including a network graph data structure, a large language model, and a task agent, cause the server to: receive, from a computing device, a request including an identification of a networked item; identify, using the identification of the networked item, one or more sub-graph data structures of nodes each corresponding to the networked item and connected by a set of edges from a plurality of sub-graph data structures stored in the network graph data structure, the network of nodes including pairs of nodes each including a source node connected with a destination node by an edge data structure including at least a classification for a particular networked item being transported from the source node to the destination node; perform a query through one or more edges of each of the one or more sub-graph data structures of nodes to identify a source node and a destination node for the networked item; identify a source node context including identifications of one or more nodes connected with the source node and a destination node context including identifications of one or more nodes connected with the destination node; generate a prompt including features of the networked item including a text description of the networked item, identifiers of the source node and the destination node, and the source node context and destination node context; execute the large language model using the prompt to generate a classification and a confidence score for the classification; and based on the confidence score, generate a user interface identifying the classification and the networked item for presentation at the computing device.

In some aspects, the techniques described herein relate to a non-transitory computer-readable media, wherein execution of the instructions further cause the server to: identify a source node context including identifications of one or more nodes connected with the source node and a destination node context including identifications of one or more nodes connected with the destination node; and generate the prompt by inserting the source node context and the destination node context into the prompt for input into the large language model. In some aspects, the techniques described herein relate to a system for reduced hallucination classification by constraining a large language model based on a network graph data structure, including: a server including, in memory: a network graph data structure storing a network of nodes and edges between the network of nodes, the network graph data structure digitally representing types of relationships between entities represented by the network of nodes and networked items, the network of nodes including pairs of nodes each including a source node connected with a destination node by an edge data structure including at least a classification for a particular networked item transferred from a source entity of the source node to a destination entity of the destination node; a classification model configured to generate candidate classification codes for networked items based at least on identifications of the networked items; a large language model trained based at least on identifications of the pairs of nodes and the classifications for the particular networked items from the edge data structure of each of the pairs of nodes in the network graph data structure; and a task agent in communication with the network graph data structure, the classification model, and the large language model; and the server configured to: receive, from a computing device, a request including an identification of a networked item; execute the task agent to: execute the classification model using the identification of the networked item as input to generate a first set of candidate classification codes; execute the large language model using the identification of the networked item to generate a second set of candidate classification codes; generate a composite set of candidate classification codes using the first set of candidate classification codes and the second set of candidate classification codes; retrieve a description of each candidate classification code of the composite set of candidate classification codes from a database; execute the large language model using the composite set of candidate classification codes and the retrieved description of each candidate classification code of the composite set of candidate classification codes to generate a selected candidate classification code from the composite set of candidate classification codes; and update the network graph data structure to identify the selected candidate classification code for the networked item.

In some aspects, the techniques described herein relate to a system, wherein the classification model is a dual encoder architecture, wherein the server is configured to receive the request by: receiving the request including the identification of the networked item, an identification of a source node and a destination node of a pair of nodes of a network operation involving the networked item, and a text description of the networked item, and wherein the server is configured to execute the task agent to execute the dual encoder architecture and execute the large language model each using the identification of the networked item, the identification of the source node and the destination node of the pair of nodes of the network operation involving the networked item, and the text description of the networked item.

In some aspects, the techniques described herein relate to a system, wherein the server is configured to execute the task agent to: execute a querying agent using the identification of the networked item to identify an edge data structure in the network graph data structure corresponding to a network operation involving the networked item between a source node and a destination node of a pair of nodes of the network graph data structure; identify, based on the execution and from the identified edge data structure, an identification of the source node and the destination node of the pair of nodes of the network operation involving the networked item, and a text description of the networked item; and wherein the server is configured to execute the task agent to execute the classification model and execute the large language model each using the identification of the networked item, the identification of the source node and the destination node of the pair of nodes of the network operation involving the networked item, and the text description of the networked item.

In some aspects, the techniques described herein relate to a system, wherein the server is configured to execute the task agent to execute the large language model to generate the selected candidate classification code by executing the task agent to: execute the large language model using the composite set of candidate classification codes and the retrieved description of each of candidate classification code of the composite set of candidate classification codes to generate a first candidate classification code at a first layer of a plurality of defined layers of a hierarchical data structure; determine to generate a second candidate classification code at a second layer of the plurality of defined layers of the hierarchical data structure; responsive to the determination, generate a second composite set of candidate classification codes using a second classification model and the large language model using the identification of the networked item, each of second composite set of candidate classification codes corresponding to the second layer of the plurality of defined layers of the hierarchical data structure; and execute the large language model using the second composite set of candidate classification codes to generate the selected candidate classification code.

In some aspects, the techniques described herein relate to a system, wherein the server is configured to execute the task agent to determine to generate the second candidate classification code by executing the task agent to: determine a layer of the hierarchical data structure that corresponds to an entity of the computing device; and determine the layer of the hierarchical data structure is higher than the first layer of the first candidate classification code.

In some aspects, the techniques described herein relate to a system, wherein the server is configured to execute the task agent to execute the large language model to generate the selected candidate classification code by executing the task agent to: iteratively generate candidate classification codes for the networked item at increasing layers of the hierarchical data structure until determining a current layer of the generated candidate classification code is at the layer of the hierarchical data structure that corresponds to the entity of the computing device.

In some aspects, the techniques described herein relate to a system, wherein the server is configured to execute the task agent to execute the large language model to generate the selected candidate classification code by executing the task agent to: execute, through a large language model application programming interface (API), the large language model using the composite set of candidate classification codes and the retrieved description of each of candidate classification code of the composite set of candidate classification codes as input to generate a question requesting more information about the networked item based on a determination by the large language model that a classification code could not be selected based on the input; receive data including the question from the large language model through the large language model API; responsive to determining the data includes the question instead of a selected classification code, transmit the question for presentation on a user interface presented at the computing device; receive the requested more information from the user interface of the computing device; and re-execute the large language model using the received requested more information, the composite set of candidate classification codes, and the retrieved description of each of candidate classification code of the composite set of candidate classification codes to generate the selected candidate classification code.

In some aspects, the techniques described herein relate to a system, wherein the server is configured to execute the task agent to re-execute the large language model using the requested more information and one or more messages previously generated by the large language model in a transcript of messages generated by and input into the large language model regarding generating the selected candidate classification code.

In some aspects, the techniques described herein relate to a system, wherein the server is configured to execute the task agent to update the network graph data structure by: identifying an edge data structure corresponding to a network operation involving the networked item; and inserting the selected candidate classification code in a field-value pair of the edge data structure corresponding to classification codes.

In some aspects, the techniques described herein relate to a system, wherein the server is configured to execute the task agent to update the network graph data structure by: identifying the field-value pair of the edge data structure based on the field-value pair corresponding to a layer of a plurality of defined layers of a hierarchical data structure that corresponds to an entity of the computing device.

In some aspects, the techniques described herein relate to a system, wherein the server is configured to execute the task agent to generate the composite set of candidate classification codes by: concatenating the first set of candidate classification codes and the second set of candidate classification codes into a prompt text string; and wherein the server is configured to execute the task agent to provide the prompt text string into the large language model through a large language model application programming interface (API).

In some aspects, the techniques described herein relate to a system, wherein the server is configured to execute the task agent to generate the composite set of candidate classification codes by: identifying a set of common candidate classification codes between the first set of candidate classification codes and the second set of candidate classification codes and a set of unique candidate classification codes between the first set of candidate classification codes and the second set of candidate classification codes; and only including the unique candidate classification codes between the first set of candidate classification codes and the second set of candidate classification codes in the composite set of candidate classification codes.

In some aspects, the techniques described herein relate to a system, wherein the server is configured to receive the request by: receiving the request including the identification of the networked item and an identification of a geographic location, and wherein the server is configured to execute the task agent to execute the classification model and execute the large language model each using the identification of the networked item and the identification of the geographic location.

In some aspects, the techniques described herein relate to a system, wherein the server is further configured to: determine that a classification prediction for a historical networked item transport was a misclassification; store a record of the classification prediction, the cause of the prediction, and an indication of the misclassification in a database; and execute the large language model using the composite set of candidate classification codes and the retrieved description of each candidate classification code, or the classification model using the identification of the networked item as input, based on the stored indication of the misclassification.

In some aspects, the techniques described herein relate to a method for reduced hallucination classification using a large language model based on a network graph data structure, including: receiving, by one or more processors from a computing device, a request including an identification of a networked item; executing, by the one or more processors executing a task agent in communication with the network graph data structure, the classification model, and the large language model, a classification model using the identification of the networked item as input to generate a first set of candidate classification codes for the networked item, the classification model configured to generate candidate classification codes for networked items based at least on identifications of the networked items; executing, by the one or more processors executing the task agent, a large language model using the identification of the networked item to generate a second set of candidate classification codes for the networked item, the large language model trained based at least on identifications of pairs of nodes and classifications for particular networked items from edge data structure of each of the pairs of nodes in a network graph data structure; generating, by the one or more processors executing the task agent, a composite set of candidate classification codes using the first set of candidate classification codes and the second set of candidate classification codes; retrieving, by the one or more processors executing the task agent, a description of each candidate classification code of the composite set of candidate classification codes from a database; executing, by the one or more processors executing the task agent, the large language model using the composite set of candidate classification codes and the retrieved description of each of candidate classification code of the composite set of candidate classification codes to generate a selected candidate classification code from the composite set of candidate classification codes; and updating, by the one or more processors executing the task agent, the network graph data structure to identify the selected candidate classification code for the networked item.

In some aspects, the techniques described herein relate to a method, wherein receiving the request includes: receiving, by the one or more processors, the request including the identification of the networked item, an identification of a source node and a destination node of a pair of nodes of a network operation involving the networked item, and a text description of the networked item, and wherein executing the task agent to execute the classification model and execute the large language model includes executing the task agent to execute the classification model and execute the large language model each using the identification of the networked item, the identification of the source node and the destination node of the pair of nodes of the network operation involving the networked item, and the text description of the networked item.

In some aspects, the techniques described herein relate to a method, includes executing the task agent to: execute a querying agent using the identification of the networked item to identify an edge data structure in the network graph data structure corresponding to a network operation involving the networked item between a source node and a destination node of a pair of nodes of the network graph data structure; identify, based on the execution of the querying agent and from the identified edge data structure, an identification of the source node and the destination node of the pair of nodes of the network operation involving the networked item, and a text description of the networked item; and wherein executing the task agent to execute the classification model and execute the large language model includes executing the task agent to execute the classification model and execute the large language model each using the identification of the networked item, the identification of the source node and the destination node of the pair of nodes of the network operation involving the networked item, and the text description of the networked item.

In some aspects, the techniques described herein relate to a method, wherein executing the task agent to execute the large language model to generate the selected candidate classification code includes executing the task agent to: execute the large language model using the composite set of candidate classification codes and the retrieved description of each of candidate classification code of the composite set of candidate classification codes to generate a first candidate classification code at a first layer of a plurality of defined layers of a hierarchical data structure; determine to generate a second candidate classification code at a second layer of the plurality of defined layers of the hierarchical data structure; responsive to the determination, generate a second composite set of candidate classification codes using a second classification model and the large language model using the identification of the networked item, each of second composite set of candidate classification codes corresponding to the second layer of the plurality of defined layers of the hierarchical data structure; and execute the large language model using the second composite set of candidate classification codes to generate the selected candidate classification code.

In some aspects, the techniques described herein relate to a non-transitory computer-readable medium including instructions that, when executed by one or more processors, cause the one or more processors to: receive, from a computing device, a request including an identification of a networked item; execute a task agent in communication with a network graph data structure, a classification model, and a large language model, to: execute the classification model using the identification of the networked item as input to generate a first set of candidate classification codes for the networked item, the classification model configured to generate candidate classification codes for networked items based at least on identifications of the networked items; executing, by the one or more processors executing the task agent, the large language model using the identification of the networked item to generate a second set of candidate classification codes for the networked item, the large language model trained based at least on identifications of pairs of nodes and classifications for particular networked items from edge data structure of each of the pairs of nodes in a network graph data structure; generate a composite set of candidate classification codes using the first set of candidate classification codes and the second set of candidate classification codes; retrieve a description of each candidate classification code of the composite set of candidate classification codes from a database; execute the large language model using the composite set of candidate classification codes and the retrieved description of each of candidate classification code of the composite set of candidate classification codes to generate a selected candidate classification code from the composite set of candidate classification codes; and update the network graph data structure to identify the selected candidate classification code for the networked item.

In some aspects, the techniques described herein relate to a non-transitory computer-readable medium, wherein executing the instructions causes the one or more processors to receive the request by: receiving the request including the identification of the networked item, an identification of a source node and a destination node of a pair of nodes of a network operation involving the networked item, and a text description of the networked item, and wherein executing the instructions causes the one or more processors to execute the task agent to execute the classification model and execute the large language model includes executing the task agent to execute the classification model and execute the large language model each using the identification of the networked item, the identification of the source node and the destination node of the pair of nodes of the network operation involving the networked item, and the text description of the networked item.

### BRIEF DESCRIPTION OF THE DRAWINGS

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles, and concepts. The drawings are not intended to limit the scope of the claims included herewith.

FIG. 1A illustrates an example block diagram depicting a computing device, in accordance with one or more embodiments.

FIG. 1B illustrates an example block diagram depicting a computing environment comprising a client device in communication with cloud service providers, in accordance with one or more embodiments.

FIG. 2A illustrates an example block diagram depicting a system using supervised learning, in accordance with one or more embodiments.

FIG. 2B illustrates an example block diagram depicting a simplified neural network model, in accordance with one or more embodiments.

FIG. 3A is an illustration of an example system for network graph data structure-based transportation networking, in accordance with an implementation.

FIG. 3B illustrates an example network graph data structure, in accordance with an implementation.

FIG. 3C illustrates example sub-graph data structures of the example network graph data structure of FIG. 3B, in accordance with an implementation.

FIG. 3D illustrates an example sub-graph data structure of the example network graph data structure of FIG. 3B, in accordance with one or more embodiments.

FIG. 3E illustrates a hub and spoke infrastructure for managing a network graph data structure that allows sharing of insights without transmission of sensitive data, in accordance with one or more embodiments.

FIG. 3F illustrates an example flowchart of a process for network graph data structure-based transportation networking, in accordance with an implementation.

FIG. 4A illustrates an example sequence of classification using a network graph data structure, in accordance with one or more embodiments.

FIG. 4B illustrates another example sequence of classification using a network graph data structure, in accordance with one or more embodiments.

FIG. 4C illustrates an example flowchart of a process for classification using a network graph data structure, in accordance with an implementation.

4D-4I illustrate example sequences of classification using a network graph data structure, in accordance with one or more embodiments.

FIGS. 4J-4DD illustrate example user interfaces for classification using a network graph data structure, in accordance with one or more embodiments.

FIG. 4EE illustrates an example flowchart of a process for classification using a network graph data structure, in accordance with an implementation.

### DETAILED DESCRIPTION

For purposes of reading the description of the various embodiments below, the following descriptions of the sections of the specification and their respective contents can be helpful:
Section A describes a computing environment and network environment that can be useful for practicing embodiments described herein.
Section B describes an artificial intelligence environment that can be useful for practicing embodiments described herein.
Section C describes a computing system for network graph data structure-based transportation networking in accordance with embodiments described herein.
Section D describes systems and methods for classification using network graph data structure-based prompt generation for a large language model in accordance with embodiments described herein.

### A. Computing and Network Environment

Prior to discussing the specifics of embodiments of dynamic management of a network graph data structure for value chain management, it may be helpful to discuss the computing environments in which such embodiments may be deployed.

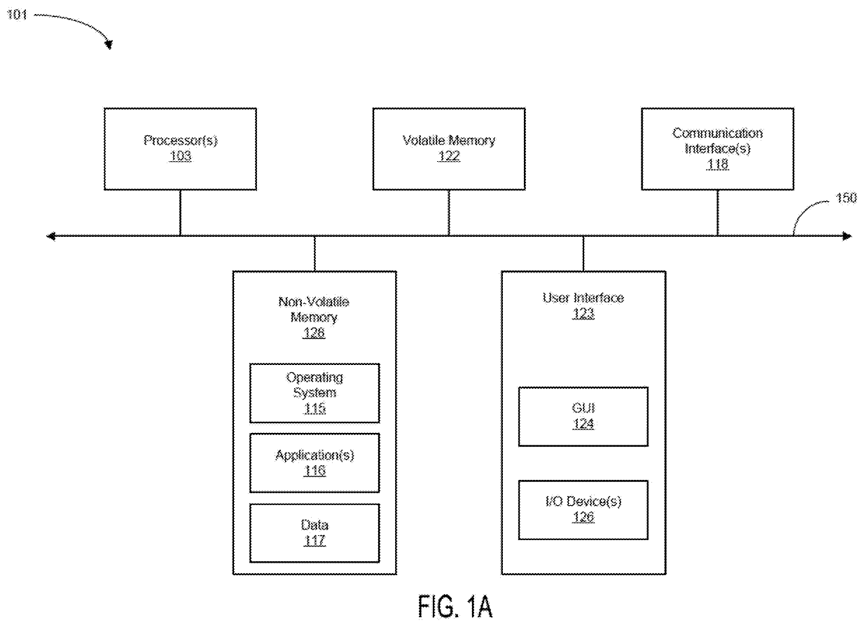

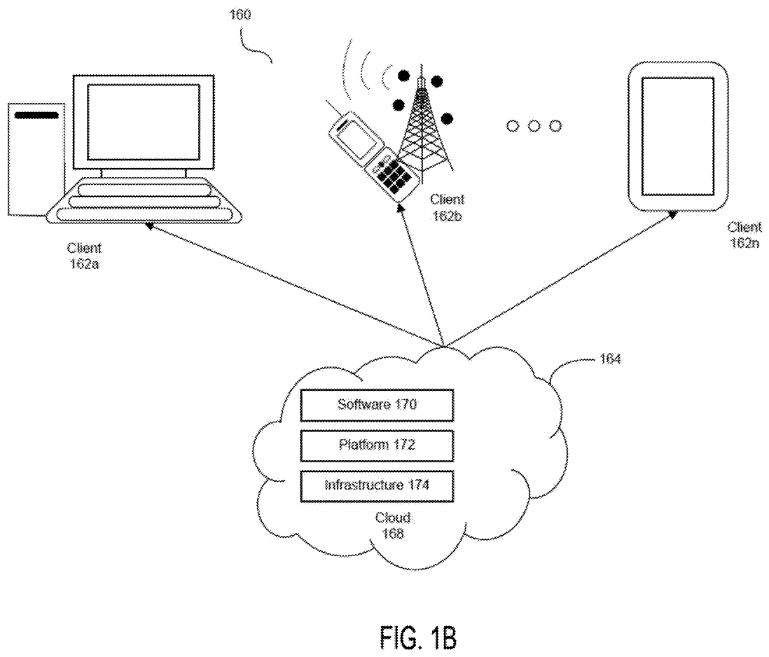

As shown in FIG. 1A, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 162 with one or more resources provided by a network environment. The computing environment 162 may include one or more clients 162a-162n, in communication with a cloud 168 over one or more networks 164. Clients 162 may include, e.g., thick clients, thin clients, and zero clients. The cloud 108 may include back end platforms, e.g., servers 106, storage, server farms or data centers. The clients 162 can be the same as or substantially similar to computer 101 of FIG. 1A.

The users or clients 162 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 108 may be public, private, or hybrid. Public clouds 108 may include public servers that are maintained by third parties to the clients 162 or the owners of the clients 162. The servers may be located off-site in remote geographical locations as disclosed above or otherwise. Public clouds 168 may be connected to the servers over a public network 164. Private clouds 168 may include private servers that are physically maintained by clients 162 or owners of clients 162. Private clouds 168 may be connected to the servers over a private network 164. Hybrid clouds 168 may include both the private and public networks 164 and servers.

The cloud 168 may include back end platforms, e.g., servers, storage, server farms or data centers. For example, the cloud 168 can include or correspond to a server or system remote from one or more clients 162 to provide third party control over a pool of shared services and resources. The computing environment 160 can provide resource pooling to serve multiple users via clients 162 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 162. The computing environment 160 can provide an elasticity to dynamically scale out or scale in responsive to different demands from one or more clients 162. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include serverless computing. The computing environment 160 can include Software as a service (SaaS). For example, the cloud 168 may also include a cloud based delivery, e.g., Software as a Service (SaaS) 170, Platform as a Service (PaaS) 172, and Infrastructure as a Service (IaaS) 174. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 162 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 162 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 162 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, California). Clients 162 may also access SaaS resources through smartphone or tablet applications, including, e.g., Salesforce Sales Cloud, or Google Drive app. Clients 162 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Artificial Intelligence Environment

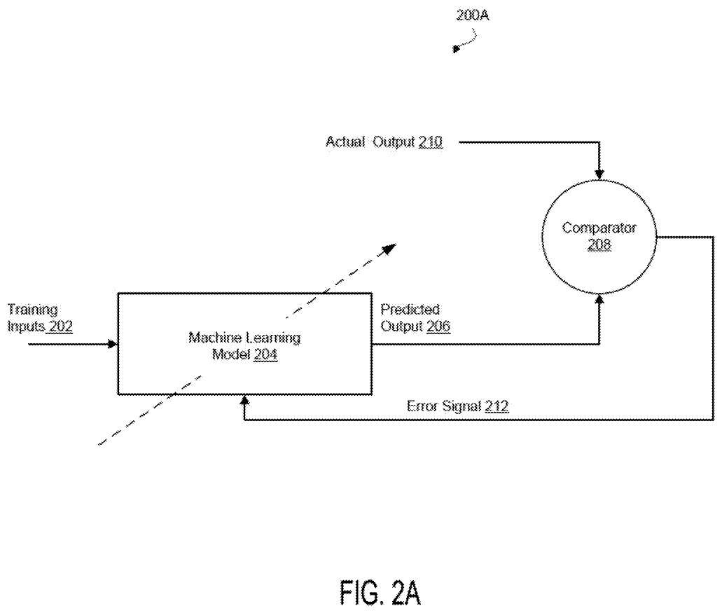

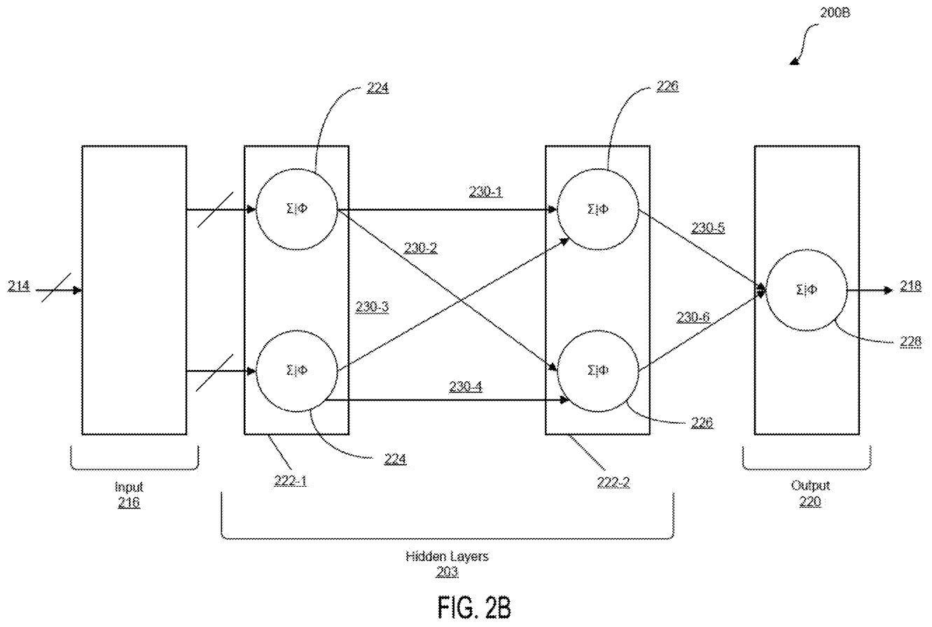

Referring to FIG. 2A, an embodiment of an artificial intelligence environment 200A is depicted. The artificial intelligence environment 200A may incorporate various machine learning models to process data, identify patterns, and generate predictions or decisions. By way of example, machine learning models can comprise supervised learning models, clustering models, neural network models, deep learning models, reinforcement learning models, unsupervised models, decision trees, support-vector machines, Bayesian networks, Gaussian processes, genetic algorithms models, generative models, image and text processing models, video processing models, any other models that can be used by one or more machine learning algorithms, any other models that can learn from data (e.g., training data) to perform tasks without explicit instructions, or various combinations thereof. They can also involve combinations of the above and agentic systems that leverage models and underlying data. The neural network models can comprise, for example and without limitation, artificial neural networks (ANNs), deep neural networks (DNNs), deep belief networks (DBNs), one or more language models, large language models (LLMs), attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), any other models that can learn patterns and make predictions or decisions, or various combinations thereof.

The machine learning models can be configured, learned, or trained using various learning or training operations, such as unsupervised learning, weakly supervised learning, semi-supervised learning, supervised learning, or any other learning or training operations that can learn from data (e.g., training data) and generalize to unseen data, or various combinations thereof. For example, parameters of nodes of a neural network model, such as weights, biases, and/or thresholds, can be configured, learned, or trained using various learning or training operations, such as unsupervised learning, weakly supervised learning, semi-supervised learning, or supervised learning. A machine learning model can be configured using training data from various domain-agnostic and/or domain-specific data sources. The training data can include a plurality of training data elements (e.g., training data instances). Each training data element can be arranged in structured or unstructured formats; for example, the training data element can include an example output mapped to an example input. The training data can include data that is not separated into input and output subsets (e.g., for configuring the machine learning model to perform clustering, classification, or other unsupervised machine learning operations). The training data can include data describing network structure, such as a supply chain network, and the greater network situation of a given observation. The training data can include human-labeled information, including but not limited to feedback regarding outputs of the machine learning model, which can allow the machine learning model to generate more human-like outputs.

Referring back to FIG. 2A, a block diagram of an example system using supervised learning is shown. Supervised learning is a method of training a machine learning model given input-output pairs. An input-output pair is an input with an associated known output (e.g., an expected output).

Machine learning model 204 may be trained on known input-output pairs such that the machine learning model 204 can learn how to predict known outputs given known inputs. Once the machine learning model 204 has learned how to predict known input-output pairs, the machine learning model 204 can operate on unknown inputs to predict an output.

The machine learning model 204 may be trained based on general data and/or granular data (e.g., data based on a specific user 132) such that the machine learning model 204 may be trained specific to a particular user 132.

Training inputs 202 and actual outputs 210 may be provided to the machine learning model 204. Training inputs 202 may include features such as numerical data, categorical variables, text, images, audio signals, and the like.

The inputs 202 and actual outputs 210 may be received from various data repositories. For example, a data repository may contain labeled datasets with example data points and their corresponding correct outputs. The data repository may also contain data associated with specific users or general populations. Thus, the machine learning model 204 may be trained to predict outcomes based on the training inputs 202 and actual outputs 210 used to train the machine learning model 204.

The example system may include one or more machine learning models 204. In an embodiment, a first machine learning model 204 may be trained to predict data using a classification or regression technique. For example, the first machine learning model 204 may use the training inputs 202 to predict outputs 206 by applying the current state of the first machine learning model 204 to the training inputs 202. The comparator 208 may compare the predicted outputs 206 to actual outputs 210 to determine an amount of error or differences. For example, the predicted output 206 may be compared to the actual output 210 to calculate a loss function or error metric.

In other embodiments, a second machine learning model 204 may be trained to make one or more recommendations to the user 132 based on the predicted output from the first machine learning model 204. For example, the second machine learning model 204 may use the training inputs 202 and the predicted outputs from the first machine learning model 204 as its own input to predict outputs 206 in the form of personalized recommendations by applying the current state of the second machine learning model 204 to the training inputs 202. The comparator 208 may compare the predicted outputs 206 (e.g., the recommended actions or networked items) to actual outputs 210 (e.g., user choices or feedback on previous recommendations to determine an amount of error or differences.

The actual outputs 210 may be determined based on historic data of recommendations made to the user 132 and the resulting outcomes in the supply chain. In an illustrative non-limiting example, the machine learning model 204 may be continuously trained to improve its quality and accuracy in predicting and improving supply chain operations. The machine learning model 204 can take into account various inputs such as forecasted demand, inventory data, customer preferences, and distributor preferences to model, recommend, and execute operations. The actual outputs 210 may then be determined by measuring the real-world outcomes after implementing these recommendations, such as the resulting stockout rate, inventory carrying costs, and overall supply chain efficiency.

In some embodiments, a single machine learning model 204 may be trained to make one or more recommendations to the user 132 based on current user 132 data received from enterprise resources 128. That is, a single machine learning model may be trained using the training inputs 202, which include historical data and current user data, to predict outputs 206 in the form of personalized recommendations by applying the current state of the machine learning model 204 to the training inputs 202. The comparator 208 may compare the predicted outputs 206 to actual outputs 210 to determine an amount of error or differences. The actual outputs 210 may be determined based on historic data associated with the recommendation to the user 132 and their subsequent actions or outcomes. The machine learning model 204 may use the data to learn patterns and make increasingly accurate recommendations over time. For instance, if the machine learning model 204 recommends ordering 1000 units of a product and a user 132 follows the recommendation, the actual output 210 may include data on whether the quantity was sufficient, excessive, or inadequate based on subsequent demand and inventory levels. This feedback loop can allow the machine learning model 204 to continuously refine its predictions and adapt to changing conditions and user preferences in the supply chain ecosystem.

During training, the error (represented by error signal 212) determined by the comparator 208 may be used to adjust the weights in the machine learning model 204 such that the machine learning model 204 changes (or learns) over time. The machine learning model 204 may be trained using a backpropagation algorithm, for instance. The backpropagation algorithm operates by propagating the error signal 212. The error signal 212 may be calculated each iteration (e.g., each pair of training inputs 202 and associated actual outputs 210), batch and/or epoch, and propagated through the algorithmic weights in the machine learning model 204 such that the algorithmic weights adapt based on the amount of error. The error is minimized using a loss function. Non-limiting examples of loss functions may include the square error function, the root mean square error function, and/or the cross entropy error function.

The weighting coefficients of the machine learning model 204 may be tuned to reduce the amount of error, thereby minimizing the differences between (or otherwise converging) the predicted output 206 and the actual output 210. The machine learning model 204 may be trained until the error determined at the comparator 208 is within a certain threshold (or a threshold number of batches, epochs, or iterations have been reached). The trained machine learning model 204 and associated weighting coefficients may subsequently be stored in memory 116 or other data repository (e.g., a database) such that the machine learning model 204 may be employed on unknown data (e.g., not training inputs 202). Once trained and validated, the machine learning model 204 may be employed during a testing (or an inference) phase. During testing, the machine learning model 204 may ingest unknown data to predict future data (e.g., future demand, inventory levels, supplier performance, delivery times, and the like).

Referring to FIG. 2B, a block diagram of a simplified neural network model 200B is shown. The neural network model 200B is only an example architecture. The neural network 200B can be any type of neural network, such as a feedforward neural network, a recurrent neural network, a convolutional neural network, a long short-term memory neural network, etc. The neural network model 200B may include a stack of distinct layers (vertically oriented) that transform a variable number of inputs 214 being ingested by an input layer 216 into an output 218 at the output layer 220.

The neural network model 200B may include a number of hidden layers 222 between the input layer 216 and output layer 220. Each hidden layer has a respective number of nodes (224, 226, and 228). In the neural network model 200B, the first hidden layer 222-1 has nodes 224, and the second hidden layer 222-2 has nodes 226. The nodes 224 and 226 perform a particular computation and are interconnected to the nodes of adjacent layers (e.g., nodes 224 in the first hidden layer 222-1 are connected to nodes 226 in a second hidden layer 222-2, and nodes 226 in the second hidden layer 222-2 are connected to nodes 228 in the output layer 220). Each of the nodes (224, 226, and 228) sum up the values from adjacent nodes and apply an activation function, allowing the neural network model 200B to detect nonlinear patterns in the inputs 214. Each of the nodes (224, 226, and 228) are interconnected by weights 230-1, 230-2, 230-3, 230-4, 230-5, 230-6 (collectively referred to as weights 230). Weights 230 are tuned during training to adjust the strength of the node. The adjustment of the strength of the node facilitates the neural network's ability to predict an accurate output 218.

In some embodiments, the output 218 may be one or more numbers. For example, output 218 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As such, the softmax classifier may be employed because of the classifier's ability to classify various classes. Other classifiers may be used to make other classifications. For example, the sigmoid function makes binary determinations about the classification of one class (i.e., the output may be classified using label A or the output may not be classified using label A).

C. Computing device for Node Transportation Networking

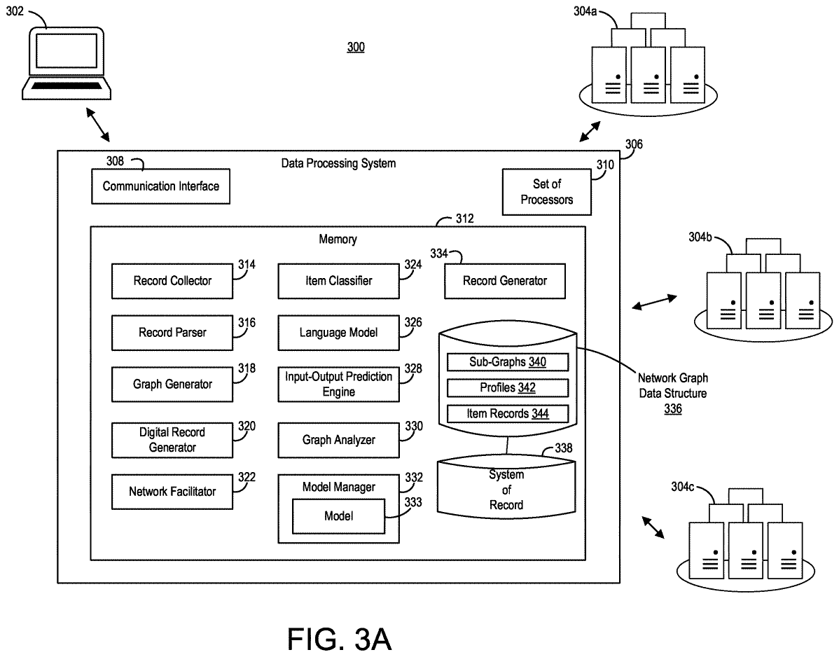

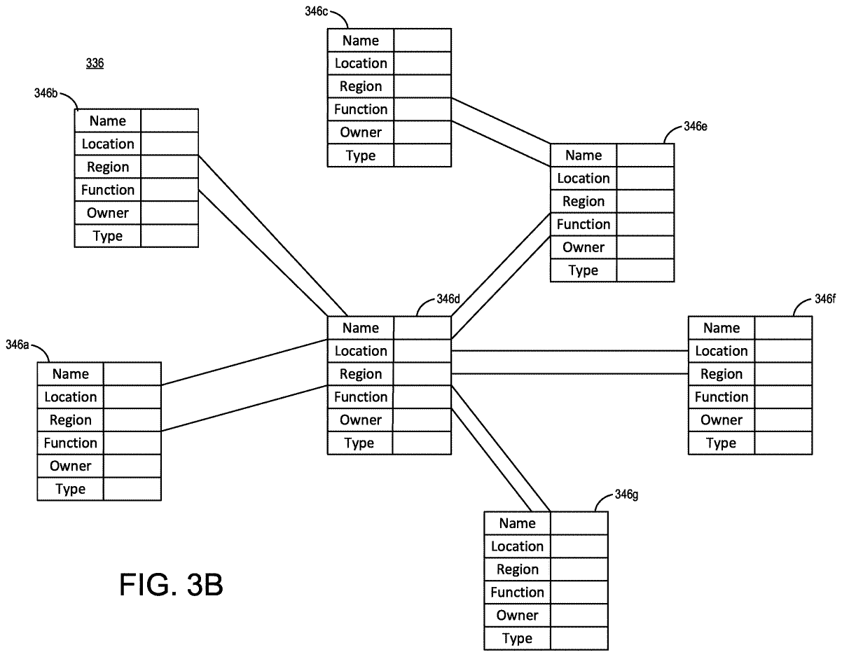

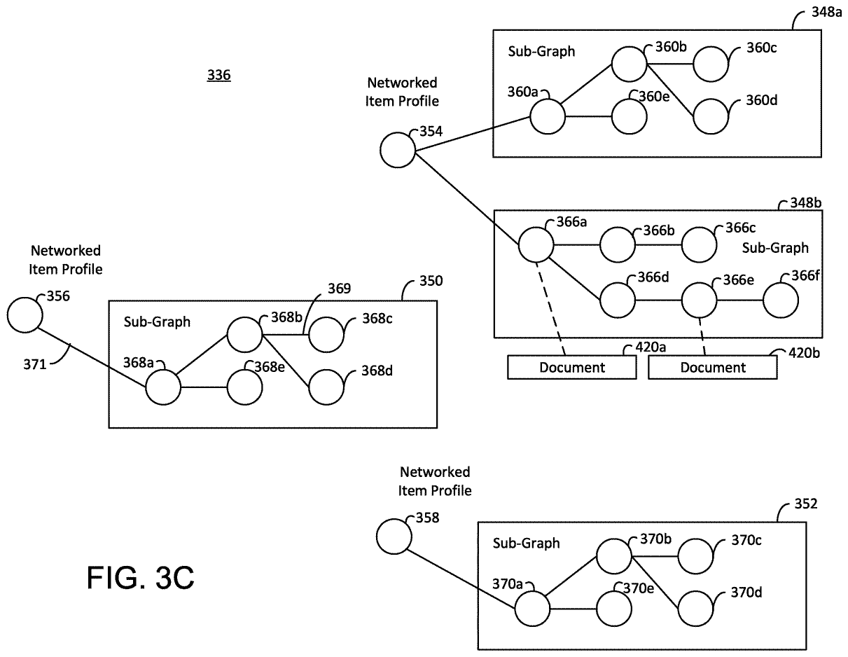

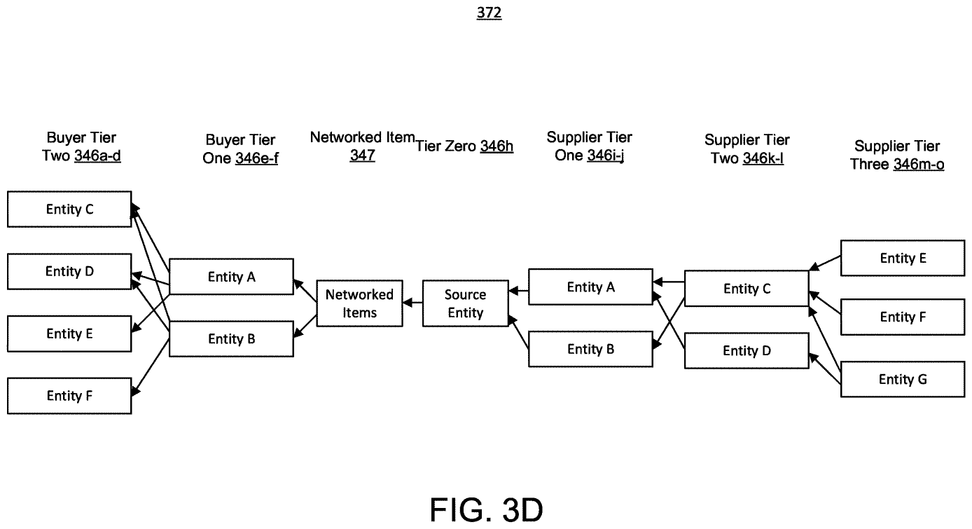

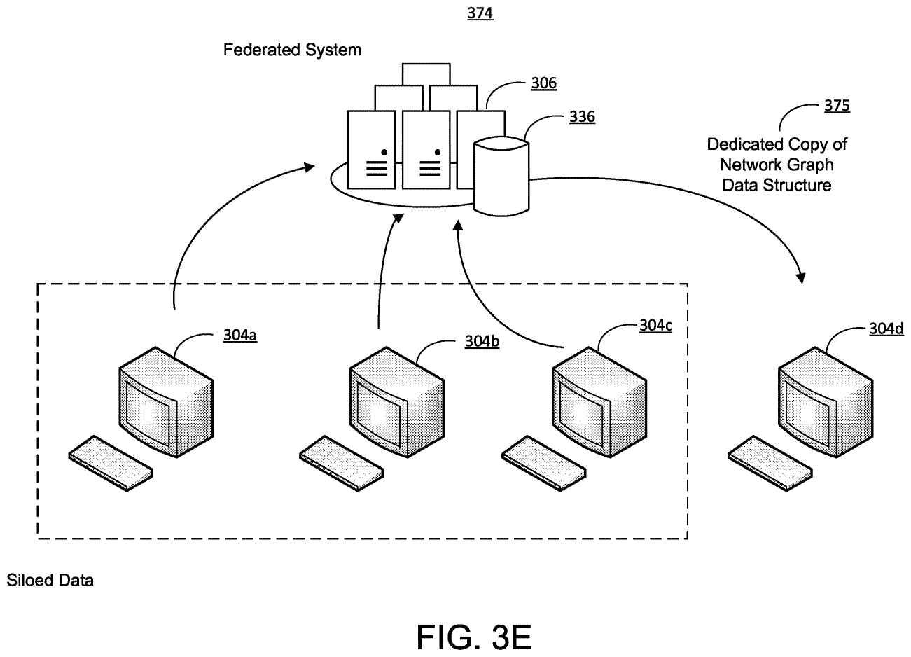

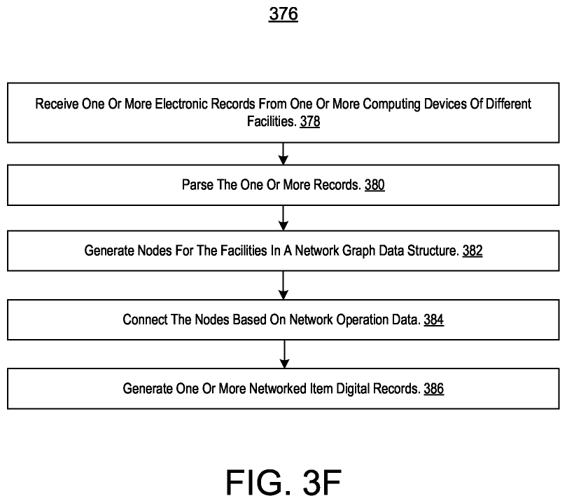

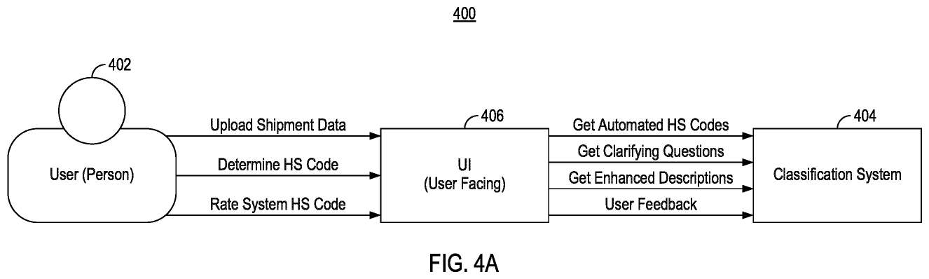

FIG. 3A is an illustration of an example system 300 for network graph data structure-based transportation networking, in accordance with an implementation. In brief overview, the example system 300 can include a client device 302, computing devices 304a-304c (individually, computing device 304, and together, computing devices 304), and a data processing system 306. The system 300 can include more or fewer components than illustrated in FIG. 3A, depending on the implementation. Each of the computing devices 304 can be configured to store various types of data and perform various types of operations discussed in this disclosure. The data processing system 306 can execute a language processing model (e.g., a large language model) to receive and/or process contextual information regarding database transactions or other communications from a user (e.g., a user accessing the client device 302) of the data processing system 306 and/or data received from the computing devices 304. The data processing system 306 can transmit the contextual information to the computing devices 304 for storage.

The client device 302 can be an electronic computing device (e.g., a cellular phone, a laptop, a tablet, a personal computer, or any other type of computing device). The client device 302 can include a display with a microphone, a speaker, a keyboard, a touchscreen, or any other type of input/output device. A user can access a platform provided by the data processing system 306 through the client device 302 to view outputs of machine learning models and/or otherwise access a portions of a network graph data structure (e.g., a knowledge graph or a graph data structure storing nodes and edges) provided generated and/or provided by the data processing system 306. In one example, the user can transmit a request including an identification of a networked item to the data processing system 306. The data processing system 306 can receive the request and retrieve data from a network graph data structure hosted or maintained by the data processing system to generate context or other requested information regarding the identified networked item. The data processing system 306 can transmit the generated context or requested information back to the client device 302. The data processing system 306 can receive and/or transmit such data over a network (e.g., a synchronous or asynchronous network).

The computing devices 304 can each be or correspond to facilities or locations in a transportation network. The facilities can be or include physical locations or sites within a value chain in which operations or processes take place to generate, modify, assemble, store, distribute, or otherwise deliver products or services. Facilities may include manufacturing plants, warehouses, distribution centers, transportation hubs, retail outlets, data centers, or other relevant infrastructure locations. Collectively, these facilities can facilitate the efficient movement and transformation of goods and services across various stages of the value chain, from initial sourcing and supply, through intermediate processing or logistics, and ultimately to the end user or consumer. The transformation and movement can each be a network operation indicating an operation performed on networked items as they move or are transformed across a network of facilities.

For example, a value chain for a consumer electronics product such as a smartphone may include the transportation and transformation of the smartphone across different facilities of the value chain. In the value chain, a first facility in the value chain can be a manufacturing plant, where components are initially assembled into finished products, such as the smartphone. The components of the smartphone can each originate at other facilities of the value chain, such that each facilitate may include multiple inputs to generate one or more outputs for the value chain for a single product. The smartphone can be transported to another facility in the value chain, such as a warehouse facility, which can store completed products awaiting orders from distributors or retailers. From the warehouse facility, the smartphone may be transported to another facility, such as a distribution center or transportation hub, where products are sorted, packaged, and dispatched to retail outlets or directly to end users.

A second example can be a value chain for food products. In this example, facilities may include food processing plants, which can transform raw agricultural produce into packaged and marketable food networked items. From these processing plants, the products may be transported to cold storage or refrigerated warehousing facilities for product freshness and safety. subsequently, transportation hubs or logistics centers can coordinate the distribution of the food products to supermarkets, grocery stores, or directly to consumers, completing the flow from farm to table for the value chain for the food products.

Facilities within a value chain can provide electronic documentation about their roles and operations in the value chain by transmitting relevant data from their respective computing devices 304 to the data processing system 306. For example, a manufacturing plant can use its computing device 304 to transmit detailed production reports that include finished quantities, malfunction logs, quality assurance metrics, and resource consumption data to the data processing system 306. Similarly, warehouse and storage facilities can utilize their respective computing devices 304 to regularly provide inventory updates, storage conditions, inbound delivery notifications, outbound shipment records, and product-handling information to the data processing system 306. By electronically transmitting ongoing documentation regarding inventory status, product movements, batch numbers, expiration dates, and environmental conditions (for example, temperature or humidity sensor readings), these facilities allow the data processing system 306 to maintain continuous visibility into different value chains in which the facilities are a part and the network operations performed by the facilities.

Additionally, logistics hubs and distribution centers may similarly rely upon their computing devices 304 to relay shipping and transportation documentation to the data processing system 306. The computing devices 304 for the logistics hubs and distribution centers can transmit information, such as shipment tracking data, freight bills, estimated delivery timelines, route details, transport conditions, and real-time status updates on transit delays or incidents can be to the data processing system 306.

The data processing system 306 may include one or more processors that are configured to maintain and update a network graph data structure, such as for transportation network management. The data processing system 306 may include a communication interface 308, a set of processors 310, and a memory 312. The data processing system 306 may communicate with the computing devices 304 via the communication interface 308, which may be or include an antenna or other network device that enables communication across a network and/or with other devices. The memory 312 may include a record collector 314, a record parser 316, a graph generator 318, a digital record generator 320, a network facilitator 322, an item classifier 324, a language model 326, an input-output prediction engine 328, a graph analyzer 330, a model manager 332, a record generator 334, a network graph data structure 336, and/or a system of record 338.

The set of processors 310 may be or include an application-specific integrated circuit (ASIC), a set of field programmable gate arrays (FPGAs), a set of digital signal processors (DSPs), circuits containing one or more processing components, circuitry for supporting a microprocessor, a group of processing components, or other suitable electronic processing components. In some embodiments, the set of processors 310 may execute computer code or modules (e.g., executable code, object code, source code, script code, machine code, etc.) stored in the memory 312 to facilitate the operations described herein. The memory 312 may be or include any volatile or non-volatile computer-readable storage medium capable of storing data or computer code.

One or more of the computing devices 304 or the data processing system 306 can include or utilize at least one processing unit or other logic devices such as a programmable logic array engine or a module configured to communicate with one another or other resources or databases to perform one or more of the operations described in this disclosure. As described herein, computers can be described as computers, computer devices, computing devices, or client devices. One or more of the computing devices 304 may each contain their own computer resources (e.g., processor, memory, etc.), share computer resources, or be part of a distributed computer system. The components of the computing devices 304 or the data processing system 306 can be separate components or a single component. The example system 300 and its components can include hardware elements, such as one or more processors, logic devices, or circuits. The computing devices 304 or the data processing system 306 can each be a server or computer that is configured to store various types of data, such as data stream data, image data, audio data, other types of content data, etc. For example, the computing devices 304 or the data processing system 306 can each store records for different accounts in memory (e.g., in a database in memory), where such media may include non-transitory machine-readable media used to store program instructions for performing one or more operations described in this disclosure.

The record collector 314 may include instructions that, when executed by the set of processors 310, cause the set of processors 310 to aggregate and retrieve or receive data from different sources, such as the computing devices 304. The record collector 314 may perform such operations by implementing various retrieval methods such as polling, change data capture (CDC), or event-driven mechanisms to fetch real-time data updates. For handling real-time data collection, the record collector 314 may employ message queues like Apache Kafka or RabbitMQ to buffer incoming data streams and prevent data loss during high-volume periods. In some cases, the record collector 314 can receive and/or manage data reception of electronic documents or records that the computing devices 304 transmit to the data processing system 306.

The record collector 314 may store the collected electronic documents or records within the system of record 338. The collected records may be stored in a structured manner, enabling efficient indexing, querying, and retrieval of information. For example, the computing devices 304 of the different facilities involved in one or more value chains may transmit records to the data processing system 306. Examples of records that the data processing system may receive can include, in addition to any other types of records:
Manufacturing facility records, such as production run reports, quality control data, defect logs, maintenance schedules, machine downtimes, and resource utilization reports.
Warehouse and inventory management records, such as detailed inventory counts, storage condition logs (e.g., temperature and humidity readings), product expiration dates, batch numbers, incoming delivery details, and outbound shipment data.
Logistics and transportation records, including shipment tracking records, freight bills, customs declarations, delivery confirmation receipts, transportation delay reports, real-time GPS coordinates, carrier performance metrics, and incident or accident documentation.
Records relating to retail or distribution centers, such as inventory sales data, return processing documents, reorder logs, store stock levels, and customer demand forecasts.
Event-driven notifications, such as alerts of supply chain disruptions, inventory shortages, equipment failures, or transportation route changes.
Operational transaction data, including purchasing or procurement orders, invoice records, payment confirmations, and financial transaction logs.
Compliance or regulatory records documenting adherence to applicable regulations, standards, certifications, inspection reports, and audit trails from each facility.
Ownership/directorship information, including ownership and directorship by companies and individuals. Moreover, the sanctioned/denied/risk status of these related entities, their physical locations, nationalities, and similar information.
Records including sanctions lists, denied party lists, geographic information (e.g., if a network operation is a denied or sanctioned region), etc.
   The record collector 314 may receive such records as sets of data or electronic documents or files and store the records in the system of record 338.

In one example, the record collector 314 can be, include, or interface with an application programming interface (API) that facilitates communication between the data processing system 306 (e.g., via the communication interface 308 of the data processing system) and other computing devices, such as the client device 302 and/or the computing devices 304. The record collector 314 may communicate with the client device 302 and/or the computing devices 304 across a network.

For instance, the record collector 314 can establish a connection with one of the computing devices 304. The record collector 314 can establish the connection with the computing device 304 over the network. To do so, the record collector 314 can communicate with set of servers across the network. In one example, the record collector 314 can transmit a syn packet to the computing device 304 (or vice versa) and establish the connection using a TLS handshaking protocol. The record collector 314 can use any handshaking protocol to establish a connection with the computing device. The data processing system 306 can communicate with the computing device over the established connection.

Over the established connection, the computing device 304 can transmit one or more records for a facility. The records can include, for example, one or more shipment tracking records, bills of materials, freight bills, delivery confirmation receipts, transportation delay reports, real-time GPS coordinates, carrier performance metrics, or incident or accident documentation. The record collector 314 can receive the records and store the records in the system of record 338.

The record parser 316 may include instructions that, when executed by the set of processors 310, cause the set of processors 310 to parse the records received by the record collector 314 and/or retrieved from the system of record 338. In some cases, the record parser 316 can parse the records using machine learning (including techniques such as natural language processing, image processing, and usage of contextual graph information) techniques, such as by extracting relevant operational data elements and facility-specific details from the electronic records transmitted by computing devices 304 of different facilities within the value chain. For example, the record parser 316 may use natural language processing techniques such as named entity recognition to identify (e.g., automatically identify) facility names, locations, equipment identifiers, product batch numbers, or shipment tracking numbers from textual records. Relationship extraction methods may be employed to identify connections between different entities, for instance, associating product batch information with manufacturing dates, quality inspection results, or origin/destination details from logistics records. Additionally, the record parser 316 may apply text classification or rule-based parsing methods to categorize records based on facility roles (e.g., manufacturing, warehousing, transportation, etc.). In some cases, the record parser 316 can normalize extracted data into standardized formats to aggregate, index, analyze, and report across datasets from multiple facilities consistently and efficiently. In some embodiments, domain-adapted machine learning models trained specifically on facility-generated documentation and supply chain terminology may further enhance the parsing accuracy and comprehensiveness of the data extraction process. The record parser 316 can identify or extract such information from the different records and store the extracted or identified data in the system of record 338.

The system of record 338 can be a relational or any other type of database that is configured to store records collected by the record collector 314 and/or data parsed or extracted from such records by the record parser 316. The system of record 338 may store structured and normalized operational data parsed from electronic records transmitted by computing devices 304 associated with facilities throughout the value chain. Examples of such operational data stored in the system of record 338 may include production run details, quality inspection results, detailed inventory levels, shipment tracking logs, logistics incidents and delays, product batch identifiers, facility locations, and transactional or compliance documentation. By maintaining this comprehensive and structured data repository, the system of record 338 can facilitate the data processing system 306 performance of efficient support queries, analytics, reporting, real-time decision-making, and/or proactive management of the overall value chain operations. The system of record 338 can also be configured to provide interfaces or data-access layers that allow other components or services within or external to the data processing system 306 to easily access and retrieve such stored information for downstream processing, visualization, or further analysis. In some cases, the system of record 338 can include the network graph data structure 336 and/or include different notes or comments about the network graph data structure 336.

The graph generator 318 may include instructions that, when executed by the set of processors 310, cause the set of processors 310 to generate the network graph data structure 336. The graph generator 318 can generate the network graph data structure 336 based on (e.g., based only on) records and/or parsed data stored in the system of record 338. For example, from the stored records and/or parsed data, the graph generator 318 can generate one or more nodes that each represent a different facility that is involved in at least one value chain. The graph generator 318 can generate edges between pairs of nodes representing pairs of facilities that represent or indicate the transportation of networked items or components used to create or transform individual the networked items. An edge between a pair of nodes representing a pair of facilities can indicate the output from one facility of the pair of nodes that is input into another facility of the pair of nodes. The graph generator 318 can additionally or instead generate nodes that represent different networked items (e.g., items that are transformed and/or transported across a value chain). The graph generator 318 can generate edges between the nodes for the networked items to the facilities that are involved in the transportation and/or creation of the respective networked items. The graph generator 318 can generate the edges by storing identifications of the nodes connected by the edges in the respective nodes. The graph generator 318 generate the nodes and/or edges between nodes in the network graph data structure 336.

The network graph data structure 336 can be or include a graph data structure configured to store different nodes of value chains for different networked items. The nodes can each be or include a separate data structure with node field-value pairs that each correspond to a different type of data regarding a facility represented by the node. For instance, the individual nodes can each include node field-value pairs for a name or identifier of the facility represented by the node, a type of node (e.g., manufacturing, warehousing, transportation, etc.), a description of the function of the node, a location (e.g., geographic location) of the node, a region of the node, an owner of the node, etc. Each node field-value pair can include an identification of the type of the node field-value pair and a value for the node field-value pair. The graph generator 318 can identify values for the node field-value pairs from the records and/or parsed data of the system of record 338 and store the values in the corresponding node field-value pairs.

The network graph data structure 336 can be or include one or more sub-graph data structures 340. Each of the sub-graph data structures can represent a value chain for generating a networked item. For instance, each sub-graph data structure 340 can be linked by an edge with a profile data structure or networked item profile 342 for a networked item that is generated by a value chain that the sub-graph data structure 340 represents. The individual sub-graph data structures 340 can each include a chain of nodes. The chain of nodes can be or include a sequence of connected nodes forming a path of one or more instances of the networked item from a source node (e.g., a source node or initial node of the chain of nodes or the sub-graph data structure 340) to a destination node (e.g., a destination node or last node of the chain of nodes or the sub-graph data structure 340). The path can represent network operations of one or more instances of the networked item through the sequence of connected nodes. In some cases, each node of the sequence of connected nodes represents an entity performing a network operation on the one or more instances of the networked item. Each edge between one or more pairs of the sequence of connected nodes can represent movement, transfer, or transport of the one or more instances of the networked item from a first node (e.g., a source node) of the pair of nodes to a second node (e.g., a destination node) of the pair of nodes.

In some cases, the graph generator 318 can perform entity resolution techniques to modify the network graph data structure 336. For example, the graph generator 318 can extract of facility-related references from electronic records parsed by the record parser 316. For instance, the record parser 316 can identify a facility's name, location, and equipment identifiers from shipment tracking logs and quality inspection reports. Once these references are extracted, the graph generator 318 can move to a resolution phase. In the resolution phase, the graph generator 318 can match each extracted reference to existing entities within the system of record 338 or, if no match is found, create a new entity to represent the facility or item. The graph generator 318 can generate nodes in the network graph data structure 336 for new entities that the graph generator 318 identifies. In doing so, the graph generator 318 can ensure that each node in the network graph data structure 336 corresponds to a unique, defined entity, minimizing duplication and enabling accurate representation of relationships within the network graph data structure 336.

The digital record generator 320 may include instructions that, when executed by the set of processors 310, cause the set of processors 310 to generate networked item profiles 342 and/or networked item digital records (e.g., passports) for different networked items for which value chains are represented in the network graph data structure 336. The networked item profiles 342 can be or include nodes or profiles that store data the networked items represented by the networked item profiles 342. For example, the networked item profiles 342 can be or include separate data structures that represent the respective networked items. The data structures can each be or include one or more attribute field-value pairs that each correspond to attributes of the respective networked items. Examples of attribute field-value pairs can include classifications, carbon footprint for manufacturing the networked items, revenue, origin, etc. The digital record generator 320 can generate networked item profiles 342 for different networked items using data stored for the networked items from the system of record 338. The graph generator 318 can store the networked item profiles 342 in the network graph data structure as profiles 342 as nodes of the network graph data structure 336. In doing so, the graph generator 318 can generate edges between the networked item profiles 342 and nodes representing facilities (e.g., the origin or initial facilities) of value chains involving the networked item or that are used to generate networked items of the respective networked item profiles 342.

The digital record generator 320 can generate networked item digital records for different networked items. The networked item digital records can be or include a view into the network graph data structure 336 that includes one or more sets of nodes or sub-graph data structures indicating one or more value chains of the networked items associated with the networked item digital records. The networked item digital records can each correspond to one or more networked items. The digital record generator 320 can generate the networked item digital records to each have a unique identifier (e.g., a passport identifier or a digital record identifier) that operates as an address for the networked item digital record. The digital record generator 320 can generate the networked item digital records to include identifications of one or more networked item profiles 342, identifications of individual nodes, and/or identifications of different sub-graph data structures or value chains for networked items. In some cases, the networked item digital records can include the profiles, nodes, and/or sub-graph data structures themselves.

The digital record generator 320 can generate the networked item digital records based on user selections that the digital record generator 320 receives, such as from the client device 302. For example, a user can provide an input to generate a networked item digital record for a networked item. The user can then provide an input selecting a networked item profile for the networked item and one or more sub-graph data structures indicating sets of nodes representing value chains in which the networked item is involved. The digital record generator 320 can receive the selections and generate a networked item digital record for the networked item by generating an identifier for the networked item digital record as well as identifying identifiers for each of the selected networked item profile and the sub-graph data structures and/or nodes of the sub-graph data structures. The digital record generator 320 can store a file including the identifiers and/or the data structures of the selected networked item digital record and the sub-graph data structures or nodes. The digital record generator 320 can store the file in the network graph data structure 336 as one of a plurality of networked item digital records 344.

The network facilitator 322 may include instructions that, when executed by the set of processors 310, cause the set of processors 310 to facilitate the transfer of networked items across a network nodes. The network facilitator 322 can do so, for example, by responding to requests from computing devices regarding whether networked items satisfy a set of rules. For instance, the network facilitator 322 can store a set of rules that indicate criteria that networked items can satisfy during the transfer or transportation of the networked items between facilities, in some cases across the border. In response to a request, the network facilitator 322 can identify a networked item digital record for the networked item from the network graph data structure 336. The network facilitator 322 can identify the networked item digital record, for example, by identifying the networked item digital record based on the networked item digital record containing an identification of the networked item or by identifying an address of the networked item digital record that was contained in the request. The network facilitator 322 can retrieve the networked item digital record and identify a networked item profile for the networked item and/or the nodes containing data regarding one or more transformations and/or transportations of the networked item. The network facilitator 322 can retrieve data from the respective profiles and/or data structures. The network facilitator 322 can apply the set of criteria to the retrieved data to determine whether the data for the networked item satisfies the set of criteria. Responsive to determining the set of criteria is satisfied, the network facilitator 322 can generate a flag indicating the transfer or transport of the networked item is allowed. Otherwise, the network facilitator 322 can restrict the transfer or transport of the networked item by generating an alert or otherwise operating a machine to restrict the movement of a vehicle from transferring or accepting the networked item.

The item classifier 324 may include instructions that, when executed by the set of processors 310, cause the set of processors 310 to generate classifications for networked items. The item classifier 324 can generate classifications for networked items in response to requests from computing devices, such as the client device 302. For example, the item classifier 324 can receive a request containing an identification of a networked item. The request can be for a classification (e.g., a harmonized system (HS) code for the time) for the networked item. The item classifier 324 can receive the request and identify one or more sub-graph data structures from the network graph data structure 336 that correspond to the networked item (e.g., correspond to facilities that facilitate the transformation and/or transport of the networked item and/or components of the networked item). The item classifier 324 can use edges between the sub-graph data structures to identify different information about the networked item, such as a source node (e.g., source facility) for the networked item and/or a destination node (e.g., a destination facility) for the networked item.

The item classifier 324 can use the retrieved data from the network graph data structure 336 to generate either a prompt or a prompt augmented for the language model. The language model 326 can be or include a large language model, a transformer, a neural network, etc., that is trained to generate responses to input containing different types of content, such as images, text, or videos. The item classifier 324 can generate a prompt containing the identification of the networked item and/or any information retrieved from the network graph data structure 336 regarding the networked item in response to the request. In some cases, the item classifier 324 can include features (e.g., textual, numeric, categorical, graph-based features, or image features) of the networked item in the prompt. This description may be augmented with graph context (buyers and suppliers of the good, their extended relationships) as well as characteristics such as the weight, value, and similar of the good. The item classifier 324 may receive the description in the request or by retrieving the text description from the networked item profile for the networked item stored in the network graph data structure 336. The item classifier 324 can generate such a prompt and input the prompt into the language model 326. The item classifier 324 can execute the language model 326 based on the input to cause the language model 326 to output a classification for the networked item and/or a confidence score for the classification for the networked item.

The item classifier 324 can compare the confidence score for the classification to a threshold. Responsive to determining the confidence score exceeds the threshold, the item classifier 324 can generate a visual representation of the classification and/or the confidence score for the classification. The item classifier 324 can transmit the visual representation of the classification to the client device that transmitted the request.

In cases in which the item classifier 324 determines the confidence score is less than the threshold, the item classifier 324 can retrieve further information regarding the networked item. The item classifier 324 can do so, for example, by querying a network (e.g., the Internet) for one or more databases that store data regarding networked items that contain matching identifiers to the identifier received in the request. The item classifier 324 can retrieve information regarding the networked item from such databases enrich the prompt with the retrieved data. The item classifier 324 can input the enriched prompt into the language model 326 and execute the language model 326 to generate a classification and/or a confidence score for the classification. The item classifier 324 can repeat this process any number of times until determining or identifying a confidence score for a classification that exceeds the threshold.

The item classifier 324 can use any type of machine learning model to generate classifications for networked items of network operations. The item classifier 324 can do so using the retrieved data from the network graph data structure 336. The item classifier 324 can use the retrieved data to generate a feature vector for input into any type of machine learning model. For example, the item classifier 324 can generate a feature vector of numeric values from the records. The item classifier 324 can do so by inserting extracted numeric values from the records and/or converting text or other attributes from the records into the numbers for inclusion in the feature vector. The item classifier 324 can insert the feature vector into a neural network configured or trained to generate classifications of network items of networked operation. The item classifier 324 can execute the neural network based on the input to cause the neural network to generate a classification for the networked item and a confidence score for the classification. Responsive to determining the confidence score does not exceed a threshold, the data processing system can retrieve further data about the networked item and execute the neural network again to determine a classification and a new confidence score. The data processing system can repeat this process until identifying a classification and a corresponding confidence score that exceeds or satisfies a threshold. The item classifier 324 can use any type of machine learning model for classification.

The input-output prediction engine 328 may include instructions that, when executed by the set of processors 310, cause the set of processors 310 to generate predictions for inputs and/or outputs of nodes of the network graph data structure 336. For instance, the input-output prediction engine 328 can be or include one or more machine learning models (e.g., neural networks, support vector machine, random forests, etc.) that are each configured to generate a prediction regarding an input to a node and/or an output of a node. Examples of inputs can be or include different types of energy (e.g., coal, electricity, gas, etc.) the facilities represented by the nodes use for operation, the amount of energy the facilities use for a defined time interval, components that the facilities receive from other facilities, types of transportation through which the facilities receive inputs, the facilities that provide the inputs, etc. The outputs can be the types of networked items or components the facilities produce, environmental emissions or outputs the facilities produce, etc. The input-output prediction engine 328 can predict such inputs and/or outputs based on any type of data or metadata regarding the facilities, such as based on identification of the technology the facilities use, identifications of the inputs and/or outputs of the facilities, the number of employees, the geography or region of the facilities, the number of network operations that the facilities are involved in, etc. The input-output prediction engine 328 can generate predictions based on such inputs or outputs. The input-output prediction engine 328 can store the predictions in the data structures or nodes of the network graph data structure 336 for which the input-output prediction engine 328 generated the predictions.

In some cases, the input-output prediction engine 328 can store and/or include an input-output matrix. The input-output matrix can map input items with classifications or directly to determine relevance for target item generation. This matrix can operate as a lookup table that facilitates fast identification of pertinent input/output relationships without requiring extensive graph traversal. The system can perform classification-based queries against this matrix, in some cases using item classifications or other types of data (e.g., textual description, numeric characteristics, categorical values, and/or graph connections) as keys to identify which inputs should be included in or discarded from the sub-graph generation process. Generating and using the input-output matrix in this way can transform the conventionally recursive and computationally expensive process of dependent graph traversal into an efficient and direct lookup operation that scales with the size of the network graph data structure.

Additionally, the input-output prediction engine 328 can implement one or more semantic models, such as generative models, foundational neural net models, transformer models, convolutional or recurrent neural networks, BERT models, SBERT models, etc., that analyze textual descriptions of items to make more nuanced determinations about input-output relationships. These semantic models can provide an additional layer of intelligence beyond classification matching using the input-output matrix, facilitating the data processing system 306's ability to understand contextual relationships between items based on their descriptive content. The semantic analysis can aid in resolving ambiguous cases where matrix-based filtering alone might be insufficient, ensuring that the generated sub-graphs capture the most accurate and relevant dependency relationships for the corresponding target items.

Moreover, the model manager 332 can continuously increase the accuracy of the models involved in evolving operational environments through continuous learning. For example, the model manager 332 can train and retrain large language models or other type of machine learning model or generative model, including those with graph based and contextual features, using records of actual network operations and item transfers. The model manager 332 can use the trained large language models or machine learning models to enable the input-output matrix to adapt to changing operational patterns. This dynamic updating capability ensures that the sub-graph generation process remains accurate as new items are introduced, relationships change, or operational procedures evolve. The continuous learning approach prevents the degradation of system accuracy.

The graph analyzer 330 may include instructions that, when executed by the set of processors 310, cause the set of processors 310 to generate metrics for the network graph data structure 336. The graph analyzer 330 can generate the metrics for individual nodes in the network graph data structure 336, individual networked item profiles of the network graph data structure 336, individual sub-graph data structures of the network graph data structure 336, etc. The graph analyzer 330 can generate the metrics based on the data stored in the network graph data structure 336 for the respective nodes, sub-graph data structures, and/or networked item profiles. The graph analyzer 330 can generate the metrics and store the metrics in network graph data structure 336 and/or the system of record 338.

The model manager 332 may include instructions that, when executed by the set of processors 310, cause the set of processors 310 to generate manage the different computer models (e.g., optimization models, machine learning models, etc.) stored by the data processing system. The model manager 332 may execute and/or train the different machine learning models and/or other types of computer models to generate outputs based on data stored in the network graph data structure 336, the system of record 338, and/or any other data sources.

The model manager 332 may be or include a task agent that is configured to execute different applications and/or models stored by the data processing system 306 to perform different tasks. For instance, the task agent can be or include one or more large language models and/or other types of machine learning models. The task agent can determine the intents of queries (e.g., natural language queries) and use the intents to determine one or more tasks to perform. The task agent can identify a relevant sets of instruction, model, and/or application of the components 314-330 and/or 334 to use to perform a task, execute the identified set of instructions, model, and/or application, determine if the task are completed based on the execution, identify another set of instructions responsive to determining the task is not completed, and repeat this process until determining the task and/or each task is completed.

The model manager 332 may include a model 333. The model 333 can include one or more of the models described herein as being processed or executed by the data processing system 306, such the language model 326 and/or the models for classification of the input-output prediction engine 328. The model manager 332 can execute and/or train the model 333 to perform different tasks, such as classifying networked items, generating risk scores for network operations, generating risk scores for entity nodes, etc. The model manager 332 can train such models using data from the network graph data structure 336 and/or ground truth information (e.g., from the network graph data structure 336 or from another source, such as the system of record 338 or an external database or data source). The model manager 332 may do so as a task agent or any type of model or application that the data processing system 306 can execute.

The record generator 334 may include instructions that, when executed by the set of processors 310, cause the set of processors 310 to generate records (e.g., user interfaces, databases, tables, files, etc.). The record generator 334 can generate records containing data that is requested by different computing devices. In some cases, the record generator 334 can generate the records to include data generated by one or more of the network facilitator 322, the item classifier 324, the language model 326, the input-output prediction engine 328, and/or the graph analyzer 330. The record generator 334 can (e.g., through the record collector 314) transmit such records to the requesting computing devices and/or store the records in the system of record 338 and/or the network graph data structure 336.

FIG. 3B illustrates an example of the network graph data structure 336 storing nodes representing the networking of the transportation and/or transformation of different networked items across a network, in accordance with an implementation. As illustrated, the network graph data structure 336 can include one or more nodes 346a-g (individually, node 346 and together, nodes 346) that represent different facilities. The nodes 346 can be connected by edges that each represent network operations (e.g., transfers, transformations, or transportation instances) between the respective nodes 346. The nodes 346 can each include one or more node field-value pairs for different types of characteristics or attributes of the facilities represented by the nodes 346. The nodes 346 can include one or more attributes such as, for example, name, location, region, function, owner, type, etc.

The edges of the network graph data structure 336 can be or include data structures (e.g., edge data structures). For example, the edge data structures can each include one or more edge field-value pairs for different types of characteristics or attributes of the network operations represented by the edges. The edges can include one or more attributes such as, for example, identifier or name of the networked item being transported or transferred, quantity (e.g., number of networked items of a shipment and/or weight of an individual network item and/or weight of the total networked items being transferred in the network operation), a time and/or date of the network operation, a classification (e.g., an HS classification) of the networked item, a description (e.g., a text string description) of the networked item, a method of transport, etc. The edge data structures can each include identifiers of the nodes that the edges are connecting, in some cases forming the edge in a structured manner.

### Master Data Objects

The network graph data structure 336 can include master data objects that store data for specific types of networked items represented in the network graph data structure 336. Non-limiting examples of networked items for which the network graph data structure 336 may store master data objects include products, organizations, locations, customers, users, suppliers, orders, directors, shareholders, shipments, and customs entries. Details regarding these data objects are below.
Product
   The “output” Product is the primary focus in the Catalog and in the overall value chain management system design
   Input Products are also linked to the output Product via a Bill of Materials
   Products can be linked across value chains networks, and specifically through the Systems of Record of “active” registered organizations, via product passports
   Attributes
      Revenue (for output Products)
      Spend (for input Products)
      Bill of Materials
      Certificate of Origin
      Free trade agreement qualification
      Product Carbon Footprint
      HS codes (by jurisdiction)
      Duty/tariff owed by jurisdiction and date
      Deforestation impact
      Forced labor risk
      Material Safety Data Sheet
      Third Party Certifications
      Images
      Reports/Attestations generated within the system
      The system ID and system-generated QR Code
      Any other attributes can be specified by users involved (e.g., the parties involved) in the need for the product passport.
Organizations
   Registered Organization
      This organization type is meant to capture the general sense of a “counterparty” entity in a global b2b or B2g interaction. I sell to Crystal and Stone Co., and not the Smith family. I import my goods with the customs agency and not the government. I buy jet engines from Acme Co. and not the parent company Globex. I fly on Jets Airways and not the regionally-licensed subsidiary.
      Registered organizations include 1) any customer-provided company counterparty node listed in their Catalog, and/or 2) system-created registered organizations generated through AI systems operating on customer and third party data, but not in reliance on, or re-constituting, any one corporate firmographic dataset.
         Registered organizations can have one or more Legal Organizations, Legal Entities, and Facilities linked to them.
      Government, non-profits, academic institutions, etc. can be registered organizations—not just corporate entities
      Attributes of registered organizations:
         Website
         Brands
         Legal Organizations linked through ownership
         Facilities
         User registries
         Sanctions/denied party status
         Revenue
      A canonical legal entity provided by a third party corporate register
Locations
   Facility
      A system-generated entity that is comprised of a 1) physical address, and 2) a business relationship edge (mostly shipments, but summary buyer-supplier edges work too)
   Area
      Polygon
      Attributes:
         Land use
         Deforestation risk
Customers
   Customers are registered organizations, and can be linked to one or more output Products in the Catalog
Suppliers
   Suppliers are registered organizations, and can be linked to one or more input Products in the Catalog
Orders
Shipments
Customs Entries

### Insight Objects

The network graph data structure 336 can include or be associated with insight objects. The insight objects can store data generated from metrics or analytics performed on the nodes or objects of the network graph data structure 336. Examples of insights for which the network graph data structure 336 may store insight data objects include exposure, event, opportunity, and change. Details regarding these data objects are below.
Exposure
   Compliance risk
   Business interruption risk
   Geopolitical risk
Event
   AI event
      Subcategories thereof
   System network event
      Placeholder for events generated based on the network graph data structure 336 and/or network
Opportunity
   Placeholder for an insight type that is an opportunity, such as a “recommended supplier” or “recommended customer”
Change
   A graph change that affects a customer's VC network

### Task Objects

The network graph data structure 336 can include or be associated with task objects. The task objects represent or include data for any type of data object of the network graph data structure 336 or associated with the network graph data structure 336. In some cases, task objects can be grouped or linked into a larger “job” data structure representing different actions to be performed to accomplish a job associated with the job data structure. Details regarding task data objects are below.
Tasks can be collaborative pages that allow for internal and external collaboration/communication and role-based abilities to:
   Edit, annotate, and append Master Data Objects
   Disposition Insight Objects
   Share or request Passports, including designating data and documents to share or request within the Passport
Examples of tasks can include
   Exposure Assessment, which may be subdivided into two tasks that include:
      Network Validation
      Exposure Validation
   Event Assessment, which may be subdivided into two tasks that include:
      Network Validation
      Event Characterization
   Duty/tariff assessment
   Free trade agreement qualification
   Proving deforestation free production
   Calculating and proving embodied carbon impact
   Classification
   Connection
      Facilitation (cross-border voluntary trade facilitation)
      Survey (upstream and downstream data gathering)
      Reporting (customer and/or regulator) as recipient
   Screening
      For screening entities not in my System of Record for exposures
   Network Update
      Network Validation action associated with a Change insight

In some cases, the data processing system may include different AI agents that facilitate users requesting an agent to establish or generate a workspace or different tasks.

FIG. 3C illustrates another view of the network graph data structure 336 storing nodes representing the networking of the transportation and/or transformation of different networked items across a network, in accordance with an implementation. As illustrated, the network graph data structure 336 can include one or more sub-graph data structures 348a-b, 350, and 352. Each sub-graph data structure can represent or otherwise correspond to a value chain including a path for generating a respective networked item.

The respective sub-graph data structures 348a-b, 350, and 352 can each include a chain of nodes that represent different locations of facilities of a path for generating a networked item. For example, the sub-graph data structure 348a can include nodes 360a-e (together, nodes 360, and, individually, node 360). One or more, or all, of the nodes 360 can be the same as or similar to the nodes 346. The nodes 360 can be linked by edges to indicate the outputs and/or inputs of the nodes 360 to other nodes of the sub-graph data structure 348a to generate a networked item. The nodes 360c, d, and e can each be a source node of the sub-graph data structure because the nodes 360c, d, and e do not receive any inputs from another node (e.g., specifically for the sub-graph data structure 348a). The node 360a can be the last facility (e.g., the destination node) of the value chain represented by the sub-graph data structure 348a because the node 360a may not provide any inputs to another node of the sub-graph data structure 348a. The destination node 360a can be linked with a node 354 associated with the networked item generated by the value chain of the sub-graph data structure 348.

The sub-graph data structure 348b can be configured in a similar manner to the sub-graph data structure 348a. For example, the sub-graph data structure 348b can include nodes 366a-f (together, nodes 366, and, individually, node 366). One or more, or all, of the nodes 366 can be the same as or similar to the nodes 346. The nodes 366 together can represent a value chain for generate the same networked item as the nodes 360 of the sub-graph data structure 348a. The nodes 366 can include one or more common nodes (e.g., the same node) to the nodes 360, such as nodes that are configured to generate the same outputs as each other. The sub-graph data structure 348b can be linked with the node 354 for the profile of the networked item that the nodes 366 are configured to generate together.

A document 420a can be linked with the node 366a of the sub-graph data structure 348b and/or a document 420b can be linked with the node 366e of the sub-graph data structure 348b. The document links are optional. More or fewer document links with nodes can be included than shown. The documents 420a and/or 420b can be records (e.g., electronic records) that were used to generate the respective nodes 366a and/or 366e. For example, the documents 420a and/or 420b can be or include attestations about the nodes 366a and/or 366e, attestations about networked items and/or outputs generated by the nodes 366a and/or 366e, bills of materials provided or associated with the respective nodes 366a and/or 366e, or any other types of documents or electronic records containing data about the respective nodes 366a and/or 366e and/or from which the data (e.g., attributes) of the nodes 366a and/or 366e was generated.

The sub-graph data structure 350 can be configured in a similar manner to the sub-graph data structure 348a. For example, the sub-graph data structure 350 can include nodes 368a-e (together, nodes 368, and, individually, node 368). One or more, or all, of the nodes 368 can be the same as or similar to the nodes 346. The nodes 368 together can represent a value chain for generating or creating the same networked item as the nodes 360 of the sub-graph data structure 348a. The nodes 368 can include one or more common nodes (e.g., the same node) to the nodes 360, such as nodes that are configured to generate the same outputs as each other. The sub-graph data structure 350 can be linked with the node 356 for the profile of the networked item that the nodes 370 are configured to generate together.

The node 368a can be connected with the node 356 for the profile of the networked item that the nodes 368 are configured to generate together. The node 368a can be connected with the node 356 by an edge 371. The edge 371 can be or include a data structure (e.g., an edge data structure) that is configured to identify the type of the connection. In this case, the edge 371 can store data indicating that the node 368 is the final node of the sub-graph data structure 350, an identifier of the sub-graph data structure 350 itself, an identifier of the networked item generated by the sub-graph data structure 350, an indication that the edge connects a node for a location or facility of the sub-graph data structure 350 with a node for a profile (e.g., a profile node) instead of representing a network operation, etc. The different sub-graph data structures 348a, 348b, and/or 352 may each be connected with a node for a profile of a networked item with a similar edge to the edge 371.

The nodes 368b and 368c may be connected by an edge 369. The edge 369 can be or include a data structure (e.g., an edge data structure) that includes data indicating a network operation between the entity represented by the node 368c (e.g., a source node) and the entity represented by the node 368b (e.g., a destination node). The network operation can be a transfer or a transportation of an instance of the network item (e.g., a portion of the networked item that will be eventually be transformed into the networked item or the networked item itself) from the entity of the node 368c to the entity of the node 368b. Together, the nodes 368b and 368c can be a pair of nodes because they are connected by an edge (e.g., the edge 369). The nodes 368b and 368c can be connected by any number of edges, as each edge may correspond to a different network operation. In some cases, the nodes 368b and 368c may be connected by different sets of edges that each correspond to a particular sub-graph data structure. Such may be the case when the nodes 368b and 368c are connected to generate different networked items as part of different value chains (e.g., in different sub-graph data structures). Thus, the edges may be specific to the sub-graph data structures in which the edges are depicted. The nodes of the different sub-graph data structures 348a, 348b, and/or 352 may respectively be connected with each other with edges similar to the edge 369.

The sub-graph data structure 352 can be configured in a similar manner to the sub-graph data structure 350. For example, the sub-graph data structure 352 can include nodes 370a-e (together, nodes 370, and, individually, node 370). One or more, or all, of the nodes 370 can be the same as or similar to the nodes 346. The nodes 370 together can represent a value chain for generate the same networked item as the nodes 368 of the sub-graph data structure 350. The nodes 368 can include one or more common nodes (e.g., the same node) to the nodes 370, such as nodes that are configured to generate the same outputs as each other. The sub-graph data structure 352 can be linked with the node 358 for the profile of the networked item that the nodes 368 are configured to generate together.

FIG. 3D is a sub-graph data structure 372 that represents an example value chain for the production of networked items (e.g., vehicle gearboxes). The sub-graph data structure 372 can represent supply and consumption tiers for generating or creating networked items and then distributing the generated networked items, in some implementations. For example, the sub-graph data structure 372 can include supplier nodes 346m-o that provide inputs to supplier nodes 346k-1 as indicated by the edges and arrows between the nodes 346m-o and the nodes 346k-1. The supplier nodes 346k-1 can use or transform the inputs to generate outputs that are input into the nodes 346i-j. The nodes 346i-j can use or transform the inputs to generate outputs that are input into the node 346h, as the source entity node. The source entity node 346h can generate the networked items 347 based on (e.g., by transforming) the inputs from the nodes 346i-j. The source entity node 346 can transfer the networked items 347 to nodes 346e-f. The nodes 346e-f can distribute or transfer the networked items 347 or a transformed version of the networked items 347.

The data processing system 306 can implement the systems and methods described herein to generate the network graph data structure 336 representing one or more value chains in the sub-graph data structures 340, such as sub-graph data structures 340 with the following characteristics:
Accurate: The network graph data structure 336 may accurately describe the physical production and transportation processes, even if they are described in disparate messy documents in multiple languages.
Granular down to the part-site level: the part-site level is necessary to truly manage supply chains. Previous approaches have focused on the business network level or connection level, but these approaches fail to understand the fundamental physicality (locations and products) of the underlying value chains. The network graph data structure 336 may include specific details to ascertain what was the specific flow of a given product from raw materials to production, distribution, and sale. Failure to achieve this part-site level view results in such high levels of false-positives (erroneous links) that value chain analysis is impossible-participants are stuck in a mire of analyzing irrelevant business relationships.
Dynamically updating: the supply chain is constantly changing. To provide actionable intelligence, the network graph data structure 336 may evolve as production networks, site locations, and corporate relationships evolve. Thus, the system can automatically update while not losing track of relationship histories.
Consistent: To facilitate collaboration between participants whether their role in a value chain is suppliers, buyers, transporters, regulators, banks, insurers, or more, all participants may operate on a shared source of truth. One-off customer specific representations may fail to enable value chain management-they cannot be used as a basis for collaboration. The supply chain graph has to be consistent and linkable across all parties.
   To achieve these attributes the network graph data structure 336 may have the following characteristics.
1. Assembly: The intelligence on global value chains be assembled while respecting data sovereignty, security, and privacy. In other words, the system can have shared value-chain intelligence without sharing data.
2. Construction: The information can be harmonized into a network representation with the correct nodes and links.
3. Customization: Users can customize the resultant value chain maps with their organization specification information, groupings, and similar.
4. Value-chain specificity: The information can allow understanding of specific value chains at the part-site level of understanding. In other words, value chain understanding that is not at the company level, but rather facility-to-facility network operations can be understood in the context of the inputs they provide for the final product.

Nodes may include not only companies, but facilities, ports, products, individuals, vessels, countries, geographies, and more. Edges may cover movement of goods, locations of facilities, ownership of companies, directorship of companies, and more. Value chain management can include constructing a network graph data structure that covers more than just corporate relationships, but also the fundamental input-output relationships of product production. Such a part-site specific graph may allow part-site specific understanding of value chains at scale.

The network graph data structure 336 illustrated in FIGS. 3B and 3C can be constructed from both commercial and proprietary data. To do so, the system can obtain publicly and commercially available supply chain data. The system can focus upon datasets that describe physical movement of goods from facility to facility, rather than more abstract “business relationships.” In other words, documents such as bills of lading, manifests, customs declarations, and purchase orders. These documents can contain information on the sender, receiver, their addresses, the goods transported (both in free text and harmonized-system product category form), the ports, the vessels, and more. The system can augment the documents with commercially available information on corporate registries, embargoes lists, tariff incentives, free trade agreement qualification, and more. Such information can be identified with publicly/privately reported business relationships as appropriate.

However, public and commercially available data can be limited. For instance, such data may only be available for certain geographies and certain modes of transport. Operating on public data alone may not achieve the visibility necessary to solve the world's value chain problems—a disconnected, erroneous, or low-fidelity network doesn't help the participants. To understand value chains, system may need to be able to understand and connect the multiple stages of production from raw extraction through final distribution.

To do so, in some cases, the data processing system 306 can implement a federated system that permits each participant to have their own private “spoke” in which their data is secure and safe, but where derived analytics can be shared across desired participants. FIG. 3E demonstrates such a hub and spoke federated system 374, where all participants benefit from the derived analytics but sensitive information stays only with the participant that owns the information. Every participant can have a private enclave, in their jurisdiction of choice, where only they can see the entirety and fidelity of the data they put into the platform. Such participants are depicted in FIG. 3E as computing devices 304a-c, respective. Product details such as names, revenue, bills of materials, costs, supplier and customer experiences, and analytics on their supply chain are always private, never shared and only exist within each enclave. Third-party data procured by participants such as ESG scores, revenue importance, and custom calculations similarly privately enriches the individualized deployments. This functionality allows participants to wire in their own private information to the network graph data structure so they see a unified view of their world connected into the global map. Each participant benefits from seeing their data, kept for their private usage in their private enclave, bound to more visibility than any one country, let alone one company, has access to.

Participants can publish and share minimal information on linkages to allow mutual engagement and tracing of value chains. By sharing this minimal information on linkages, all participants can benefit from connectivity of the network graph data structure 336—the ability to traverse through multiple tiers. This connectivity can provide essential value to all participants, as it allows the participants to understand and manage their value chains across all stages of production. For this reason, the network graph data structure 336 can enable a collaborative supply chain graph, while preserving contributors' privacy, and competitive advantages.

The shared graph of intelligence assembled via the hub and spoke architecture can be constructed from documents with erroneous or woefully incomplete information. They frequently lack the detail necessary to go down to the part-site level. The data processing system can extract signal from the noise through the following steps: (1) recognizing and matching entities such as companies, addresses, ports, and products in many languages, robust to misspellings; identifying and correcting erroneous information, such as incorrect addresses, values, product categories (e.g., HS codes), and more; (2) imputing missing information, whether that is missing product categories, address components, values, or otherwise; and (3) solving these challenges can involve state-of-the-art machine translation, entity resolution, link resolution, deduplication, cross-linking of information, and domain specific optimizations to connect the data together in both a granular and scalable manner.

The data processing system 306 can leverage both classic machine learning and modern deep learning, including graph based approaches. Table 1 below provides an example of transformations of raw messy shipment information into canonicalized standardized representations.

| | | Canonicalized |
|---|---|---|
| Type | Original raw text | representation |
| Company | from warehaus rivilogistics by Globex | Globex |
| Company | AKME Ko B Ka3axcTaHe | Acme Co. |
| Address | 2 a calle 8 s n 53370 | Calle 8 No. 2 A, Industrial |
| | naulcalpan de juarez | Alce Blanco, Naucalpan De |
| | naucalpan de juarez | Juarez, Mexico, 53370, |
| | | Mexico |
| Product | Ladies 90% cotton 7% tencel 3% elastane | 6204.62.8011 (US |
| | woven denim pant | Harmonized Tariff System |
| | | Code) |
| | | Articles of apparel and |
| | | clothing accessories, not |
| | | knitted or crocheted— |
| | | women's or girls' suits, |
| | | ensembles, suit-type jackets, |
| | | blazers, dresses, skirts, |
| | | divided skirts, trousers, bib |
| | | and brace overalls, breeches |
| | | and shorts (other than |
| | | swimwear):—trousers, bib |
| | | and brace overalls, breeches |
| | | and shorts: of cotton:—other: |
| | | other: other: other—other: |
| | | women's trousers and |
| | | breeches: blue denim (348) |
| Product | [symbol] | 3006.20.00 |
| | | (Gulf Cooperation Council |
| | | Harmonized System Code) |
| | | [symbol] |
| | | [symbol] |
| | | [symbol] |
| | | [symbol] \| Blood-grouping |
| | | reagents |

The data processing system 306 can perform the following operations to generate Table 1 and similar tables:
map the raw fields to standardized fields;
use one or more artificial intelligence (AI) systems to parse fields with multiple values (e.g., name+address) concatenated into one field;
use AI systems to structure unstructured fields (e.g., address not structured by administrative granularity) into structured representations (e.g., a structured address);
use AI driven search systems to take obscure/opaque/vague descriptions and expand them (e.g., take a goods description that is just a parts number from a company specific parts database and replace it with a detailed description of that product); and
use AI systems to match to canonical representations based on a semantic understanding of the entity (e.g., company, address, product) regardless of what language/misspellings it has.

The data processing system 306 can perform this canonicalization based on the features (textual, numeric, categorical, graph) and contextual information such as involved parties, involved products, etc., in the raw document. The end result is both a canonical description of the entity and a canonical ID by which the entity can be referenced. If no canonical entity already exists, the data processing system 306 can create one.

The data processing system 306 can identify and correct erroneous or missing information functions in a similar manner. For example, the data processing system 306 can use AI systems to predict the field's information. If it differs from the provided original information, the data processing system 306 can flag and correct the discrepant information (e.g., an erroneous product code or monetary value). If it's empty, the data processing system 306 can predict the correct value. In both cases, there is a measure of confidence in the prediction that is calibrated for at least a threshold accuracy/quality. One particularly notable correction is for supplier addresses. In some cases, customers have supplier lists that either have no address information or provide the supplier's HQ, not the true production facility address. The distinction, and the data processing system 306's systemic correction of this error can be used accurate construction of part-site specific value chains.

Users of the network graph data structure 336 may customize the network graph data structure 336 with their organization and user-specific information. Users may do so, for example, through:
1. Addition of organization-specific scores and values: For example, internal parts numbers for products, ESG scores for different facilities, previous return rates on investment in trade financement.
2. Organization/user-specific groupings of entities: the ability to group multiple entities (e.g., companies, facilities, products) represented in the network graph data structure into one grouping. For example, an organization may wish to see all the activity of a given supplier cohort grouped together, ignoring distinctions between the underlying companies.
3. Attachment of source documents and files: Backing files serving as backing information for the entities.
4. Storage of notes: Specific additional information provided by users and organizations on the entities.

The data processing system 306 can provide above capability in customer private-enclave-specific (e.g., spoke specific) instances. In doing so, the data processing system 306 can provide each customer with the capability to customize the network graph data structure 336 as necessary for their organization. The sensitive information described herein may stay in each private deployment and, in some cases may never transmitted back to the hub.

Additionally, understanding physical production and acting upon the physical production can require understanding the steps from raw material extraction through final distribution. Within their private enclave, customers may have their bill of materials for their products. However, they may not have the recursive bill of materials—the inputs for their inputs or the inputs resulting from their outputs. This information may be required to understand the original and intermediate processing that led to the product, as well as the intermediate and final consumption, as illustrated in FIG. 3D.

To construct this understanding, the data processing system 306 can integrate, in the private enclave, the customer's bill of material information. Combined with the customer's supplier list, this gives the first tier understanding of production facilities and inputs for each customer product. Then, the data processing system 306 can apply an AI-based understanding of input-output relationships to understand value chains to understand the network of production conditional on the good being produced. The data processing system 306 can use the network graph data structure 336 to filter a set of relationships to only include the value chain for a vehicle gearbox, for example, while disregarding all irrelevant links and associations related to other goods at the same facility. The data processing system 306 can do so by producing and applying a recursive map of the relationship between inputs and outputs, a function estimating the “bill of materials” for all physical goods. Using deep learning, graph information/modeling, and generative AI, the data processing system 306 can derive this input-output relationship for all goods, thus allowing the refinement of site-specific exchange of goods to be conditional on specific products. This understanding can then be refined, in some cases, by a human collaborating with internal and external parties.

The resultant graph of global value chains may be, post-harmonization, gigantic in size, in some cases including billions of transactions linking 100s of millions of entities. The data processing system 306 can identify the most relevant parts of the network graph data structure, individual entities, shipments or sub-networks (“sub-graph data structures”) involving companies, addresses, products, shipments, ports. The data processing system 306 can do so using cutting edge AI, exceptional engineering, deep product understanding, and insightful design to achieve these tasks. The underlying systems and industrial ecosystems represented by the network graph data structure are complex, and easy answers are uncommon. The data processing system 306 can implement the systems and methods described herein to generate and process the network graph data structure 336 for:
Compliance: Complying with and enforcing environmental (e.g., Scope 3, deforestation, etc.), human rights (e.g., forced labor), tax/tariff/duty, export controls, sanctions, national security, and other laws and regulation across multiple country's regulatory environments.
Sourcing and procurement: Analyzing existing and potential suppliers and buyers at scale across 10s of thousands or more relationships.
Resiliency: Proactively and reactively understanding potential disruption to value chains at the scale of multinational corporations or nations. Analyses include understanding bottlenecks, exposure to current or potential adverse events (e.g., a factory being destroyed), multi-tier exposure to geopolitical risk geographies, and more. Such resiliency is critical to continued corporate operation as well as economic and national security.
Insurance: Usage of the above resiliency information to offer and price novel forms of business-interruption coverage. Understanding resiliency at scale enables origination and pricing of insurance that could not profitably previously be offered due to lack of information on the extended value chain. Contingent business interruption insurance, insuring against extended disruptions in the value chain, was previously unavailable at desired volumes due to the difficulty of understanding extended value chain relationships. Insurers can now offer such insurance while understanding extended risk and concentrations, and insureds can benefit from the surety that such insurance brings.
Trade facilitation and prevention of illicit activity across borders: Logistics parties, multinational corporations, and governments can collaborate together to ensure facilitation of legitimate cargoes and targeting of illicit activity. Positive value chains are promoted and aided in filing of required paperwork, negative value chains (such as narcotics production) are impeded.

The data processing system 306 has several features that facilitates generation and processing of a network graph data structure that represents a real-time version of multiple value chains. For example, the data processing system 306 can use security features such that the represented data remains safe using information security programs, secure software development lifecycle, and segmenting customer accounts. The data processing system 306 may be deployed into various secure environments across the globe. These controls help service the goal of securing data.

Another advantage is that the system supports granular role-based access controls to put individual organization's administrators in control of who in the organization can see which details, as well as external collaboration with other parties.

In some cases, in the context of sensitive applications, the data processing system 306 can support selection and vetting of which specific users (e.g., government-associated users) can access private deployments. The most standard use case is for public sector deployments where all access must be done by vetted/security-cleared individuals, often from that nation.

In some cases, the data processing system 306 may never share raw data between spokes without explicit instructions for collaboration between trusted parties. The default may be that no direction is enabled. Rather, the system can facilitate sharing of network visibility, analytics, and shared AI models without moving raw data.

The data processing system 306 can provide individual customers a private enclave where they, and only they, can see the entirety of the data their organization puts into the platform. Product details such as name, revenue, bill of materials, costs, supplier and customer experiences, and analytics on the customer's supply chain are always private, never shared and only exist in the private enclave. They are processed and harmonized with the network graph data structure's broader multi-tier view while remaining within that individual enclave.

To facilitate the value chain network function, and connections between buyers and suppliers in multi-tier value chains, the data processing system 306 can facilitate minimal linkages necessary for engagement. After normalizing and canonicalizing the entities to the network graph data structure in the private-enclave, the data processing system 306 can anonymously connect the minimal details of a supply chain linkage to the central network graph data structure. These details include: the sender and receiver companies and locations; an intentionally vague description of the goods such as an HS code or summarized description; and the month of the transaction.

The source of the derived links derived via this canonicalization and anonymization may not be revealed to any other clients. This shared intelligence may allow each customer to in turn receive and connect to linkages provided by others.

The data processing system 306 can be, include, or otherwise interact with a federated learning system to generate the network graph data structure 336 and generate metrics and intelligence across users or entities. Federated learning is a field of machine learning focused on how to learn in a privacy preserving manner that does not share nor combine data. One example of use of federated learning is customization of suggestions when an individual types on a cell phone. The system learns across many devices by learning on the device and never transferring the raw data, only the trained model, back to a central hub. All users thus benefit without ever sharing any typing history such as passwords, loved ones' names, or full messages back to the cloud.

The data processing system 306 can implement federated learning across a number of features of generating and processing the network graph data structure 336. In doing so, the data processing system 306 can preserve user privacy while providing the benefits of aggregating data from a large number of data sources. Examples of how the data processing system 306 uses federated learning include the following:

Value chain construction: Many facilities receive shipments of coffee, but these are very unlikely to be relevant to a particular product's specific value chain for any product that is not in the coffee category. As such, the data processing system 306 can implement a process which smartly builds product value chains from the network graph data structure creating specific and granular understanding down to the material category, type of input (e.g., ingredients, capital goods, packaging). Customers can engage and refine these value chains which further contributes to quality of this machine learning construction. The customer provided feedback, as well as rich product descriptions, and relationships may all be private to the users that provide the data. The data processing system 306 can train across the feedback on those classifications in a privacy preserving manner and such that each user may benefit from other customers' refinements. This technique has shown significant improvement in quality of value chain construction both within and across industries when compared to expert review.

A value chain can be constructed as a network graph data structure to provide the technical foundations of value chain management. The network graph data structure can be used to identify missing information or deficiencies and identify risk probabilistically. Users can collaborate in a risk/impact-oriented manner on top of the network graph data structure For example, the network graph data structure 336 can be used to generate or support product passports and trade facilitation.

Harmonized System (HS) Classification: Assigning HS codes to products may determine tariff rates and other global trade related requirements. Determining the appropriate HS code for a product is difficult, however, and most practitioners outside of customs don't know how to classify products correctly. The data processing system 306 can include suite of tools for both assigning HS codes to products as well as explaining these according to the general rules of interpretation, and using previous CROSS/BTI rulings to support a classification. To properly do this requires detailed product descriptions that are private to individual users. As such, the data processing system 306 can use federated learning to achieve these processes, while preserving the privacy of users' information, and enabling users to benefit from other users' refinements of the classifications.

Tariff/duty calculation: assessing the correct tariff requires calculation based on the HS code, the country of origin, free trade agreement qualification, input material origin, and similar. The data processing system 306 uses federated learning to assemble all this information without compromising data privacy and security

Free trade agreement qualification: similarly, qualifying for a free trade agreement requires multi-tier understanding of the value chain of the goods, the companies, facilities, countries, and processes involved, and the production of a certified representation of the good's production and certification. The data processing system 306 uses federated learning to assemble all this information without compromising data privacy and security

Trust scores: Shipment fraud and illicit goods may affect all players in the logistics and shipping space. To facilitate cross border trade, the data processing system 306 can generate a trust score based on customers' shipment interdiction history, proximity to embargoes, shipper history, and other attributes. These details may be private to customer relationships, however, all participants in the space would benefit from being able to identify contraband and smuggling better. The data processing system 306 can use federated learning across platform participants working in these areas to better identify shipment fraud and facilitate expedited clearance while preserving the privacy of specific customer history and never pooling any customer data together.

The hub and spoke of generating and processing the network graph data structure 336 can be applied for multiple internal departments/agencies to collaborate within or between governments. For example, the hub-spoke architecture described herein can facilitate secure collaboration within and across government agencies and governments themselves. The data processing system 306 can generate private copies of the entire architecture, and thus a private network/“intranet” of value chain information and collaboration may be generated. This architecture can thus enable collaboration between different departments/ministries without different rights to access different data. Furthermore, they can enable shared intelligence across national boundaries for sensitive national security and economic security use cases that require multi-national collaboration between cooperating/allied nations. Combined with the role-based access controls and government-ready secure deployments described above, the data processing system 306 can enable secure collaboration.

In some cases, the data processing system 306 may not synchronize any information, including derived information such as network visibility, analytics, or AI models, back to the hub from national deployments. In other words, national security users benefit from the platform provided by the data processing system 306 in support of their missions, and are given new abilities to collaborate with the private sector in service of security, economic growth, and resiliency through a shared source of truth, but maintain the classification levels and security of their agencies and departments.

In some cases, to preserve privacy and security, the data processing system 306 can transmit copies (e.g., versions, dedicated copies, dedicated version, etc.) of the network graph data structure 336 to the different computing devices 304 of the hub-and-spoke system. The copies can be dedicated copies for the respective computing devices 304, such that the computing devices 304 only receive data that the computing devices 304 are authorized (e.g., via stored permission of profiles for the computing devices 304) to receives. For example, the data processing system 306 can generate a copy 375 of the network graph data structure 336. The data processing system 306 can generate the copy 375 by identifying the data of the network graph data structure, such as the types of data, edges connected with specific nodes, specific nodes, etc., that the computing device 304d is permissioned or authorized to receive, view, or access. The data processing system 306 can identify such data by applying a schema or a set of rules or permissions stored in a profile for the computing device 304d or the entity associated with the computing device 304d. The data processing system can use such permissions to retrieve that that the computing device 304d is authorized to access, and generate a copy 375 of the network graph data structure 336 only with the retrieved data. The data processing system can transmit the copy 375 of the network graph data structure 336 to the computing device 304d. In this way, the data processing system 306 can preserve the privacy of certain types of data for different nodes, while still providing different spokes of the federated system with access to the network graph data structure 336.

By implementing the systems and methods described herein, the data processing system 306 can generate a network graph data structure using a hub-spoke federated learning system with privacy preserving techniques to provide industry-wide insights while protecting confidential information.

FIG. 3F illustrates an example flowchart of a process 376 for network graph data structure-based networking, in accordance with an implementation. A data processing system (e.g., the data processing system 306, shown and described with reference to FIG. 3A) can perform the process 376 to generate and/or update a network graph data structure representing the network between facilities for networked item transformation and/or transportation. The process 376 can include any number of operations or additional operations and the operations may be performed in any order.

At operation 378, the data processing system can receive one or more electronic records. The data processing system may receive the electronic records from one or more computing devices of different facilities that are involved in a network of value chains representing the transport and/or transformation of networked items.

At operation 380, the data processing system can parse the one or more electronic records. The data processing system can parse the records using natural language processing techniques and/or language processing models to identify specific entities or data included in the electronic records. The data processing system can store the parsed data in a database, such as a system of record that maintains the data for the network of value chains.

At operation 382, the data processing system can generate nodes in a network graph data structure. The data processing system can generate the nodes based on the electronic records and/or the parsed data such that each of the facilities corresponds to a different node in the network graph data structure. Each of the nodes can include node field-value pairs for different characteristics or attributes of the facilities represented by the respective nodes.

At operation 384, the data processing system can connect nodes in the network graph data structure. The data processing system can connect the nodes in the network graph data structure with edges. Each edge can represent a different network operation or transaction. For example, an edge between two nodes can represent transport of a networked item or component from one facility to another facility. The data processing system can generate any number of edges between pairs of nodes.

Each edge can be or include a data structure. The data structure can include data about the relationship indicated by the edge between the nodes. For instance, the data structure can include an identification of the networked item transported between nodes, a time and/or date of the transportation, a quantity, etc.

At operation 386, the data processing system can generate one or more networked item digital records. The data processing system can generate the networked item digital records in response to one or more requests to generate the passports, for example. The data processing system can generate a networked item digital record by identifying one or more nodes or sub-graph data structures of the network graph data structure to include in the networked item digital record. The data processing system can identify such nodes or sub-graph data structures based on identifications of the nodes or sub-graph data structures in a request. The data processing system can generate the networked item digital record to include identifications of each of the identified or nodes or sub-graph data structures and/or the data structures of the nodes or sub-graph data structures themselves. In some cases, the data processing system can include an identification of a networked item profile or the networked item profile itself in the networked item digital record. The data processing system can generate and store such networked item digital records in the network graph data structure or a separate database in a file. Subsequently, the data processing system can transmit the networked item digital record to another computing device to either provision the computing device with access to the data structures (e.g., the nodes, the networked item profiles, the sub-graph data structures, etc.) identified in the network graph data structure and/or provision a copy of the data structures included in the networked item digital record to provide a view of the data represented in the networked item digital records.

Implementations of the current solution provide systems and methods of addressing technical challenges in network systems, focusing on the real-time construction of node graphs, faster and more accurate data retrieval methods, federated system controls, and communication across network systems. First, the solution tackles the complexity involved in representing large-scale permutations of input-output relationships within node graphs. These graphs can be constructed in real-time and accommodate dynamic updates to maintain an accurate end-to-end matrix of relationships. Second, improvements to data retrieval processes are implemented by structuring node graphs into sub-graph data structures that represent specific value chains for specific networked items across networking systems. These improvements allow for targeted access to pertinent data and reduce computational overhead through intelligent navigation and traversal of the edges of the graph. Federated systems offer data privacy by implementing controls over node graph sharing. Data can be segmented within private enclaves, accessible only to authorized entities, while insights are shared without the transmission of raw or proprietary data. Furthermore, the architecture facilitates seamless communication and collaboration between systems and users across value chains over the complex network. This configuration enables efficient data updates and retrieval over the network, providing real-time synchronization, reduced latency, and improved coherence within interconnected systems.

The technological problem addressed by real-time construction of a node graph centers on the complexity and scalability of mapping intricate input-output relationships within large-scale systems. Conventional systems often encounter difficulties when attempting to represent the extensive permutations of transactional and procedural interactions across an entire network. As such, limitations in processing capabilities hinder the ability to produce comprehensive and dynamic models, resulting in fragmented or incomplete depictions of these relationships. This constrains computing device ability to analyze, plan, and improve processes across large scale networks and systems that are useful for more efficient operations.

The techniques described herein provide a technical solution through the development of a node graph architecture designed for real-time integration and analysis of large data sets. This architecture can dynamically construct node graphs that encapsulate different permutations of input-output connections within an end-to-end framework. Advanced algorithms can be deployed to continuously update and reconcile the graph structure as new data inputs become available. This includes identifying and relating comprehensive network nodes, allowing the system to seamlessly integrate diverse data points and maintain an up-to-date, accurate representation of the large scale network that continuously grows and changes.

The implementation of real-time node graph construction results in several technical enhancements. This construction provides continuous data integration into the node graph with continuous updates to the nodes and the edges between nodes within the node graph, ensuring that systems have up-to-date information streams. Accordingly, the construction can eliminate or reduce latency in data availability. The node graph structure facilitates efficient data indexing and retrieval, allowing for faster access to pertinent system relationships than conventional systems data storage and retrieval techniques or data storage and retrieval techniques that involve a node graph data structure. This capability can facilitate swift propagation of updates across the system, thus enhancing the system's responsiveness and scalability.

The technical problem addressed by improving data retrieval in node graphs entails the inefficiencies and inaccuracies associated with accessing relevant information from complex graph data structures. Conventional methods of data retrieval can struggle to efficiently navigate vast graph networks, especially when attempting to extract pertinent details related to sub-graph data structures that represent specific value chains. These challenges arise from redundant or unoptimized search processes, which often lead to increased retrieval times and higher computational costs, while failing to effectively pinpoint or prioritize the most relevant data subsets necessary for analysis.

The techniques described herein offer a technical solution by implementing advanced data retrieval through the structure of node graphs, particularly focusing on sub-graph data structures within these networks. This solution includes algorithms that can intelligently navigate the node graph, identifying sub-graph data structures that correspond to specified value chains or sub-graph data structures. Such algorithms can improve search paths and employ heuristic techniques that reduce retrieval time and computational overhead. By structuring data access around the segmentation of the graph into sub-graph data structures, the system can more efficiently target and extract relevant information.

The improved data retrieval techniques yield several technical enhancements in accessing and utilizing specific subsections of a broader node graph. These techniques increase the precision of data query results, ensuring high accuracy by effectively filtering out irrelevant data points. They also enhance retrieval efficiency and accuracy that reduce query response times, allowing fast access to relevant data subsets. This facilitates real-time data analytics capabilities, enabling systems to quickly process and analyze specific value chain segments. The improved retrieval mechanisms support enhanced data throughput and minimize bottlenecks in information processing, contributing to the system's overall responsiveness. Additionally, these techniques improve and/or optimize computational resource allocation by minimizing data redundancy and ensuring efficient utilization of processing power across networked system.

The technical problem associated with federated systems and the control over node graph sharing arises from the need to balance collaborative data integration against data privacy and sovereignty constraints. In traditional centralized data systems, sharing comprehensive data sets poses risks to confidential information and often violates regional data protection regulations. As organizations engage in shared networks, the challenge is to allow effective collaboration while ensuring that sensitive elements of the node graph remain protected and are only shared with authorized entities.

The techniques described herein introduce a federated system architecture designed to control specific node graph sharing, thus mitigating privacy concerns while still facilitating collaborative benefits. This system can segment the node graph into isolated private enclaves for each participant. Within these enclaves, data remains secure and local, accessible solely to the owner. Federated learning techniques are employed to derive shared insights without actual data transmission, enabling the selective sharing of insights rather than raw data. The system allows participants to define granular sharing controls, specifying which segments of the node graph are accessible and under what conditions, ensuring alignment with privacy and regulatory standards.

The implementation of federated systems with controlled node graph sharing results in several technical improvements. These systems uphold robust data privacy through decentralized data management, minimizing the risk of exposure by keeping data within local storage environments. By utilizing federated learning, the system aggregates insights without raw data transfer, maintaining data integrity and sovereignty across network nodes. This decentralized approach reduces the attack surface for potential breaches, significantly enhancing system security. Additionally, the architecture enables seamless integration of proprietary data into a collective analytical model, optimizing inter-organizational data processing without compromising the proprietary data. This configuration allows for efficient parallel processing and model refinement, facilitating advanced analytics and machine learning applications across distributed environment

The technical problem in networked systems, particularly within the context of systems operating across the value chain, is the challenge of seamless communication and data exchange with a central system. Traditional networked systems often experience latency, data inconsistency, and bottlenecks when numerous disparate systems attempt to update and retrieve information over a central network. These issues are exacerbated by the scale and complexity inherent in value chains, which traverse multiple entities and geographical locations, necessitating robust and efficient communication mechanisms to maintain coherence and synchronization of data across the network.

The techniques described herein propose a technical solution through the implementation of an advanced graph node architecture that facilitates efficient communication between systems across the value chain and a central system. This solution can involve configuring the central system as a nodal hub, where each node in the architecture represents specific entities or processes within the value chain. Alternatively, the solution can involve configuring decentralized nodes that communicate with no central hub, achieving decentralized communication and privacy. These nodes are interconnected in a manner that reflects the actual input-output relationships, allowing for streamlined data propagation and retrieval. The architecture can employ algorithms that dynamically adjust node connections based on network traffic, ensuring optimized data routing that minimizes latency and improves overall efficiency.

The implementation of a graph node architecture within networked systems enhances several technical aspects across the value chain. First, the architecture enables real-time data synchronization, reducing discrepancies and mitigating the risk of data inconsistency. This facilitates immediate data availability, enhancing the precision of analytics and decision-support systems. Second, the intelligent routing algorithms adjust node connections dynamically, which optimizes data flow and reduces latency throughout the network. This results in faster data processing times and improves system responsiveness under varying load conditions. Additionally, the architecture inherently supports fault tolerance by maintaining alternative pathways for data communication in the event of a node failure, thereby ensuring continuous operation and system reliability. Overall, the advanced graph node architecture strengthens the technical infrastructure needed for efficient data exchange, contributing to a more robust and agile value chain network.

The technical problem associated with tracking real-world events, processes, and occurrences, such as the production and transportation of goods within a graph node system, stems from the complexity of accurately representing and managing the dynamic and interconnected nature of these physical activities. Traditional systems often lack the capability to integrate multiple aspects of physical processes, such as changes in location, status, and characteristics, within a cohesive and responsive framework. This leads to inefficiencies in monitoring the transformation and movement of goods, making it challenging to manage logistics, ensure compliance with transportation restrictions, and capture the nuanced transformation characteristics of inputs into outputs.

The techniques described herein provide a technical solution through the implementation of an intelligent node graph system that can model and track the multifaceted nature of networking events in real time. The system can use advanced data analytics to map and update each node's attributes as networked items progress through various stages of their lifecycle, such as from creation, through transportation, to final transformation. Each node within this architecture can represent specific goods, transportation modes, or transformation processes, capturing relevant data points, such as location, condition, and transformation metrics. This setup allows the system to dynamically allow or restrict transportation based on predefined criteria and regulatory requirements, integrating these constraints into the decision-making functionality governing the network.

The implementation of this graph node system results in several technical effects useful to managing physical processes. The system enhances data acquisition and integration capabilities by providing precise real-time updates of physical attributes and changes within the network. This significantly improves monitoring accuracy by reducing dependency on manual tracking, thereby minimizing tracking errors. The architecture supports the orchestration of logistics operations by facilitating data-driven adjustments and enabling instantaneous data updates to relevant nodes. Automated enforcement of restrictions through system integration enhances compliance and regulatory adherence within the network. The standardized data framework within the system supports interoperability across different technological platforms, facilitating seamless data exchange and system integration. Overall, the system optimizes computational resources by structuring heterogenous data inputs into a cohesive, scalable architecture, improving the overall reliability and efficiency of monitoring events and processes.

The technical problem related to enabling collaborations between users on a graph network while tracking products lies in the challenge of facilitating seamless and secure data exchanges among diverse entities. Traditional systems struggle with synchronizing real-time updates and ensuring compatibility across different data formats. Moreover, protecting sensitive information while still allowing effective collaboration presents a significant technical hurdle. These issues can lead to inconsistencies and inefficiencies, impacting the effectiveness of the collaborative workflow.

The techniques described herein offer a technical solution through the development of an advanced graph network architecture. This architecture supports secure, real-time collaboration by employing cryptographic protocols and robust access controls, ensuring that data confidentiality is maintained. It provides mechanisms for integrating diverse data inputs into a cohesive structure, enabling consistent updates and data visibility across the network. By implementing dynamic access controls, the system can facilitate efficient information sharing that aligns with user roles and collaborative activities.

The implementation of this collaborative graph network results in several technical effects. The system ensures real-time data synchronization across users, minimizing discrepancies and enhancing the consistency of information. Secure data exchange can be facilitated through encryption and access control measures, restricting access to authorized users and preserving data confidentiality. The architecture integrates disparate data inputs into a unified format, enhancing data coherence across various systems. Additionally, adaptive management of user permissions through dynamic access controls enables efficient collaboration, ensuring data sharing aligns with security policies. These improvements contribute to a more resilient and efficient framework for tracking products and facilitating user collaboration within the graph network.

The implementations of embodiments of the present solution results in several technical advancements that significantly enhance system capabilities. Improved data retrieval algorithms ensure high accuracy and reduce query response times, facilitating real-time analytics. Intelligent node graph constructions can enable continuous data integration, precise monitoring, and efficient parallel processing, improving resource allocation and system responsiveness. Federated systems can uphold data privacy while allowing collaborative information sharing, enhancing system security and integrity. Advanced graph node architectures can provide real-time synchronization and fault tolerance, contributing to robust data exchange across the value chain. Systems for tracking physical events and facilitating user collaboration improve monitoring accuracy and regulatory compliance while supporting seamless data integration and communication. Overall, these solutions collectively optimize system reliability, efficiency, and the technical infrastructure needed for streamlined operations across complex network systems.

### D. Network Graph Data Structure-based Prompt Generation and Enrichment for Large Language Model Classification

Conventional approaches to automated classification using LLMs typically operate on unstructured textual descriptions without incorporating real-time structured relational context from graph data. As a result, inferences and classifications produced by such systems are frequently prone to hallucinations, or outputs that are syntactically coherent but are factually incorrect. These deficiencies are more pronounced when an accurate classification depends on the relationship of a given networked item to both its source and destination nodes and the surrounding context of those nodes within the graph. Conventional systems do not or otherwise fail to traverse the graph to identify relevant sub-graph data structures or to integrate such graph relationships into LLM input prompts. The absence of grounded relational data leads to higher misclassification and hallucination rates, diminished confidence in system outputs, and potential operational or security risks in domains that rely on accurate automated decision-making.

In some embodiments, the computing system of the present disclosure addresses these shortcomings by querying sub-graph data structures within the network graph data structure. The computing system can do so in response to a received request identifying a networked item linked with the sub-graph data structures. The computing system executes a task agent to perform a traversal operation (e.g., by causing the task agent to execute one or more searching engines or machine learning searching engine or language models to generate queries and then execute the generated queries) over relevant edges to identify both the source node and the destination node (e.g., the node associated with the source entity and the node associated with the destination entity, but described herein as source node and destination herein in some cases for brevity) for that networked item. Additionally, the computing system may determine a source node context, identifiers of one or more nodes connected with the source node, and a destination node context, identifiers of one or more nodes connected with the destination node. This targeted and automated extraction of relational context from the network graph ensures that subsequent classification operations are anchored to verifiable, structured graph data representing the actual relationships between entities.

The computing system then generates a prompt comprising features of the networked item including a textual description of the identified networked item along with the identifiers for the source and destination nodes. In particular embodiments, the prompt further incorporates the source node context and destination node context directly into its content. The prompt is transmitted to the large language model (e.g., via an LLM application programming interface (API)), which is executed by the computing system to produce both a classification for the networked item and a confidence score for that classification. By embedding verifiable, structured graph relationships into the LLM input, the computing system constrains the model's generative process and materially reduces the risk of hallucinations. This design can bind the LLM inference process to live, structured graph data, reducing any hallucinations generated by the LLM.

Upon obtaining the classification and associated confidence score, the computing system compares the score to one or more thresholds to determine whether the result satisfies an established confidence criterion. When the threshold is met or exceeded, the computing system generates a user interface identifying the classification and the corresponding networked item, and causes presentation of that interface at a computing device. When the confidence score falls below the threshold, the computing system may automatically retrieve supplemental networked item characteristics via an external search engine (e.g., across the Internet), generate an updated prompt including those characteristics, and re-execute the LLM. In some embodiments, the computing system stores records of misclassifications, including the cause and context, in a database and uses such records to retrain the large language model. These operations enable the system not only to deliver grounded, contextually accurate classifications in real time, but also to progressively improve model accuracy through structured feedback loops, thereby solving the technical problem of inaccurate, hallucination-prone LLM classifications in graph-based environments.

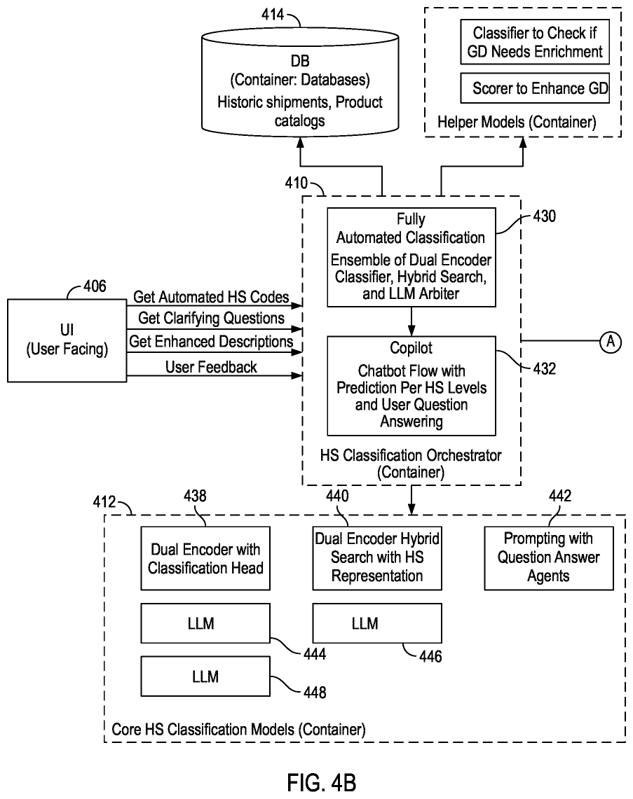

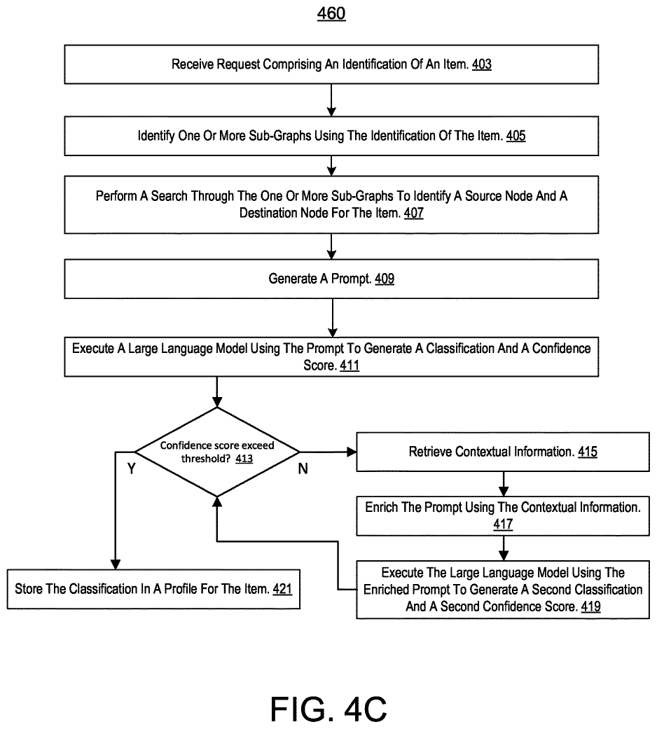

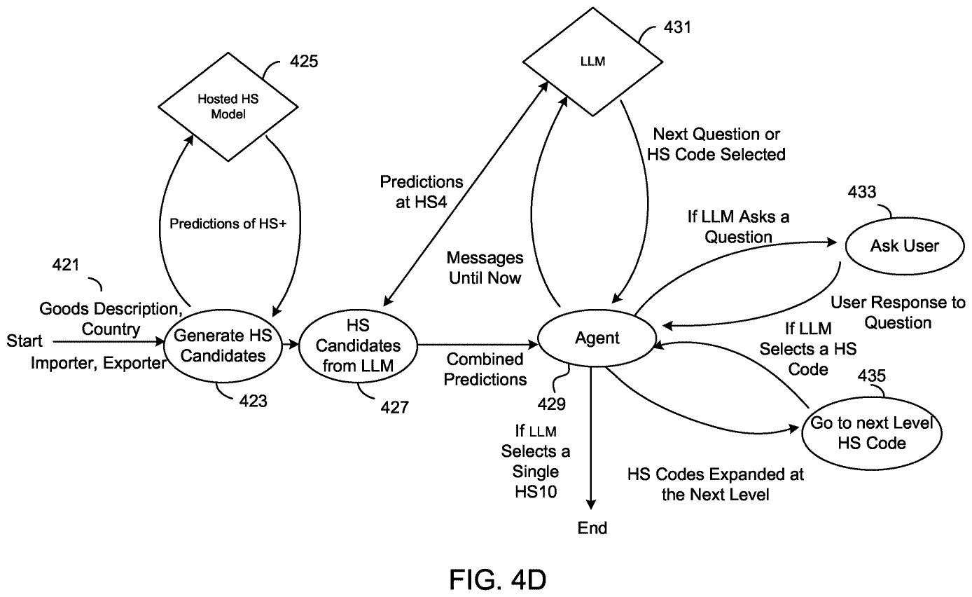

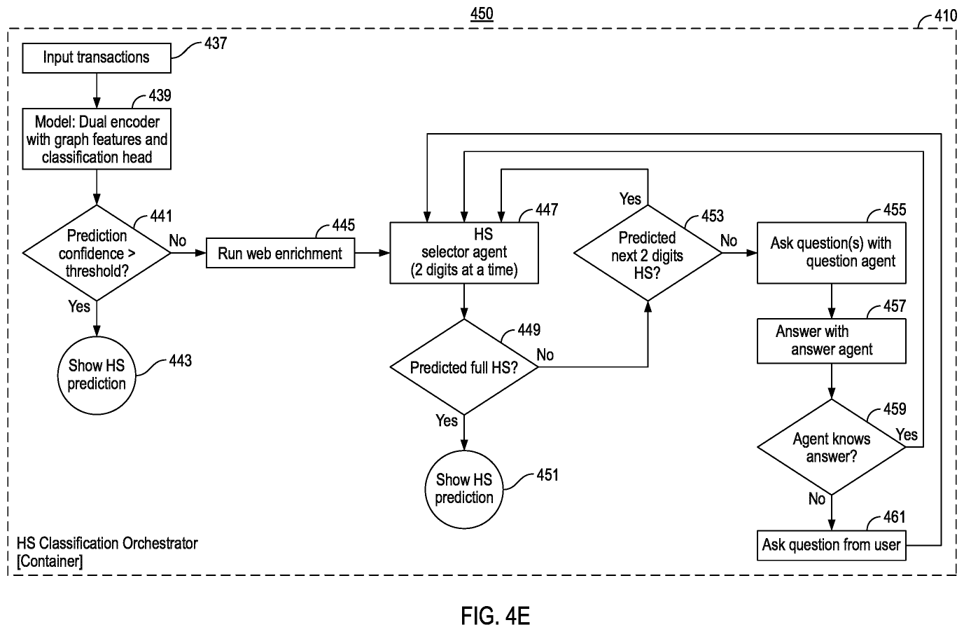

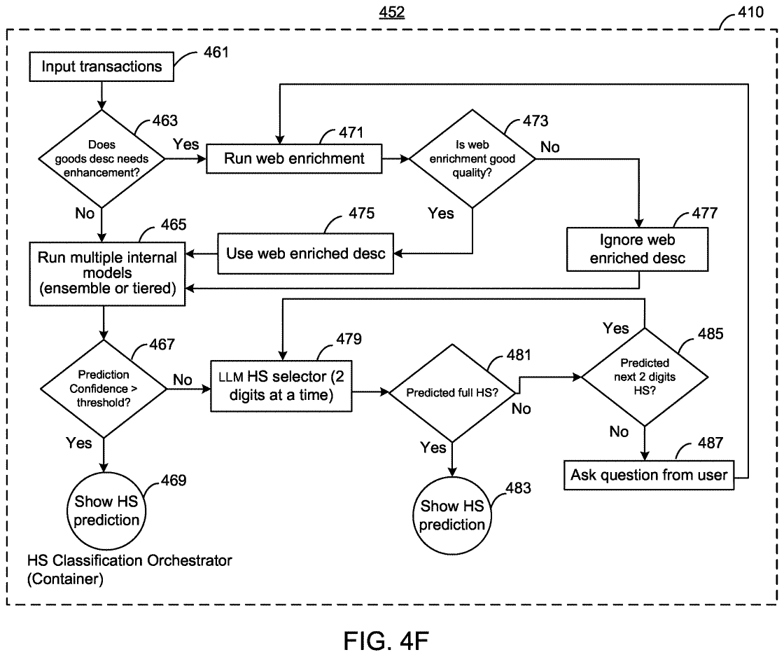

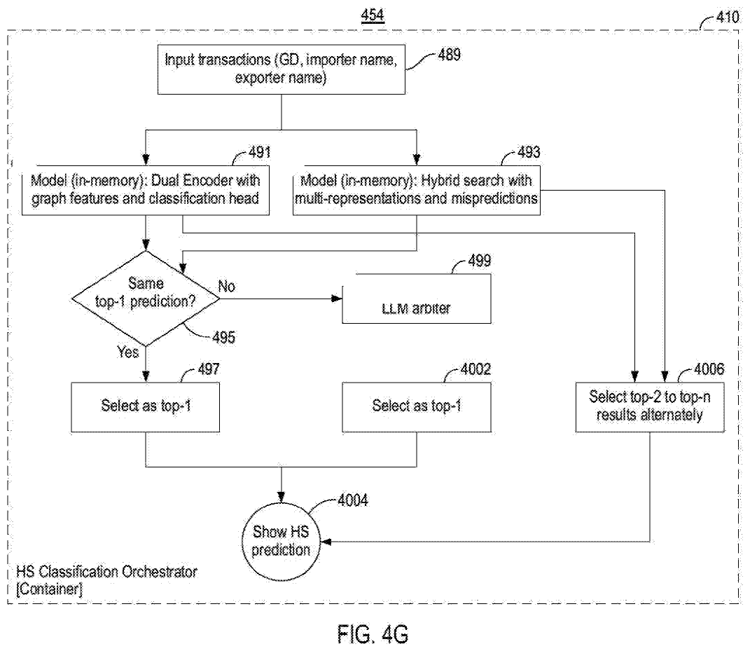

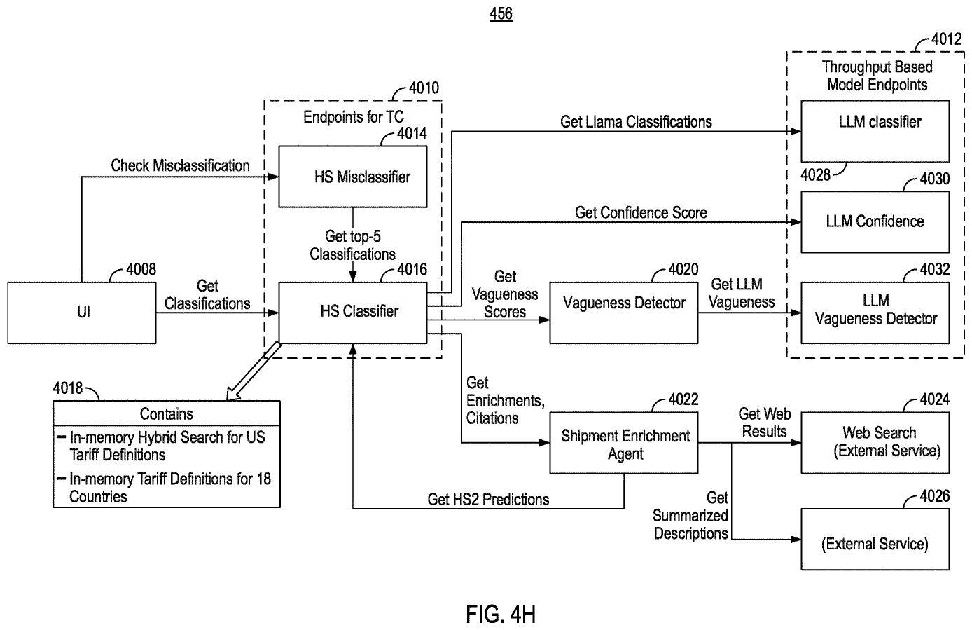

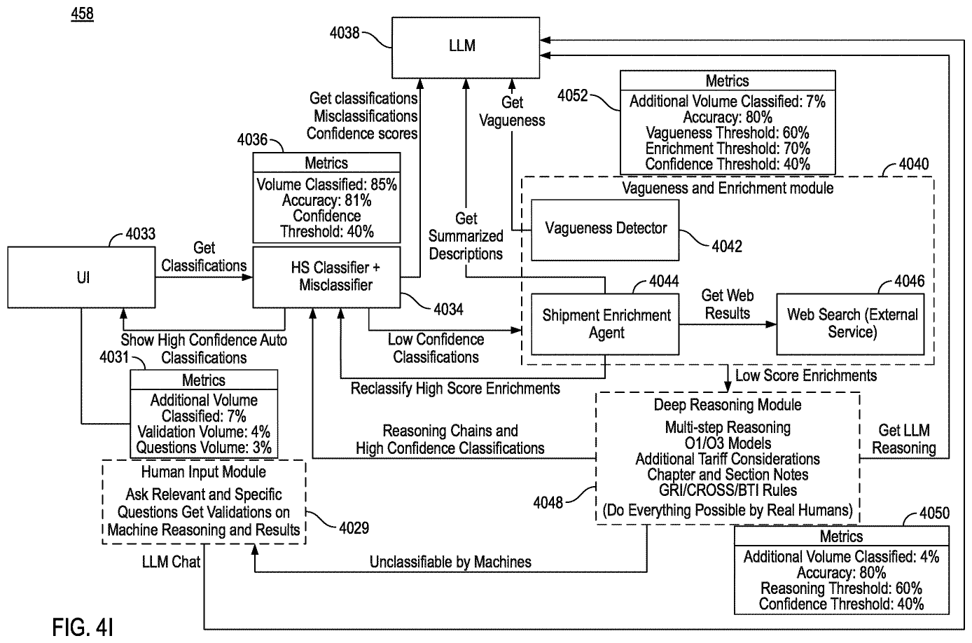

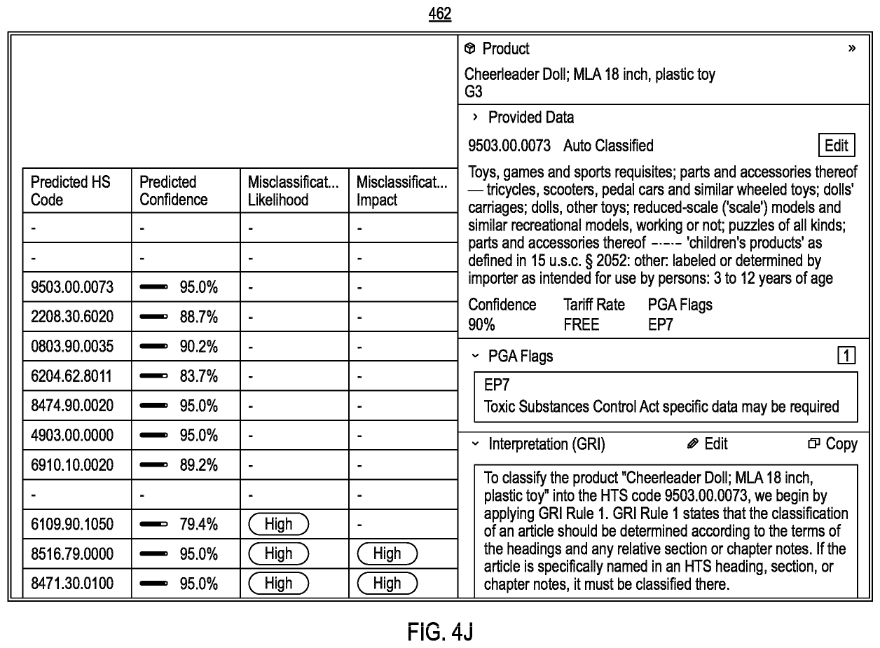

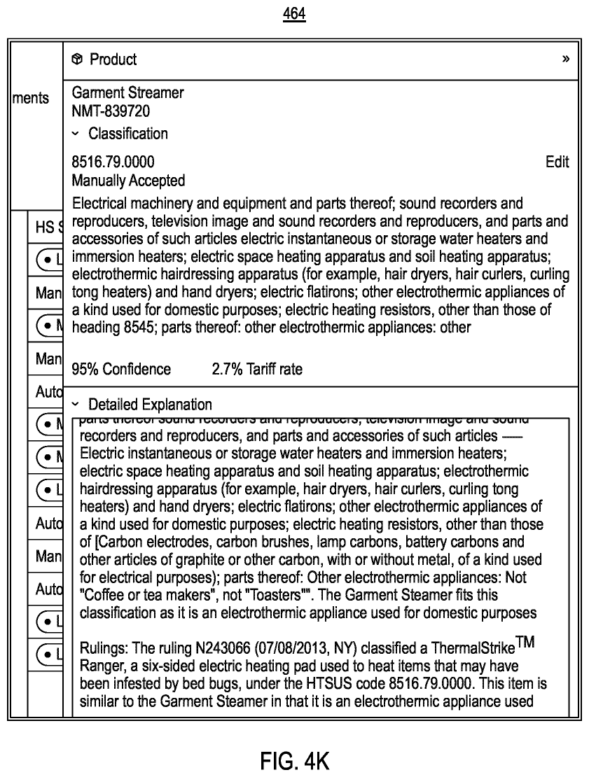

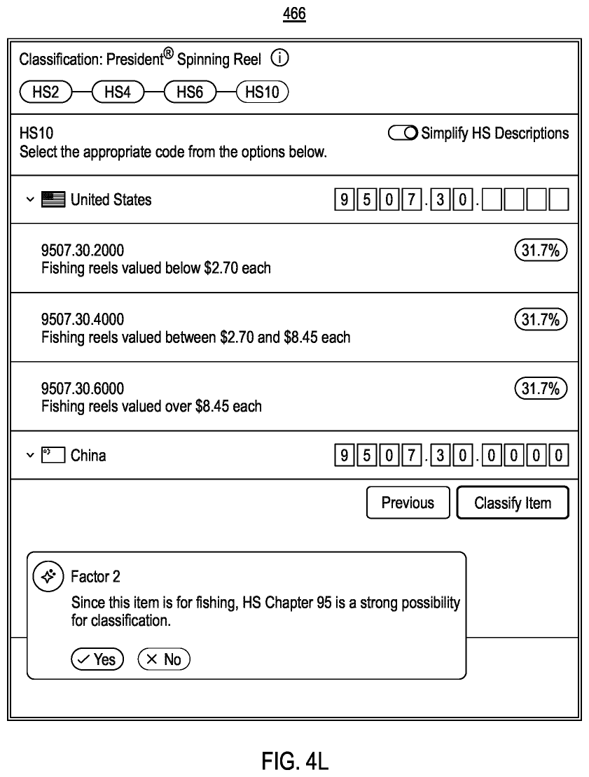

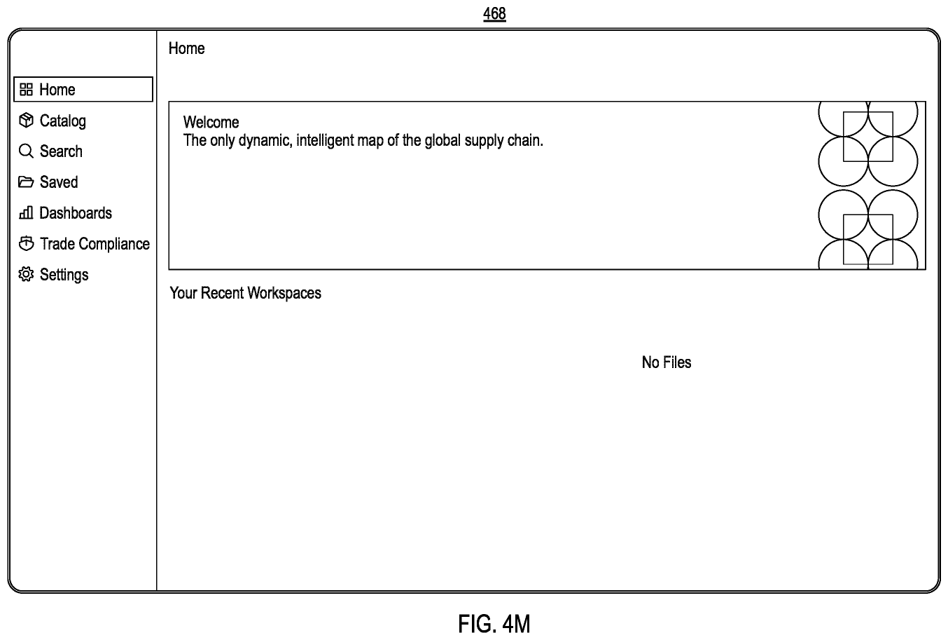

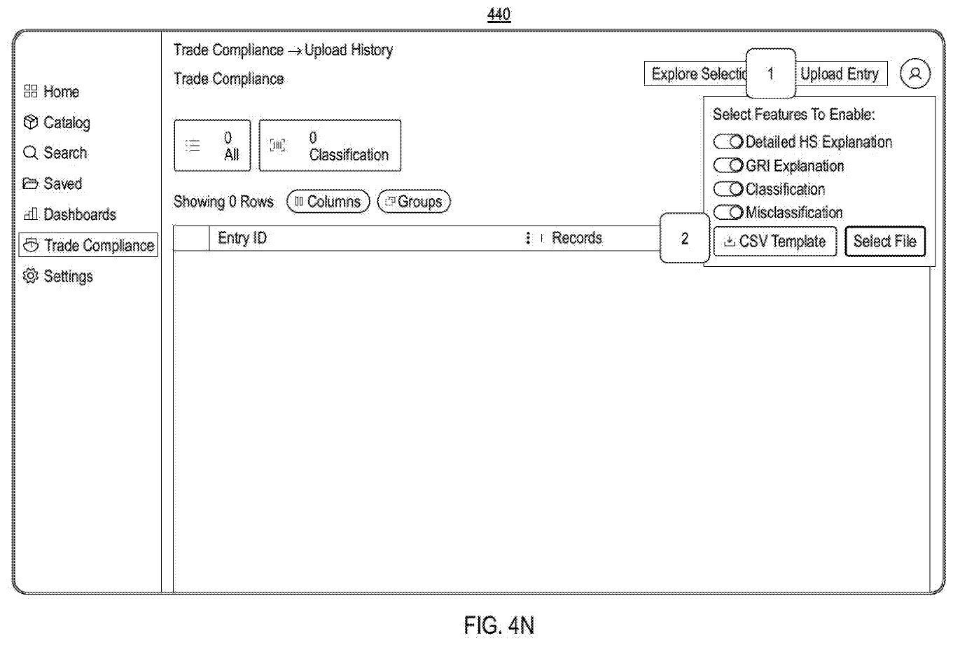

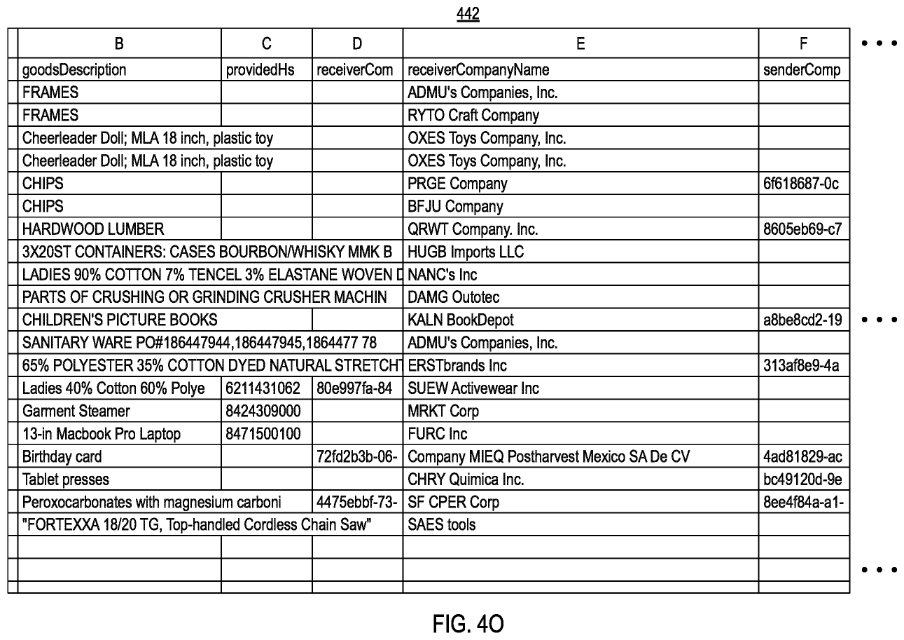

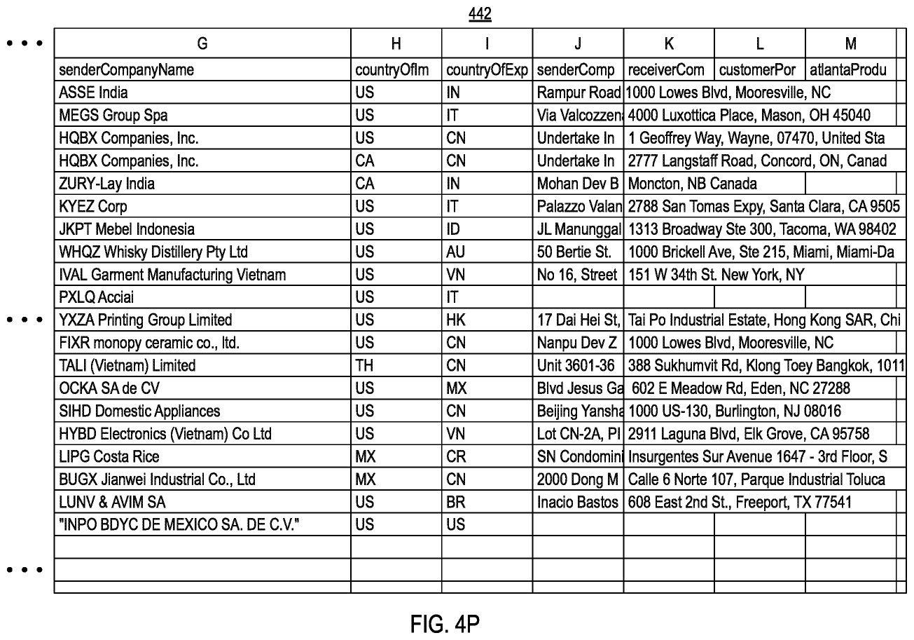

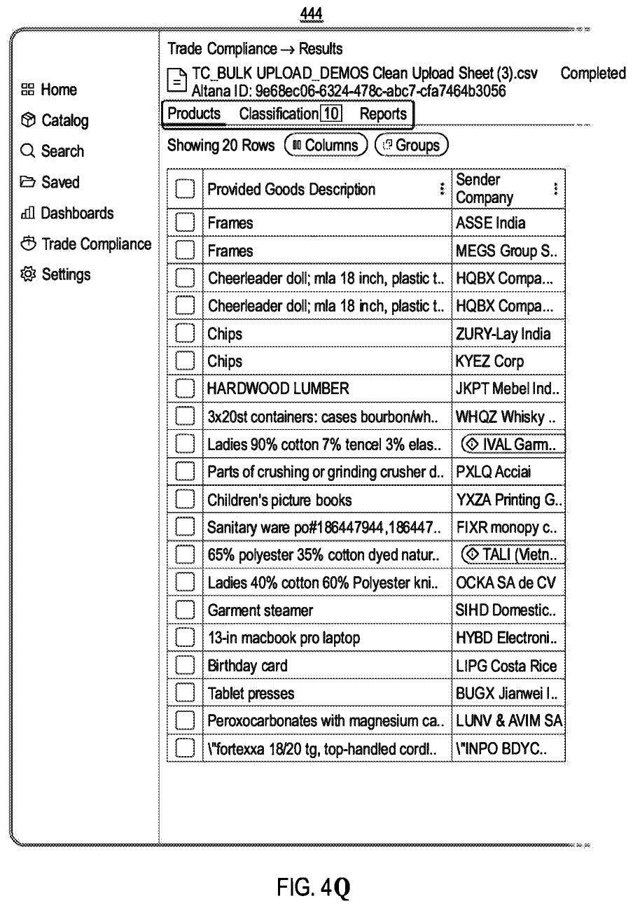

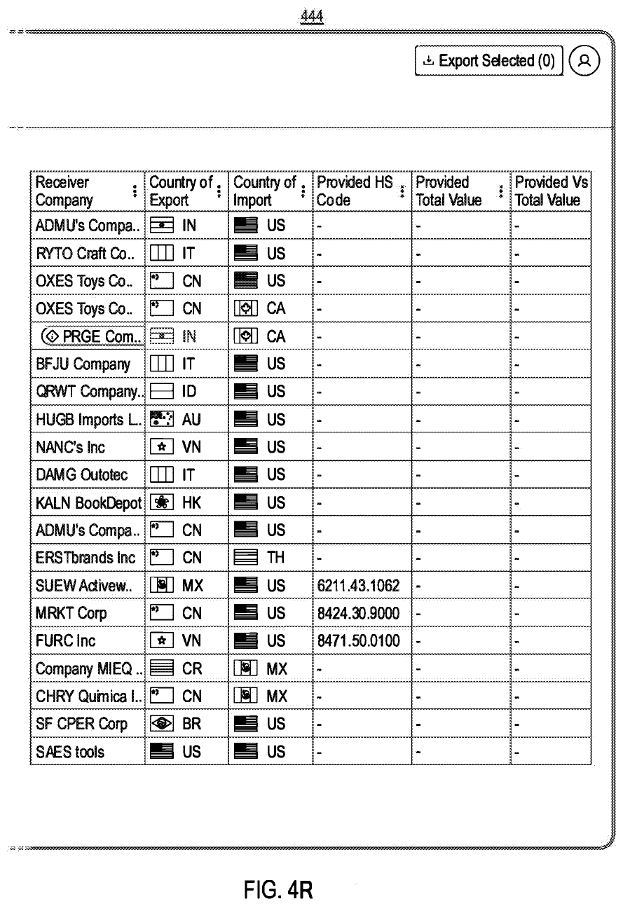

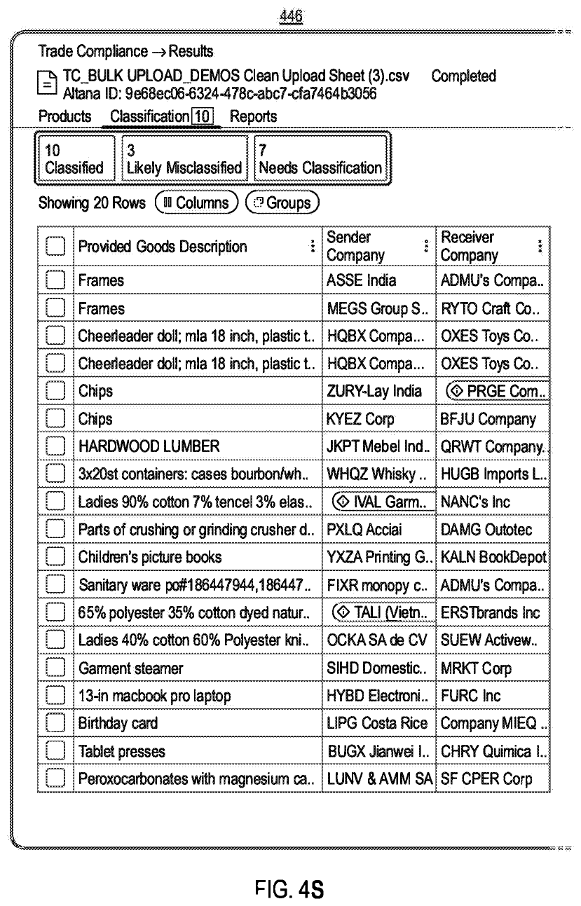

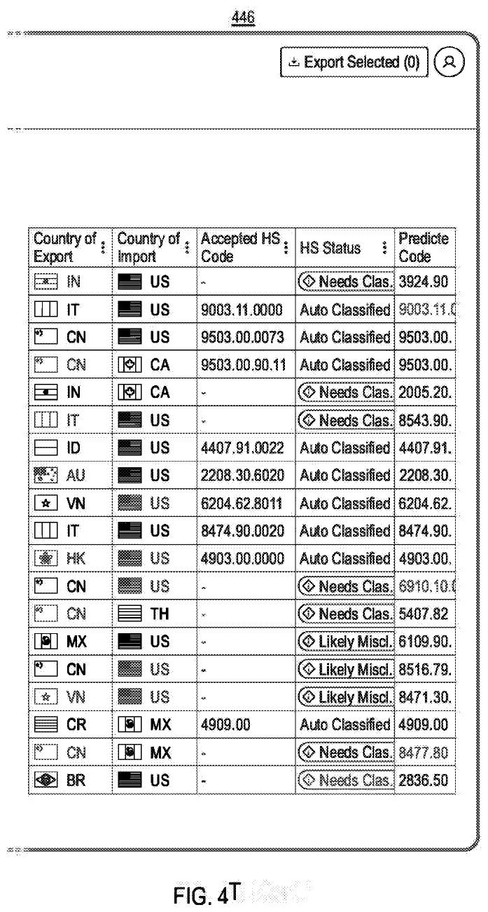

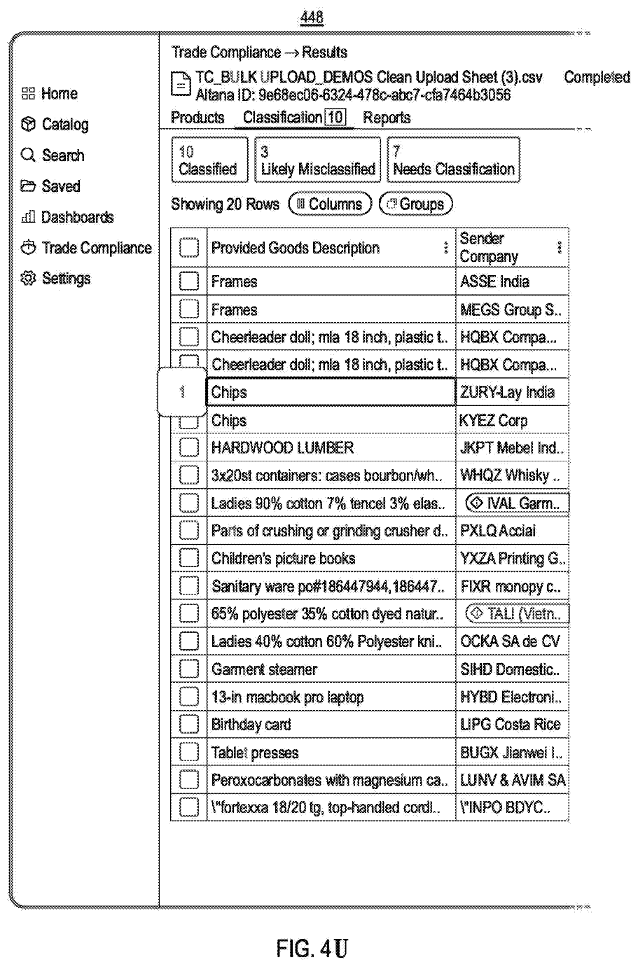

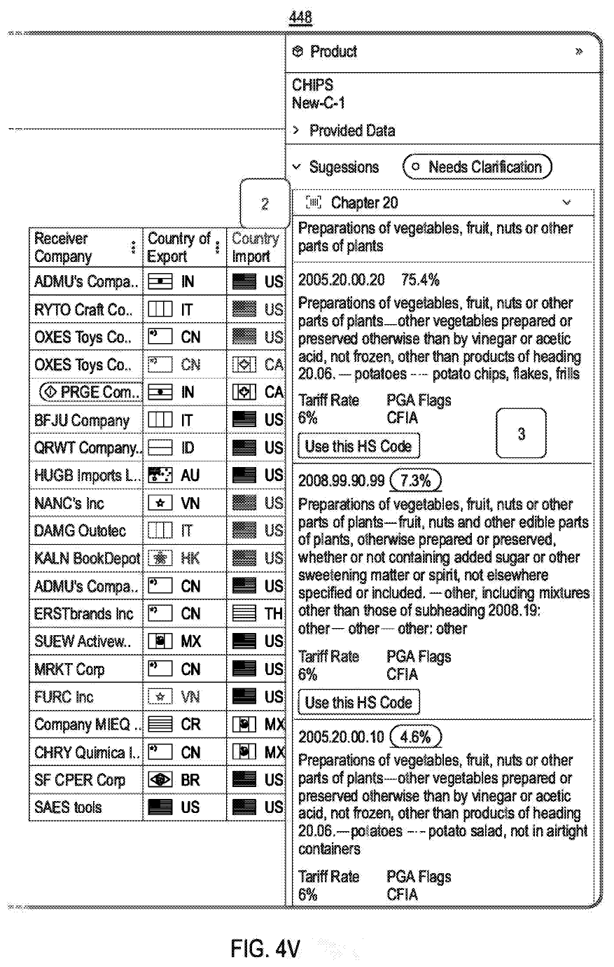

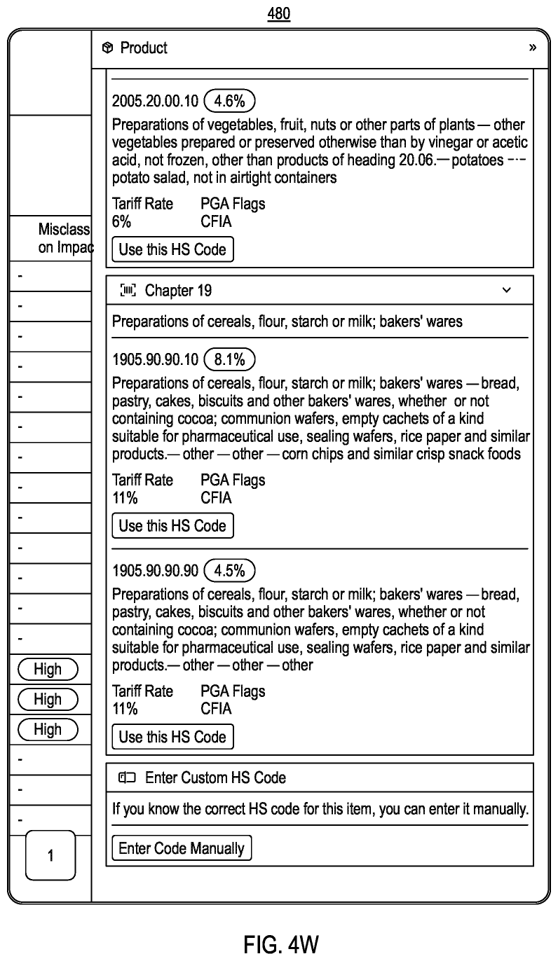

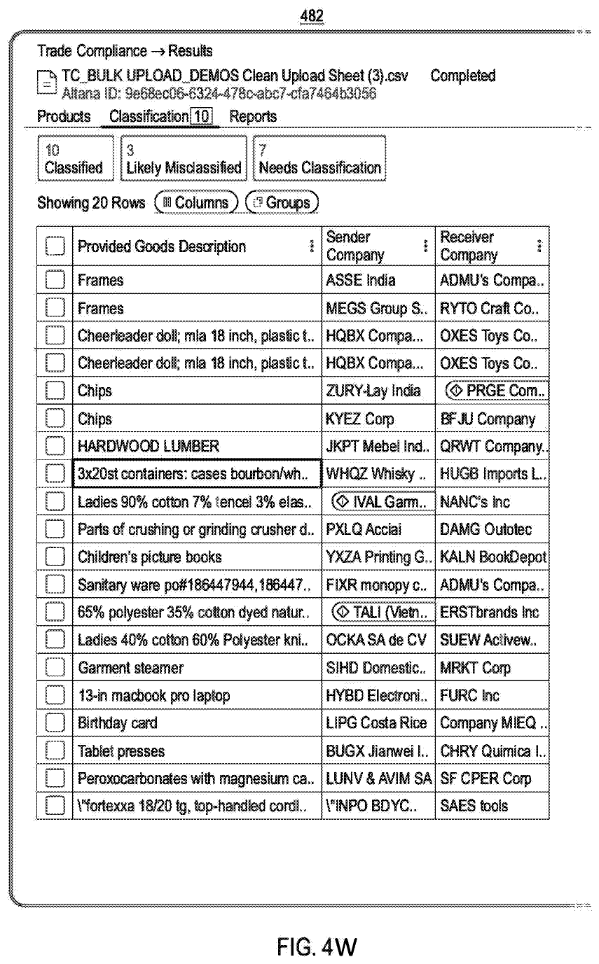

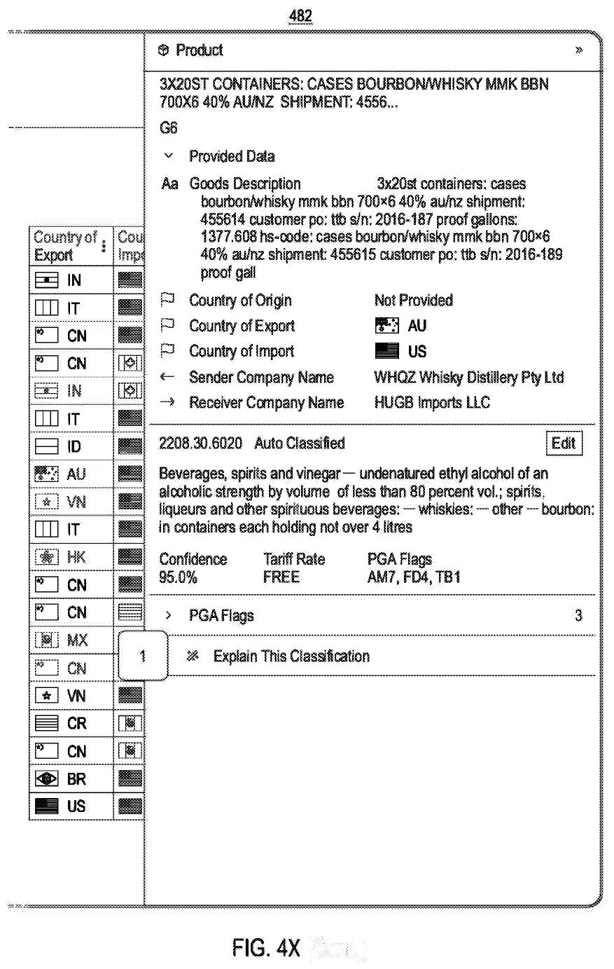

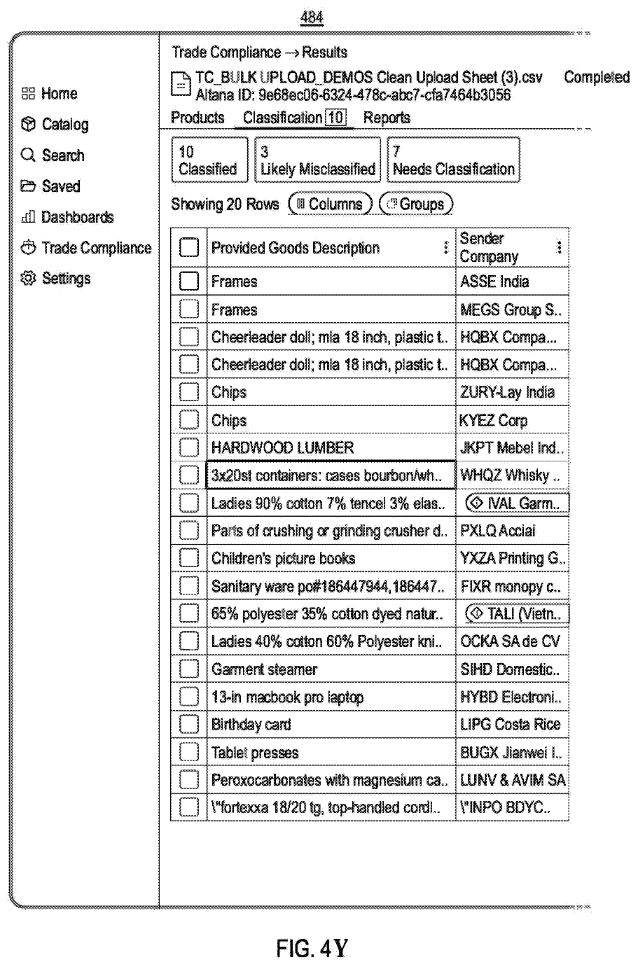

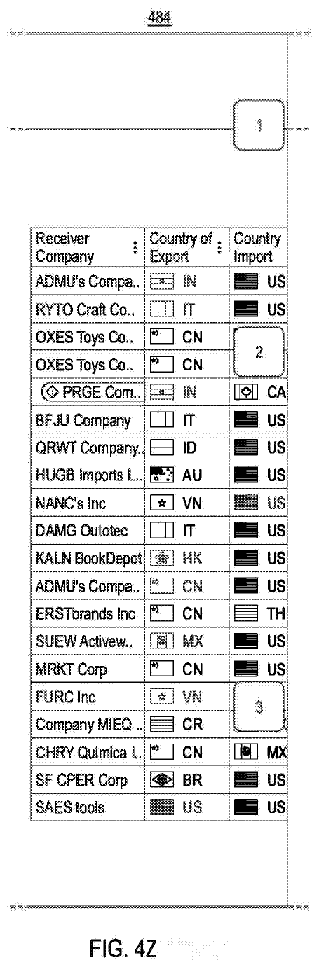

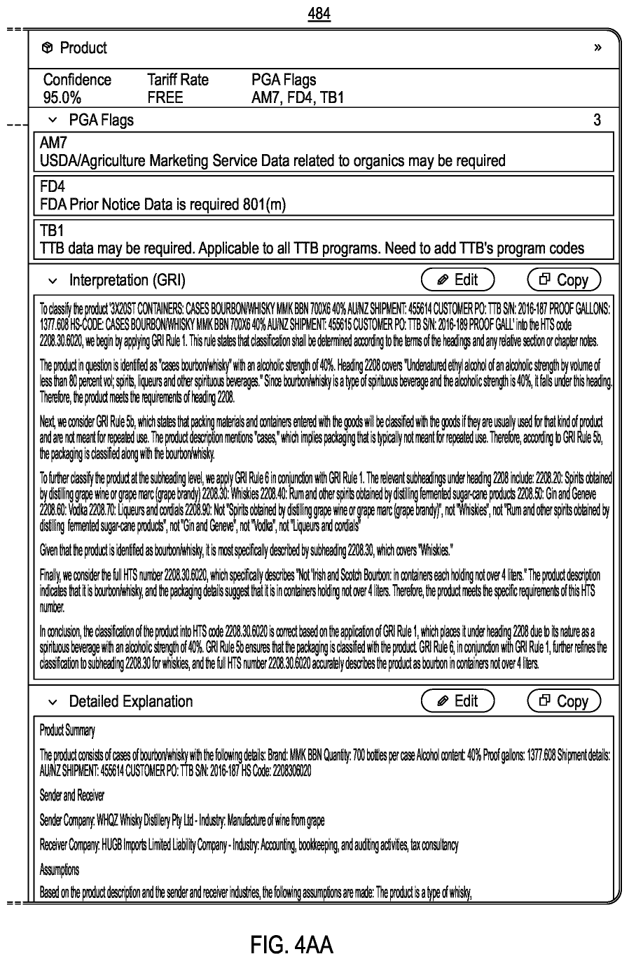

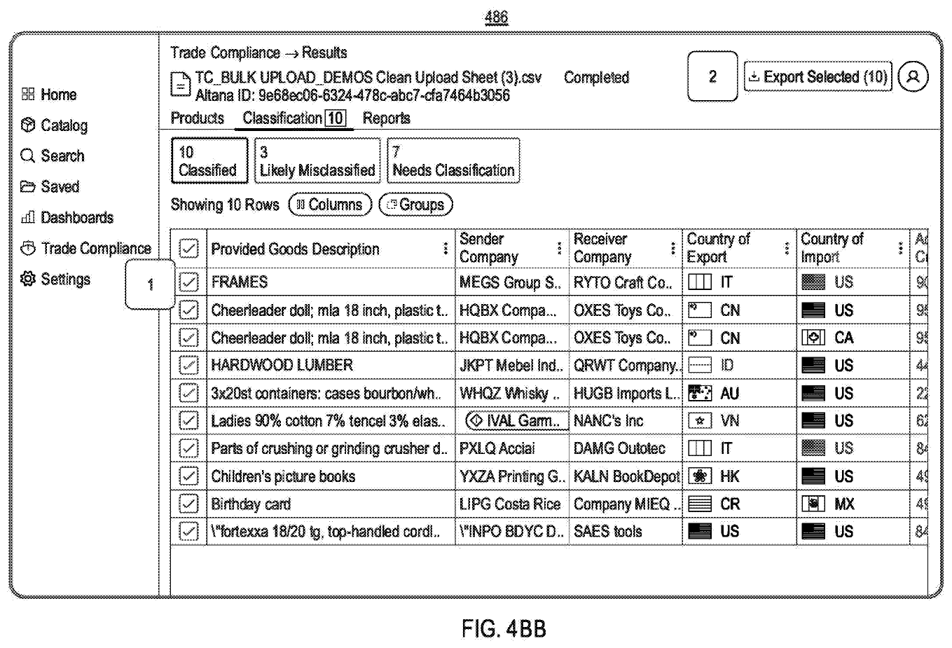

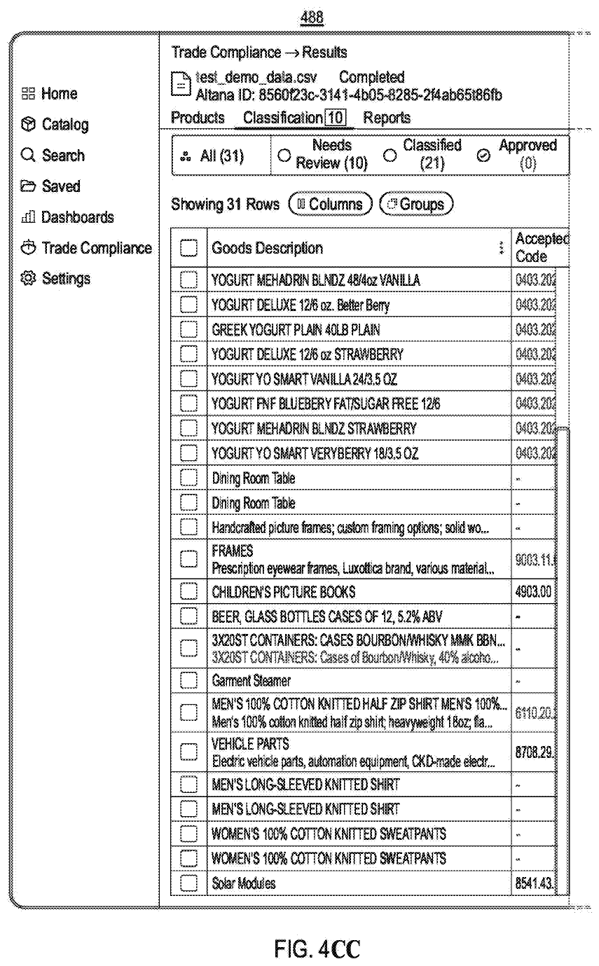

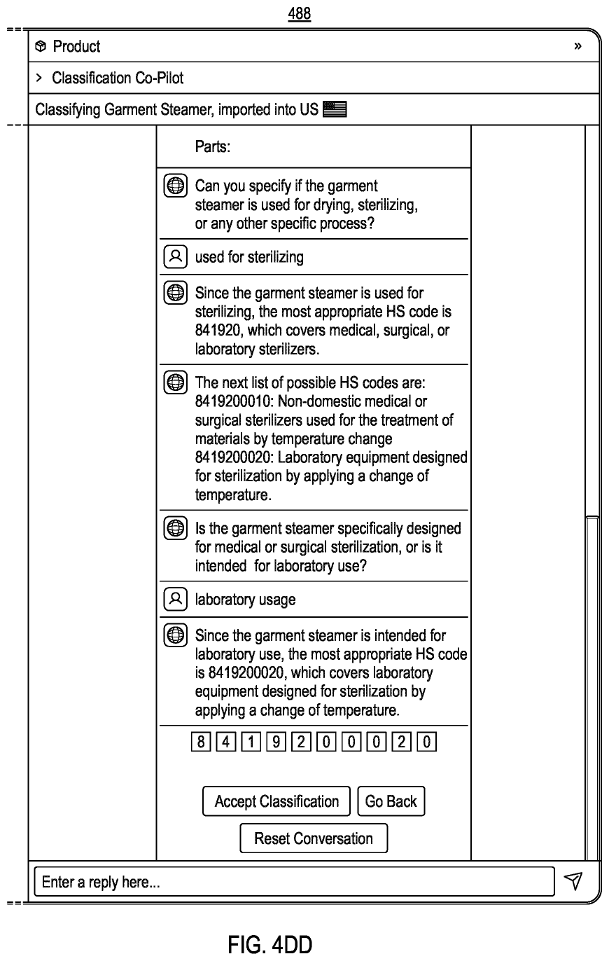

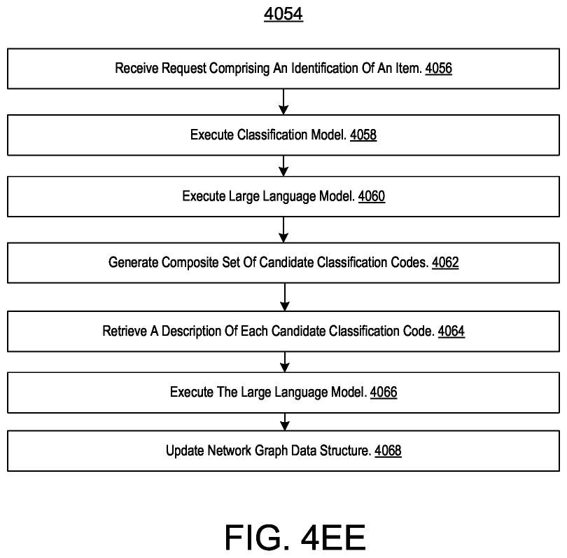

FIG. 4A illustrates an example sequence 400 of classification using a network graph data structure, in accordance with one or more embodiments. A data processing system (e.g., the data processing system 306, shown and described with reference to FIG. 3A) can perform the sequence 400 to generate a prediction for a confidence score for a classification for a networked item. The sequence 400 can include any number of operations or additional operations and the operations may be performed in any order.

The sequence 400 can be performed by a client device 402 (e.g., the client device 302) and a data processing system 404 (e.g., the data processing system 306). The data processing system can host a platform and provide a user interface 406 to the client device 402. Through the user interface 406, a user accessing the client device 402 can provide inputs that provide one or more identifications of items. The user can provide such inputs, for example, by uploading a file containing the identifications (e.g., in a CSV file or a spreadsheet). The graphical user interface and API may also be used to submit the data. The data processing system can receive the uploaded identifications of the items from the user interface and implement the systems and methods descried herein to determine a classification for each of the items and/or a confidence score for the items. For example, the data processing system 404 can execute a large language model using metadata included with each of the items, such as a source node, a destination node, a text description of the item, a path of nodes that the item traveled, etc., which may be retrieved from a network graph data structure and/or across a network, to generate a classification and a confidence score for the classification. The data processing system 404 can compare the confidence score to a threshold (e.g., a classification threshold). Responsive to determining the confidence score exceeds the threshold, the data processing system 404 may update the graphical user interface, return via API or update the CSV file or spreadsheet to indicate the classification and/or the confidence score for the classification. The data processing system 404 can repeat this process for any number of items uploaded by the user through the client device 402. The data processing system 404 can provide the determined confidence scores and/or classifications to the user at the user interface 406 that the user is accessing, such as by presenting the updated CSV file or spreadsheet to the user or by updating the user interface 406 itself.

FIG. 4B illustrates another example sequence 408 of classification using a network graph data structure, in accordance with one or more embodiments. A data processing system (e.g., the data processing system 306, shown and described with reference to FIG. 3A) can perform the sequence 408 to generate a prediction for a confidence score for a classification for an item. The sequence 408 includes operations the data processing system 404 of FIG. 4A may perform to generate classifications for items. The sequence 408 can include any number of operations or additional operations and the operations may be performed in any order.

In the sequence 408, the data processing system 404 can include a classification orchestrator 410, one or more classification models 412, a database 414, and/or one or more helper models 416. The data processing system 404 can communicate with an online system 418. The online system 418 can include an enrichment service 420 a search service 422, a web page retrieval service 424, a large language model 426, and/or a search and/or summarization service 428. The classification orchestrator 410 can include a set of classification models 430 and a chatbot 432. The helper models 416 can include a classifier 434 configured to check if more data is needed for classification and/or a score generation model 436. The classification models 412 can include a dual encoder 438, a dual encoder 440, other types of deep learning or machine learning models, a prompt loop with question answer agents 442, a first large language model 444, a second large language model 446, and/or a third large language model 448. The classification orchestrator may be a large language model, potentially tuned on the underlying network graph data structure and task. The classification orchestrator may be an agentic system or a task agent leveraging multiple underlying models and tools. All these systems may leverage not only text but also graph/network information on the connections of the relevant corporate and other parties and their histories.

The data processing system 404 can receive identifications of one or more networked items from the user interface 406. The identifications can be of networked items of a shipment of networked items being transported from one facility to another facility, for example. In some cases, the shipment can be from a facility in one country to a facility in another country. The data processing system 404 can receive the identification of the networked items in a request for classifications (e.g., HS classification codes) that classify or categorize the networked items. The data processing system 404 can receive the identifications of the one or more networked items from the user interface 406 through the classification orchestrator 410.

The classification orchestrator 410 can execute one or both of the set of classification models 430 and/or the chatbot 432 to generate classifications for the one or more networked items. The classification orchestrator 410 can generate the classifications by generating classifications and/or confidence scores for such classifications. The classification orchestrator 410 can generate such classifications for particular countries, in some cases.

The dual encoder 438 can be or implement one or more dual encoders (e.g., sentence transformers) models along with deep and cross networks blocks as part of a custom neural network architecture. The dual encoder 438 can be trained on graph data from the network graph data structure 336. For example, the dual encoder 438 can be trained on historical network operations or network operations that include networked item classifications for networked items that are transported between nodes of the network graph data structure 336.

The dual encoder 438 can be configured to receive as input a networked item description, source node (e.g., exporter or node representing an entity providing an input to an entity of a destination node in a network operation) graph features, and destination node (e.g., importer or node representing an entity receiving an input from an entity of a source node in a network operation) graph features. In one example, the dual encoder 438 may be configured to receive company statistical classification of economic activities (NACE) codes as input (e.g., the NACE codes of the source node and/or the destination node for the networked item). The graph features of the nodes can include any data from the data structures of the source node and/or the destination node. The data processing system 404 can execute the dual encoder 438 based on such inputs to generate an output including a classification for the networked item (e.g., a country-specific classification for the networked item) and/or a confidence score for the classification. In some cases, the dual encoder 438 can generate multiple classifications and/or confidence scores for such classifications.

Advantageously, by using one or more dual encoders that include a sentence transformer and/or deep and cross network blocks together, the data processing system 404 can encode and leverage graph features for networked item classification. The dual encoder may be used directly for the classification or be fed into other machine learning and deep learning systems.

The dual encoder 440 can be or include an ensemble of a dual encoder, a hybrid search engine, and/or a large language model arbiter. The dual encoder 440 can be configured to receive as input a good description, a name of a source node (e.g., importer), and a name of a destination node (e.g., exporter). The data processing system 404 can execute the dual encoder 438 based on such inputs to generate an output a classification for the networked item (e.g., a country-specific classification for the networked item) and/or a confidence score for the classification. In some cases, the dual encoder 438 can generate multiple classifications and/or confidence scores for such classifications.

To generate a classification for a networked item, the dual encoder 440 can use a search engine and/or a large language model. While called a dual encoder here, the dual encoder 440 can be any type of machine learning model. For instance, the dual encoder 440 can be or include a duel encoder, a cross encoder, a neural network, a support vector machine, a random forest, or any other deep learning or machine learning model. In one example, the dual encoder 440 can identify multiple representations of tariffs that may be applicable to the networked item. The dual encoder 440 can do so using the classification for the networked item to search for potentially applicable tariffs from the database 414 and retrieving definitions of the tariffs that are stored in the database 414. The dual encoder 440 can execute the large language model based on the definitions to generate summarized definitions of the tariffs. The dual encoder 440 can identify or generate (e.g., via the large language model) sub-group definitions for different classifications (e.g., HS codes), dividing the classifications into multiple groups. The dual encoder 440 can additionally or instead generate a descriptions of a list of top networked items (e.g., networked items that correspond with the highest number of edges and/or network operations) in the network graph data structure 336. The dual encoder 440 can combine each of the codes, the descriptions of the networked items, the definitions and/or the summarized definitions of the tariffs, etc., into a single field, prompt, or feature vector. The dual encoder 440 can execute or perform a lexical and/or semantic search through the database 414 using the concatenated input to generate a classification and/or a confidence score for the classification identified in a request received through the user interface 406.

In some cases, the data processing system 404 can use the dual encoder 440 for networked item classification without using any large language models or other types of large language model. For example, the dual encoder 440 can be configured to process inputs such as networked item descriptions, source node names, and destination node names. The dual encoder 440 can utilize a sentence transformer to convert these textual inputs into numerical embeddings that capture the semantic meaning of the information provided. These embeddings can represent the items and their associated nodes in a high-dimensional vector space, facilitating effective comparison and categorization based on learned relationships within the data.

Once the textual data is transformed into embeddings, the dual encoder 440 can employ deep and cross network blocks to further process the information. The deep network blocks can be responsible for identifying complex, non-linear relationships within the features, enhancing the model's ability to distinguish subtle differences between networked items. The cross network blocks can explicitly model feature interactions by combining different input features in various ways. This multi-layered architecture enables the dual encoder 440 to learn intricate patterns and dependencies for accurate item classification, even in the absence of a language model.

After processing the input through the sentence transformer and the network blocks, the dual encoder 440 can generate an output that includes a classification for the networked item. In addition to the classification, the model can also produce a confidence score that reflects the certainty of its prediction. The confidence score can be derived from the similarity or distance metrics computed within the embedding space any, allowing the system to quantify the reliability of the classification. This mechanism ensures that users receive not only the most probable classification but also an indication of how strongly the model supports its decision.

Using the dual encoder 440 for classification without a language model can reduce computational complexity and resource requirements, resulting in faster inference times and lower operational costs. By focusing on embedding-based representations and specialized network blocks, the dual encoder 440 can efficiently capture relevant features and relationships specific to the classification task. Furthermore, the model's architecture is well-suited for scenarios where interpretability, scalability, and responsiveness are important, making it useful for real-time or large-scale networked item classification tasks.

The data processing system can track incorrect and/or correct classifications. For example, after the dual encoder 440 generates an output with a classification with the highest confidence score, a user can provide an input indicating whether the output was correct. The data processing system can store identifications networked items for which the dual encoder 440 generated the incorrect classification, a description of the networked item, and a correct classification (which may be input by the user) in a hybrid search index. Subsequently, during prediction for another networked item, the dual encoder 440 may search both the multi-representations index and the mispredictions index to identify the top search results, or the classifications with the highest classifications. This process can aid the dual encoder 440 in avoiding making the same known mistakes again. In some cases, the data processing system can dynamically update the hybrid search index based on user/subject matter expert feedback such that any mistakes the dual encoder 440 makes can be fed back to the mispredictions index, which can reduce the chances of making the same mistakes again.

In some cases, the dual encoder 440 can use the large language model arbiter to generate a classification. For example, the dual encoder 440 can use a dual encoder similar to the dual encoder 438 to generate or select a classification for a networked item. The dual encoder 440 can additionally or instead use the hybrid search engine through the hybrid search index to generate a classification for the networked item. The dual encoder 440 can use the large language model arbiter (e.g., a large language model) to select one of the two classifications, such as by providing the tariff definitions or summaries of the tariff definitions of the two classifications in the large language model arbiter. One or both of the dual encoder or the search engine can generate the classification and the confidence score for the classification, for example, by concatenating together the name of the source node, the name of the destination node, and/or the description of the networked item to generate a feature vector or prompt. The system may also generate features based not just on text but also on numeric representations of graph/network trading information, weights, values, and other graph and numeric/continuous features. Such can provide a more meaningful textual representation than using a networked item description alone. The data processing system 404 can execute the large language model arbiter based on the input classifications output by the dual encoder and the search engine and tariffs descriptions of the classifications to cause the large language model to select one of the two classifications for output.

The second large language model 446 can be a language model, such as a llama model. The second large language model 446 may be finetuned for classification generation (e.g., HS code classification generation) for one or more countries, confidence generation for such classification generation, and/or vagueness detection. The second large language model 446 may be configured to receive as input a networked item description, source node (e.g., importer) and destination (e.g., exporter) names, relevant tariff definitions from hybrid search, additional network operation metadata fields, any available previous or other country classifications (e.g., HS codes), network operation enrichments, etc. The second large language model may be trained or finetuned to generate outputs based on such inputs such as classifications across several countries, explanations for the classifications, and/or confidence scores for the classifications. The confidence scores may be generated using logprobs, for example.

The data processing system 404 may train the second large language model 446 in the following manner. The data processing system 404 can train the second large language model 446 to generate outputs based on tariff definitions, global reporting initiative (GRI), official tariff guides, and rulings for the United States and Canada. The data processing system 404 can perform supervised finetuning on predicting top-1, predicting top-5, predicting single country, predicting multi-countries, predicting tariff definitions to code and vice versa, including top-5 hybrid search predicted tariff definitions as context in finetuning (RAFT), predicting different types of explanations, classification (HS code) translations between countries, vagueness detection, material descriptions metadata, web enriched descriptions, confidence scoring, misclassifications, and/or chatbot sample interactions generated using LLMs.

For example, the second large language model 446 may be fine-tuned to predict classifications for multiple countries together. The multi-country prediction can ensure that the predictions for countries are aligned with each other. In one example, the second large language model 446 can first make HS6 predictions. Followed by other country predictions. Keeping HS6 first ensures that HS Aug. 10, 2012 predictions are aligned at the HS6 level. Joint finetuning with multiple types of datasets (e.g., training using training classifications of the same networked items generated for different countries) can ensure that a single model can work across multiple use cases. In some cases, the second large language model 446 can take in a classification from one country to predict in another country

The dataset selection for finetuning can involve selecting a subset of data that is more likely to provide differentiating results. From the large set of network operation data, the data processing system 404 only take a subset where the available/provided classification is in the top-5 predictions of a previous model (a dual encoder in most cases since it is faster to run on large sets). This dataset selection reduces the chances of having wrong classification codes in training data. In some cases, the dataset selection may be to only select GDs that are distinctly different from each other using semantic clustering.

Using the same model for confidence scoring can improve the accuracy of the confidence scores. The confidence scores can be used to know which predictions were low confidence, and need human review. Such confidence scores can be shown in the UI as “Needs classification” so users can review and select appropriate codes for low confidence predictions. The confidence scores can additionally be used to determine the need of enrichments and to run further model predictions to arrive at a higher confidence prediction.

In some cases, the chatbot 432 can facilitate generating classifications and confidence scores for classifications for networked items. The chatbot 432 can facilitate chat flow using both machine learning predictions and human input to arrive at the most accurate classifications. The chatbot 432 can generate predictions iteratively at different classification levels (e.g., HS2/4/6/10 and/or another other granularity). The chatbot 432 can ask questions at each step that informs the classification at that level. The chatbot 432 can use machine learning model predictions at each step to identify the most relevant classification codes and tariff definitions. The chatbot 432 can implement multiple choice style and free response questions to get inputs from users on details of the product.

In some cases, the data processing system 404 can enrich the inputs into the models 438-448 with data for more accurate classification. The data processing system can do so, for example, responsive to detecting vagueness in a particular description for a networked item. For instance, each networked item or set of networked items can be scored based on three criteria vagueness (e.g., vague descriptions, such as electronic components), nonsense-ness (e.g., if the description is not useful for any network operation purpose, e.g. networked item, merchandise), and/or web-enhanceability (e.g., if the network operation description is enhancable through web (e.g. 565601011H spare wheel) vs not being sufficient for enhancement (e.g. spare parts)). The data processing system generate such scores using models such as a bidirectional encoder representations from transformers (BERT) model and/or a large language model (e.g., Llama).

The BERT model and/or the large language model can be finetuned iteratively. For example, the models can be starting with a few manually labeled network operations in each category, then finetuned iteratively on weakly supervised examples inferred from the model. The data processing system may do so if there is a low amount of ground truth labels on any of the vagueness categories.

The detection of vagueness of network operations can aid the classification workflow to know which networked items or network operations need further automated enrichments or review from human users. The selection of appropriate categories for vagueness help optimize the overall classification workflow. Iterative weak supervision finetuning can help address the lack of training data.

In an example, the data processing system 404 can enrich an input into one of the models 438-448 for networked item classification by communicating with the online system 418. The data processing system 404 can do so in response to determining a confidence score for a classification (e.g., the highest confidence score generated for a classification) for a networked item is too low and/or in response to determining one of the scores generated for the vagueness criteria is too high, such as above a threshold (e.g., indicating the networked item description or input is too vague). The data processing system 404 can communicate with the online system 418 using a web search application programming interface (API). In doing so, the data processing system 404 can request information (e.g., by transmitting identifications of the source node, the destination node, the networked item, and/or the description of the networked item) to the online system 418. The online system 418 can receive the request and retrieve information regarding the networked item, the source node, and/or the destination node.

In one example, the networked item may be a radio flyer trike. The online system 418 can retrieve a vehicle type of tricycle, a purpose of toddler training vehicle, a frame material of plastic or metal, a features list including single or dual decks, attachable bells, and handlebar streamers, and an age range of various models for ages 1-5 ages. The online system 418 can retrieve such information by executing a search engine or web crawler configured to retrieve information from a network, such as the Internet. The online system 418 may retrieve the relevant information from a web page or website associated with the networked item. In another example, the networked item may be an LCD screen panel. The online system 418 retrieve a networked item type of replacement monitor, a material of WLED, a purpose of display screen replacement, and a resolution of 2560×1440 2K from the network. The online system 418 can transmit the retrieved data back to the data processing system 404. The data processing system 404 can enrich the input (e.g., the input including the networked item name, networked item description, source node identifier, destination node identifier, etc.) to include the retrieved data. The data processing system 404 can execute one of the models 438-446 based on the input to generate a classification for the networked item.

The aforementioned enrichment can help identify relevant information from the network to facilitate classifications. For example, the enrichment process can first identify if the descriptions of one or more networked items (e.g., one or more networked items of a network operation) are vague. For vague descriptions the data processing system 404 can execute all enrichment steps. The final enrichments can be used as context for classification. The enrichment process involves an agentic workflow to select the right tools for enrichments, as well as several scoring thresholds to improve the enrichments.

In some cases, the enrichment can involve retrieving data about the source node and/or the destination node for a networked item. For instance, the online system 418 can receive identifications of the source node and/or destination node and retrieve or generate data regarding the identified source node and/or destination node. The online system 418 can transmit the retrieved data back to the data processing system 404 to include the input into one of the models 438-446 for classification.

In some cases, the data processing system 404 can leverage HS2 level important attributes. For example, an agent of the data processing system 404 can check if the input networked item description misses any important attributes needed for classification by using a list of manually and/or large language model-curated HS2 attributes. The agent can use the check to inform the decision if the input for a networked item needs enrichment and/or to provide appropriate enriched description based on the required HS2 attributes. The data processing system 404 leverage any level of important attributes in this manner to inform the decision of whether enrichment is needed.

Referring now to FIG. 4C, depicted is a flow chart illustrating a method 460 for classifying a networked item using a large language model and contextual enrichment. A data processing system, such as the data processing system 404 or any other computing device as described herein, can perform the method 460. The method 460 can include any number of operations, and the operations can be performed in any order. In some cases, a task agent (e.g., the model 333) can perform the operations 405-419 to facilitate execution of different software modules and/or models, such as large language models. By performing the method 460, a computing system may facilitate contextual enrichment for automated classification of a networked item using a large language model, thereby reducing hallucinations of the output of the large language model.

At operation 403, the data processing system can receive a request from a computing device. The request can include an identification of a networked item. The request may be received via a user interface or application programming interface. In some cases, the data processing system can specify or identify a networked item description, a networked item identifier, a stock keeping unit, a source entity, a destination entity, a geographic location (e.g., a country) or any combination thereof.

In some implementations, a user may upload a comma-separated values (CSV) file containing networked item descriptions. The upload of the CSV file can trigger the data processing system to receive the networked item identification for processing. The data processing system can parse the request to extract or identify the networked item identifier, which may be used as input for subsequent graph traversal and prompt generation. In one example, a CSV file may contain a networked item description of “Cheerleader Doll, MLA 18 inch, plastic toy.” Receipt of the CSV file can trigger or otherwise cause the data processing system to identify the networked item identification as a classification code of “9503.00.0073”.

In some implementations, the CSV file can include additional metadata, such as sender and receiver information, among others, to provide support for downstream enrichment. For example, the metadata may include Company A as the sender company along with Canada as the country of export, and Company B as the receiver company with the United States as the country of import.

In some implementations, the request may include a set of descriptions of networked items and corresponding classifications, and the data processing system may use the set of descriptions and classifications to train a large language model. For example, the request may include a networked item with a description of “Garment steamer” including company and country information, and a corresponding classification of “8424.30.9000”. The networked item description and classification set may be used to train the large language model, such as by using backpropagation techniques with a loss function.

At operation 405, the data processing system can identify one or more sub-graph data structures of nodes each corresponding to the networked item and connected by a set of edges from a plurality of sub-graph data structures stored in a network graph data structure. The data processing system may traverse or query the network graph data structures using the identification of the networked item to locate all sub-graph data structures that are relevant to the networked item. For instance, the data processing system can query the network graph data structure using the item identifier as a key. Based on the query, the data processing system can identify a profile node for the networked item that contains a value matching the item identifier. The data processing system can identify the edges or edge data structures linked to the profile node for the networked item to identify sub-graph data structures that are linked with the item profile node. The data processing system can identify or retrieve the nodes of the identified sub-graph data structures.

In some implementations, the sub-graph data structures may represent different supply chain paths, network operation histories, and/or organizational relationships for the networked item. For example, sub-graph data structures for hardwood lumber may correspond to the supply chain for hardwood lumber of Oak type and may contain another supply chain for a hardwood lumber of Mahogany type. The sub-graph data structures may also contain the network operation histories for hardwood lumber from Entity E in a supplier tier three to Entity C in a buyer tier two along with each network operation within the entities between. The sub-graph data structures may contain this data by storing nodes that represent the different entities, edges that represent the network operations between the different nodes indicating respective transfers of instances or portions of the networked item between entities represented by pairs of nodes.

In some cases, the sub-graph data structures can be or include directed acyclic graphs (DAGs). For instance, the different edges may include arrows indicating a direction of the network operations. The arrows may indicate a direction of transfer of the instances of the networked item between pairs of entities represented by connected nodes of the network graph data structure. The arrows may be represented in the data structures for the edges by identifiers of the source node and the destination note (e.g., the arrow may point to the destination node) for the network operations represented by the respective edges. The data of the DAG graph may aid the data processing system identifying source nodes and destination nodes for labeling (e.g., as the respective source and/or destination nodes) in prompts or feature vectors input into a machine learning model (e.g., a language model or a classification model) for classification.

At operation 407, the data processing system can perform a query through one or more edges of each of the one or more sub-graph data structures of nodes. In doing so, the data processing system can query each of the one or more sub-graph data structures to identify one or more pairs of nodes that respectively represent a source for a networked item and a destination for the networked item. The sub-graph data structures can each represent the transfer of the networked item from the source node to the destination node through the nodes of the sub-graph data structure (e.g., through the entities associated with the nodes of the sub-graph data structures). The source node and destination node pairs can represent direct connections (e.g., two nodes that share an edge with each other), nodes at the beginning and end of the respective sub-graph data structures, or any other combination of nodes. The data processing system may traverse the edges of the sub-graphs to determine which nodes serve as the origin (e.g., the source) and destination for the item in a given network operation or value chain. The search may involve extracting or identifying node identifiers and edge attributes from the sub-graph data structures to determine or identify the appropriate source and destination. The data processing system can identify any number of pairs of nodes in each identified sub-graph data structure

In some implementations, the data processing system can identify a source node context and a destination node context for one or more of the identified pairs of nodes. The source node context can be or include identifications of one or more nodes connected with the source node. The destination node context can include identifications of one or more nodes connected with the destination node. The data processing system can identify the source node context and the destination node context, for example, by identifying the edges connected with each of the source node and the destination node. The data processing system can identify the data structures of the edges (e.g., the edge data structures) based on the edges identifying the networked item or otherwise corresponding to the generation of the networked item. The data processing system can identify the nodes connected by the edges with the source node and/or the destination node, in some cases and one or more nodes connected with the identified connected nodes, to any degree of connection. The data processing system can identify or extract an identification of each identified node (e.g., name of the entity represented by the node) and/or any other attributes or information about the entity stored in the respective nodes.

In some implementations, the data processing system may perform the search (or query) by identifying a source node and a destination node from the network graph data structure based on the source node and the destination node each sharing an edge with a networked item node (e.g., the profile node for the networked item) in the network graph data structure digitally representing the networked item. The data processing system may determine that a particular node in the network graph data structure represents the networked item, and may identify edges connecting the source node and the destination node to the networked item node. The data processing system may select the source node and the destination node based on the presence of such shared edges, for example, where the source node and the destination node are each directly connected to the networked item node by a respective edge. The edges may store identifiers of the connected nodes and may include metadata describing the relationship between the source node, the destination node, and the networked item node, such as a transfer event, network operation, or transformation, among others. The data processing system may use the identified source node and destination node for subsequent prompt generation or classification operations.

For example, the search for the sub-graph data structures of hardwood lumber may identify the source node and the destination node from the network graph data structure utilizing an edge that is shared between the source node and destination node with the hardwood lumber. The network graph data structure may store an edge data structure that includes identifiers for both the source node and the destination node, as well as an identifier for the hardwood lumber as the networked item. The search may determine that the edge data structure links the source node and the destination node by referencing the identifier of the hardwood lumber networked item. The network graph data structure may store additional metadata in the edge data structure, such as a classification for the hardwood lumber, a quantity, or a timestamp, among others. The search may retrieve the identifiers of the source node and the destination node by traversing the edge data structure associated with the hardwood lumber.

At operation 409, the data processing system can generate a prompt. The prompt can be or include, for example, a structured input and/or a string of text that can be input as a feature vector into a language model for processing. The data processing system can generate the prompt to include a text description of the networked item and identifiers of the source node and the destination node for the networked item. In some cases, the data processing system can include the data identified from the identified sub-graph data structures or the nodes of the identified sub-graph data structures in the prompt. In some cases, the prompt may include a description of the networked item, identifications of the source and destination (e.g., importer and exporter names), and/or relevant network operation metadata. The data processing system may concatenate the relevant information into a structured prompt (e.g., a structured prompt according to a template replacing variables with the corresponding values) for input into a large language model.

The data processing system can generate a prompt by formatting the data according to the requirements of the large language model, including any necessary context fields. The data processing system can select and arrange data fields such as networked item description, source and destination identifiers, network operation metadata, fields for source node context and/or destination node context, and/or definitions, such as in a predetermined order specified by or otherwise for the large language model (e.g., the large language model may have been trained to generate classification based on a particular structure or format of fields of prompts). In some implementations, the data processing system can insert context fields that provide additional information, such as historical network operation data, enriched networked item descriptions, or geographic location-specific classification rules, among others. The data processing system can concatenate the selected data fields into a structured prompt string, using delimiters or formatting conventions, which may be required by the large language model. The data processing system can store the formatted prompt for input into the large language model or transmit the prompt to a model inference component for classification processing.

In some implementations, the data processing system may generate the prompt by inserting the source node context and the destination node context into the prompt for input into the large language model. For example, the source node context may include information relating to the name, location, function, owner, and type of the source node while the destination node context may include the same information of the destination node. A networked item such as hardwood lumber may have specific source node context and destination node context that is extracted into a structured prompt. The data processing system can further include the identifications of the connected nodes and/or data of the connected nodes with the source node and/or the destination node in the source node context and/or destination node context in the prompt. By generating the prompt to include the source node context and the destination node context, the data processing system can supply the large language model with structured, verifiable relational data that grounds the model's inference in factual network graph relationships, which can reduce the likelihood that the large language model generates hallucinated classifications.

In some implementations, the prompt may be further enriched with additional context or historical network operation data. The data processing system may retrieve historical network operation records from a system of record (e.g., a separate database from the network graph data structure), such as prior network operations, associated networked item classifications, or related importer and exporter entities, among others. The data processing system may extract attributes from such historical network operation data, for example, networked item descriptions, location of import, source and destination (e.g., sender and receiver) names, or transfer metadata. The data processing system may concatenate the extracted attributes with the current prompt to generate an enriched prompt string. The data processing system may store the enriched prompt for subsequent input into the large language model. The data processing system may thereby supply the large language model with a prompt containing both current and historical context relevant to the networked item under classification. The inclusion of historical context in the prompt can improve the factual grounding of the large language model's output, which can reduce the likelihood of hallucinated classifications and can provide a technical advantage by increasing the accuracy and reliability of automated classification predictions in the presence of ambiguous or incomplete input data.

At operation 411, the data processing system can execute the large language model using the prompt to generate a classification and a confidence score for the classification. The large language model may output a predicted classification (e.g., predicted harmonized system code) and an associated confidence score for the networked item. In some cases, the large language model may generate an explanation of the rationale underlying the predicted classification, such as by referencing definitions, graph-derived features, among others. In some implementations, the data processing system can store the predicted classification, the confidence score, and the explanation in association with the networked item in a database. The data processing system may provide the classification, confidence score, and explanation for display on a user interface.

In some implementations, the data processing system implement or use a retrieval augmented generation (RAG) system to generate the classification and/or a confidence score for the classification. In doing so, the large language model can first retrieve relevant external or internal knowledge, such as historical network operation records, official classification guidelines, tariff schedules, relevant tariff definition, official rulings, graph-derived features, official laws and regulations, or prior classification outcomes associated with similar networked items. This retrieval step enriches the model's input by supplementing the prompt with factual, contextually pertinent data that may not be present in the initial network graph data structure or prompt.

Once the relevant information is retrieved, the RAG system can integrate these supporting documents or data points into the prompt, either as additional context fields or as appended textual evidence. The large language model then processes the combined prompt, which now includes the original networked item description, source and destination node identifiers, network operation metadata, and the retrieved supporting information, to generate a more accurate and reliable classification and its associated confidence score.

By grounding its inference in both the graph-derived features and the retrieved factual data, the large language model can reduce the likelihood of hallucinated or erroneous classifications. For example, if the model is tasked with classifying a networked item such as “hardwood lumber,” the RAG system may retrieve official harmonized system code definitions, historical classification records for hardwood lumber transfers, and relevant regulatory rulings. This enriched prompt enables the model to reference authoritative sources when generating its output, resulting in a classification that is not only contextually relevant but also factually substantiated. The confidence score produced by the model reflects the combined certainty from both the graph-based context and the retrieved evidence, thereby improving the robustness and explainability of the automated classification process.

In some implementations, the large language model may be finetuned to generate classifications for networked items and confidence scores for such classifications. The large language model can be finetuned using one or more both of authoritative sources or contextual graph-derived data. During the finetuning process, the large language model can be trained on input-output pairs that include not only networked item descriptions and graph features, such as the manufacturer's historical transfer patterns and the destination country's classification schedule, but also relevant tariff definitions, official laws and regulations, and official rulings. By incorporating these sources into the training data, the large language model can learn to associate specific networked item characteristics and relational context with the correct classification codes, while referencing regulatory frameworks and historical precedents to inform its predictions. This approach enables the model to output both a classification and an associated confidence score that reflects the certainty of its prediction, grounded in both factual data and regulatory compliance. As a result, the finetuned model can deliver more accurate and reliable automated classifications, with explanations that reference the underlying legal and operational rationale, thereby supporting robust decision-making in complex trade and compliance scenarios.

The large language model may process the prompt by encoding the input features, (e.g., networked item description, source and destination (e.g., importer and exporter) information, and transfer metadata, into a latent representation using a neural network architecture. The large language model may evaluate the semantic similarity between the encoded prompt and candidate classification labels, such as location-specific harmonized system codes, by computing a set of logits or probability values for each candidate classification. The large language model may apply a normalization function, such as a softmax function, to the logits to produce a probability distribution over the candidate classifications. The data processing system may assign the resulting probability value for each candidate as the confidence score for that candidate classification. In some implementations, the large language model may incorporate additional context, such as graph-based features, historical network operation patterns, or enriched transfer (e.g., network operation) attributes, into the latent representation to refine the confidence score.

In some implementations, the data processing system may execute the large language model using the prompt to generate confidence scores for a plurality of classifications. The data processing system may generate, for each candidate classification, a respective confidence score that quantifies the likelihood that the candidate classification is correct for the networked item. The large language model may process the prompt and return a ranked list of candidate classifications with confidence values. The data processing system may store the ranked list (e.g., ranked in ascending or descending order based on a magnitude of the confidence scores for the respective classifications) of candidate classifications and their respective confidence scores in association with the networked item for subsequent selection, ranking, or display operations.

The data processing system can select the classification for the networked item based on the confidence score for the networked item satisfying a criterion. The criterion can be a criterion relative to the other confidence scores and/or a fixed value (e.g., defined or predetermined threshold). For example, the data processing system may compare the confidence scores for the plurality of candidate classifications or ranked list of candidate classifications to determine which candidate classification satisfies a predefined criterion, such as exceeding a threshold value and/or being the highest among the generated scores. In some implementations, the data processing system may store the selected classification and the associated confidence score in a database in association with the networked item. The data processing system may generate an indication of the selected classification for display in a user interface at a computing device, such as by presenting the classification, the confidence score, and/or additional metadata associated with the classification. The data processing system may generate an explanation or rationale for the selection of the classification, for example, by referencing the features of the prompt, the networked item description, or the relationships in the network graph data structure, among others. The data processing system may transmit the selected classification, the confidence score, and the explanation to the computing device for presentation to a user.

In one example, the large language model can receive (e.g., from a semantic model) a prompt that includes a text description of a networked item, such as “wooden dining chair with upholstered seat,” along with identifiers of a source node and a destination node extracted from the network graph data structure. The prompt can further include contextual information derived from the source node context and the destination node context, such as the manufacturer's NACE code, historical network operation data, and relevant network operation metadata (e.g., country of export, country of import, and prior classification outcomes). The large language model can process the prompt and output a set of candidate classifications, such as a list of country-specific harmonized system (HS) codes, each associated with a confidence score. For instance, the large language model can generate a top candidate classification code of “9401.61.6011” for the United States, corresponding to “wooden chairs, upholstered, for domestic use,” with a confidence score of 97.2 percent, and a secondary candidate classification code of “9401.69.6011” with a confidence score of 2.3 percent. The item classifier can compare the confidence scores and select the classification with the highest score, provided the score exceeds a predetermined threshold. In some implementations, the data processing system can generate an explanation for the selected classification, referencing the relevant tariff definition, official laws and/or regulations, official rulings, and graph-derived features such as the manufacturer's historical transfer patterns and the destination country's classification schedule. The data processing system can transmit the selected classification code, the associated confidence score, and the explanation to the user interface for display, enabling a user to review the automated classification and any supporting rationale. In some implementations, if the confidence score does not exceed the threshold, the data processing system can trigger a network operation enrichment agent to retrieve additional web-based networked item details or importer and exporter information, generate an enriched prompt, and re-execute the large language model to obtain a revised classification and confidence score.

In some implementations, the large language model may generate explanations or flag potential misclassifications as part of the output. The large language model may generate an explanation by referencing definitions, official rulings, or graph-derived features associated with the predicted classification. The explanation may include a rationale for the selection of a particular harmonized system code, such as by referencing the networked item description, importer and exporter information, or relevant network operation metadata. For example, the large language model may generate an explanation for a garment streamer including “it is an electrothermic appliance used for domestic purposes” including other description. The large language model may generate a flag indicating a potential misclassification when the predicted classification deviates from historical network operation patterns, exhibits a low confidence score (e.g., below a misclassification threshold), or matches known error cases stored in a mispredictions index. The flag may include an assessment of the likelihood and/or impact of the potential misclassification, such as by quantifying the deviation from prior classifications or by referencing regulatory risk indicators. In some implementations, the explanation and flag may be stored in association with the classification in a database, and may be provided for display in a user interface for review by a user. The user interface may present the explanation, the flag, and any supporting rationale to enable a user to review the automated classification and any associated concerns.

In some implementations, the data processing system may train the large language model to generate confidence scores for classifications of networked items based on a training data set comprising identifications of source nodes and destination nodes for networked items identified from the network graph data structure and labels indicating classifications for the networked items. The data processing system may perform supervised training by providing the large language model with input-output pairs, where each input includes data representing a source node, a destination node, and one or more attributes of a networked item, and each output includes a label indicating a correct classification for the networked item. In some cases, the data processing system can traverse the network graph data structure to enrich the prompt by retrieving node data of one or more nodes connected with one or both of the source node or the destination in the network graph data structure and including the node data in the prompt. The data processing system may generate a loss value by comparing the predicted classification and confidence score output by the large language model to the ground truth classification label for each input in the training data set. The data processing system may update the parameters of the large language model by applying a gradient-based optimization algorithm to minimize the loss value across the training data set. The data processing system may repeat the supervised training process over multiple epochs using batches of training examples until a convergence criterion is satisfied. The data processing system may store the trained large language model in memory for subsequent use in generating classifications and confidence scores for new networked items.

For example, the training data set may include identifications of hardwood lumber with the source and destination nodes along with the classification of hardwood lumber labeled, the training data set also including identifications of chips with the source and destination nodes along with the classification of chips labeled. The training data set can include identifications of hardwood lumber with the source and destination nodes along with the classification of hardwood lumber labeled, the training data set also including identifications of chips with the source and destination nodes along with the classification of chips labeled. The data processing system can generate training examples by associating each networked item with corresponding graph-derived features, such as company NACE codes, historical network operation data, or transfer metadata, among others. In some implementations, the data processing system can encode the networked item description, source and destination information, and relevant network operation context for each example in the training data set. The data processing system can store the encoded features and classification labels in memory for use in supervised training of a neural network model, such as a dual encoder with graph features or a finetuned Llama model. The neural network model can include a plurality of nodes, each node representing a computational unit that receives as input one or more encoded features associated with a networked item, a source node, a destination node, or a combination thereof. The data processing system can update model parameters associated with the nodes based on loss values computed between predicted classifications and ground truth labels for each example in the training data set. In some cases, the data processing system can receive a set of descriptions of networked items and corresponding classifications; and train the large language model using the set of descriptions and classifications.

In some implementations, the data processing system may train the large language model to generate confidence scores for classifications of networked items based on a training data set comprising identifications of edges between the source node and a first set of nodes of a first sub-graph data structure and edges between the destination node and a second set of nodes of a second sub-graph data structure. The data processing system may generate the training data set by extracting edge identifiers, node identifiers, and/or associated metadata from the network graph data structure. The data processing system may select edges that connect the source node to the first set of nodes and edges that connect the destination node to the second set of nodes, for example, by traversing the sub-graph data structures and recording the relevant relationships. The data processing system may encode the extracted edge and node information as input features for the large language model, such as by generating feature vectors that represent the structural and contextual relationships present in the network graph data structure. The data processing system may associate each input feature vector with a ground truth classification label for the corresponding networked item. The data processing system may train the large language model by minimizing a loss function that measures the difference between the predicted confidence scores and the ground truth labels across the training data set. The data processing system may store the trained large language model in memory for subsequent use in generating confidence scores for new classifications of networked items. By grounding the training process in graph-derived structural and contextual relationships, the data processing system may reduce the likelihood that the large language model generates hallucinated classifications in future inference tasks when using inputs from the graph for classification.

In some implementations, subsequent to training the large language model, the data processing system may add an edge between a first node of the network graph data structure and a second node of the network graph data structure indicating the first node is a first source node for a first transport of a first networked item to the second node as a first destination node, and responsive to the addition, may retrain the large language model using identifications of the first node and the second node and a first classification for the first networked item.

For example, an edge may be added between a first source node for a first transport of chips to a second node as a first destination node. The new edge may trigger the retraining of the large language model using the identifications of the first node, the second node, and a first classification for the chips, as described herein.

At operation 413, the data processing system can determine whether the confidence score for the classification exceeds a threshold. The data processing system may compare the confidence score of each output classification from the large language model to a pre-set or dynamically determined threshold value. The data processing system can retrieve the confidence scores generated by the large language model for each given classification. The data processing system may access a stored threshold value, which can be specified by a user, an administrator, or a regulatory requirement, among others. In some implementations, the data processing system can dynamically adjust the threshold value based on historical classification accuracy, user feedback, or risk tolerance criteria, among others. The data processing system can execute a comparison operation to evaluate whether each retrieved confidence score meets or surpasses the applicable threshold value. In some cases, the data processing system may only identify the classification that is associated with the highest confidence score for the comparison.

In one example, the threshold may be dynamically adjustable based on user preferences or regulatory requirements. For example, Company A may require a confidence score of 90% or better to consider the predicted results to be accurate while Company B may require a confidence of 98% or better due to a more sensitive networked item. The data processing system can adjust the threshold based on whether Company A or Company B is performing the classification. In another example, the data processing system can adjust the threshold based on a location of the entity or company associated with the request for the classification.

In some implementations, in response to the data processing system determining no classification corresponds to a confidence score that exceeds the threshold and/or that the classification associated with the highest confidence score does not exceed the threshold, at operation 415, the data processing system can retrieve further contextual information regarding the networked item. The data processing system can retrieve the contextual information, for example, from one or more web pages or databases accessible across the Internet. For instance, the data processing system can determine that the confidence score for the classification is less than a threshold. Responsive to the determination, the data processing system can execute a search engine across the Internet using the identifier of the networked item to retrieve one or more characteristics (e.g., further text descriptions or attributes) of the networked item, such as from pages identifying or otherwise dedicated to the networked item.

In some implementations, the search engine can generate a search query string based on the identifier of the networked item, such as a networked item description, stock keeping unit, or other unique attribute. The search engine can transmit the search query string to one or more web search application programming interfaces, and can receive a set of search results in response. The search engine can extract uniform resource locators from the search results and can transmit requests to retrieve the content of the corresponding web pages. The search engine can parse the retrieved web page content using natural language processing techniques, such as named entity recognition or keyword extraction, to identify relevant characteristics of the networked item, such as technical specifications, networked item classifications, or manufacturer details, among others. The search engine can filter the extracted characteristics based on relevance scores or predefined criteria and can store the filtered characteristics in memory for subsequent use in prompt enrichment or classification operations.

In some implementations, the data processing system may obtain additional data from internal databases or third-party sources to supplement the prompt. The retrieval may involve invoking one or more enrichment agents (e.g., an application, service, program, task or any type and form of executable instructions configured to retrieve or identify data to add to a prompt for input into a large language model, such as from a web search or an internal database), application programming interfaces, or search tools to gather the required context. In some implementations, the data processing system may invoke a source enrichment agent or a destination enrichment agent to retrieve supplemental information regarding a source or destination entity associated with the networked item, such as company names, addresses, historical networked operation data, or industry classification codes, among others, by querying internal databases or third-party business information providers. The data processing system may determine whether the networked item description or other transfer metadata lacks one or more attributes required for harmonized system classification by comparing the available data to a curated list of attribute requirements at the harmonized system two-digit level, such as material composition, intended use, or country of origin, among others. Responsive to determining that one or more attributes are missing, the data processing system may invoke an enrichment agent to retrieve or generate the missing attributes using web-based search, internal data lookups, or machine learning models trained to predict likely attribute values based on similar historical transfers.

The data processing system may concatenate the retrieved or generated attributes with the original prompt data, format the enriched prompt according to the requirements of a target large language model, and store the enriched prompt for subsequent inference operations. In some implementations, the data processing system may apply scoring thresholds to determine whether the enrichment results meet a minimum quality or relevance standard before including the enrichment data in the prompt, and may discard or flag enrichment results that do not satisfy the applicable criteria. The data processing system may log the enrichment process, including the sources of supplemental data, the extracted attributes, the applied thresholds, and any enrichment agent decisions, in a persistent data store for auditability, traceability, or subsequent model improvement. The data processing system may thereby generate a prompt that incorporates structured, verifiable, and contextually relevant supplemental data from internal or external sources to improve the factual grounding and classification accuracy of the large language model.

In some implementations, the data processing system may prioritize certain types of contextual information based on the harmonized system two-digit level attributes (e.g., attributes corresponding to HS4, HS6, HS8, etc.) of the item. The data processing system may select contextual information that is most relevant to the determined harmonized system two-digit level attribute, such as supplier location, material composition, or intended use, among others. For example, the HS two-digit level attribute of the networked item hardwood lumber may prioritize certain types of contextual information like the location of supplier. The data processing system can retrieve supplier location data from network operation records, network graph data structures, or external databases, among others, and may insert the supplier location into the prompt for input into the large language model. In some implementations, the data processing system may apply a set of rules or a lookup table that maps harmonized system two-digit level attributes to prioritized contextual information fields, and may use such rules to select and arrange the contextual information in the prompt. The data processing system may thereby generate a prompt that includes contextual information prioritized according to the harmonized system two-digit level attribute of the networked item, which can improve the accuracy of automated classification predictions.

At operation 417, the data processing system can enrich the prompt using the contextual information. The data processing system may append additional networked item attributes, web snippets, or importer and exporter metadata to the original prompt. The enrichment may involve merging, formatting, or otherwise incorporating the contextual information into the prompt structure. The data processing system can generate an enriched prompt by concatenating the original prompt with one or more supplemental data fields, such as technical specifications, regulatory flags, or historical network operation records, among others. In some implementations, the data processing system may determine whether the contextual information includes relevant attributes at the harmonized system two-digit level, and may insert such attributes into the prompt if present. The data processing system can store the enriched prompt in memory for subsequent execution by the large language model.

At operation 419, the data processing system can execute the large language model using the enriched prompt to generate a second classification and a second confidence score. The large language model may process the enriched prompt and return an updated classification and confidence score. The data processing system may re-run the large language model with the new prompt and compare the new confidence score to the threshold. In some implementations, the data processing system can determine whether the second confidence score generated by the large language model meets or exceeds the threshold value specified for classification acceptance. If the confidence score does not meet or exceed the threshold, the data processing system may repeat operations 415, 417, and 419 by retrieving additional contextual information, enriching the prompt using the additional contextual information, and executing the large language model using the further enriched prompt to generate a subsequent classification and a subsequent confidence score. The data processing system can continue to repeat operations 413 through 419 in a loop, each time retrieving further contextual information, enriching the prompt, executing the large language model, and comparing the resulting confidence score to the threshold, until the data processing system determines that a classification has a confidence score that meets or exceeds the threshold. In some implementations, the data processing system may store each classification and confidence score generated during the repeated executions in association with the networked item and may select the classification corresponding to the first confidence score that meets or exceeds the threshold for further processing, such as storage in a profile for the networked item or presentation in a user interface.

At operation 421, the data processing system can store the classification in a profile for the networked item. The final classification and associated metadata may be saved in a record (e.g., database, a file, a table, a matrix, etc.) or as an attribute of the node for the networked item network graph data structure. The data processing system may update the profile with the new harmonized system code, confidence score, and/or any supporting explanations. The storage may involve writing to a persistent data store, updating in-memory structures, or transmitting the result to an external system.

The data processing system can generate a user interface for presentation at the computing device that transmitted the request, the user interface identifying the classification generated for the networked item and including the identification of the networked item. The data processing system can generate the user interface to display the predicted harmonized system code, a confidence score associated with the classification, and a textual description of the networked item as received in the request or as retrieved from a network graph data structure. In some implementations, the data processing system can generate the user interface to present additional information, such as a likelihood or impact flag for misclassification, a tariff rate, a government agency flag, or an explanation generated by a large language model, among others. The data processing system can generate the user interface to group networked items by classification status, for example, classified, likely misclassified, or needs classification, among others, and can provide interactive elements for a user to review, confirm, or override the predicted classification. The data processing system can generate the user interface to allow a user to export classification results, for example, as a comma-separated values file or a portable document format report, among others, and can generate the user interface to display detailed insights for each classification, such as a general rules of interpretation analysis, a detailed explanation referencing official rulings, or a summary of networked item attributes, among others.

In some implementations, the data processing system may determine at a set interval (e.g., daily or weekly) that a classification prediction for a networked item that was stored in a profile node for the networked item of the network graph data structure was a misclassification. The data processing system can do so, for example, by identifying a historical networked item transport in the network graph data structure and executing the method 460 for the networked item associated with the historical network operation. For example, the data processing system may, at the set interval, identify each networked item represented in the network graph data structure by a networked item node, identify one or more sub-graph data structures of nodes each corresponding to the networked item and connected by a set of edges from a plurality of sub-graph data structures stored in the network graph data structure, perform a query through one or more edges of each of the one or more sub-graph data structures of nodes to identify a source node and a destination node for the networked item, generate a prompt comprising features of the networked item including a text description of the networked item and identifiers of the source node and the destination node for the networked item, execute a large language model using the prompt to generate a classification and a confidence score for the classification, and compare the generated classification to the classification previously assigned to the networked item in the network graph data structure. In some implementations, the data processing system may determine that the classification previously assigned to the networked item is incorrect based on a mismatch between the generated classification and the stored classification, or based on a confidence score for the generated classification exceeding a threshold while the stored classification does not match the generated classification. The data processing system may identify such nodes in the network graph data structure that correspond to networked items with incorrect classifications and replace the classifications in the node for the networked item and/or replace the classification in any edge data structures containing an identification of the networked item classification. In some cases, the data processing system can flag such nodes as misclassified for subsequent remediation, reporting, or retraining operations.

In one illustrative embodiment, a server-based data processing system is deployed within an enterprise knowledge management environment to reduce hallucinations in a large language model (LLM) classification workflow. The server includes in memory a network graph data structure digitally representing multiple real-world entities and their relationships. The network graph comprises thousands of nodes, each node representing either an entity (e.g., supplier, location, networked item type) or a networked item (e.g., an SKU). Edges between nodes are annotated with metadata, including classifications and transport relations that indicate, for example, that a given networked item was transferred from one source node to a destination node. The data processing system further stores and executes a large language model trained using identifications of such source-destination node pairs, along with corresponding classifications, to improve classification accuracy by grounding predictions in the graph's verified relationships.

Upon receiving, from a remote computing device operated by a quality control analyst, a request comprising an identifier of a particular networked item in need of classification, the data processing system instantiates and executes a task agent. The task agent first queries the network graph data structure to identify one or more sub-graph data structures containing the specified networked item. For example, the task agent retrieves a sub-graph including nodes for a manufacturing facility (source node), the given networked item (networked item node), and a distribution center (destination node) connected by edges representing prior network operations. The task agent navigates the edges of the sub-graph to confirm the correct source and destination pairing corresponding to the requested networked item.

Once the correct nodes have been identified, the task agent constructs a classification prompt for the LLM. This prompt includes a textual description of the networked item sourced from the network graph attributes, unique node identifiers for the source and destination, and relevant context nodes connected to each. For instance, the task agent appends the source node's context (e.g., “manufacturing plant in Shenzhen specializing in microcontrollers”) and the destination node's context (e.g., “North American electronics distributor focused on consumer IoT devices”) into the prompt. By incorporating source-destination context from the verified graph structure, the prompt ensures the LLM's classification process is constrained by factual, relationship-driven data rather than relying solely on generative inference.

The data processing system then executes the large language model using the generated prompt. The LLM outputs a machine-readable classification for the networked item (e.g., “smart home automation module”) along with a numeric confidence score. The task agent evaluates the confidence score against a predefined threshold. If the score exceeds the threshold, the task agent automatically generates a user interface component for presentation on the analyst's computing device, the UI containing both the classification and the networked item identifier for immediate review. In one example, this allows high-confidence results to be confirmed with minimal human validation effort.

In scenarios where the LLM's confidence score is below the threshold, the task agent supplements the prompt by initiating an automated search across Internet-accessible networked item information sources using the networked item's unique identifier. Retrieved characteristics, such as material composition, networked item category, and technical specifications, are semantically integrated into the prompt before re-executing the LLM classification process. By enriching the LLM's input with authoritative external attributes while retaining the graph-derived relational context, the system reduces misclassification likelihood.

Over time, the data processing system also continuously improves classification performance through adaptive retraining. For instance, when the task agent detects that a historical classification was incorrect, the system logs the misclassification, its probable cause, and the correct label into a misclassification records database. This information is then incorporated into future training datasets comprising graph-extracted source-destination pairs, enriched node contexts, and associated classifications. As the system continues to operate, the LLM's grounding in the network graph structure, combined with feedback-driven retraining, yields progressively higher accuracy classifications with minimized hallucination rates, even across highly diverse and dynamic networked item relationships.

In modern global trade and logistics, computing systems are deployed to manage vast, dynamic networks of entities that buy, sell, transport, or otherwise handle networked item. These networks can be modeled as network graph data structures, where nodes represent physical facilities or entities, and edges represent network operations or transfers of items between those facilities. Trade compliance systems must determine accurate classification codes, such as harmonized system (HS) codes, for items moving through this network to satisfy tariff, customs, and regulatory requirements. Increasingly, machine learning-based classification systems, including large language models (LLMs), are applied in this environment to automate the classification process and process data at scale.

However, conventional classification computing systems operating in such networked environments suffer from several technical shortcomings. Large language models, in particular, tend to generate plausible but incorrect “hallucinated” classification codes when presented with incomplete or ambiguous networked item descriptions. Graph-based classification approaches can similarly fail when unable to incorporate both the contextual relationships of a networked item within the network (e.g., its source and destination facilities) and up-to-date domain-specific classification code descriptions. The result is a high rate of misclassification, increased compliance risk, and significant re-work, especially when processing high-volume or multi-layer classification structures. The technical challenge lies in reducing hallucinations and improving classification accuracy by grounding the model's inference in verifiable, structured network graph context and authoritative classification code data.

The computing system described herein addresses these problems by operating directly on a network graph data structure stored in server memory that digitally represents the relationships between entities and the items transferred between them. Upon receiving, from a remote computing device, a request to classify a specific networked item, the system's task agent first executes a trained classification model to generate a first set of candidate classification codes based on the item's identifier. In parallel, the task agent executes a large language model, which can be trained on structured graph-derived data linking source nodes, destination nodes, and historical classifications, to generate a second, independent set of candidate classification codes. This dual-path processing deliberately combines the predictive strengths of statistical classification models and LLMs while isolating their weaknesses.

The computing system then actively generates a composite set of candidate classification codes by combining the output from both models according to explicit logic (e.g., concatenation, intersection, or uniqueness rules). For each candidate in this composite set, the system retrieves authoritative descriptions from a classification code database. These curated descriptions, together with the composite candidate set, are provided as structured input back into the large language model. Executing in this constrained, context-rich mode, the LLM selects a single candidate classification code, grounding its choice not only in the raw item identifier but in both the network graph-derived relationships and validated classification code definitions. This process materially changes how the LLM operates, constraining its generative behavior to verifiable options and thereby reducing hallucination.

In some embodiments, the computing system further reduces hallucinations by classifying the networked item within a hierarchical data structure defining multiple layers of classification codes, such as chapter, heading, subheading, and item levels. Instead of requiring the large language model to guess the most granular classification in a single step, a process prone to compounding errors when initial assumptions are wrong, the task agent executes the LLM and the classification model iteratively, one layer at a time. At each layer, the composite-candidate-plus-description process is performed to select the best code for that layer based on grounded graph context and authoritative definitions. The chosen code then constrains and informs the next layer's candidate set, eliminating large portions of the classification space and focusing the LLM on a narrower, more accurate subset of possibilities. This feedback-driven progression through the hierarchy significantly reduces the model's opportunity to hallucinate fine-grained codes unsupported by higher-level classifications, thereby improving both the accuracy and explainability of the final selected code.

In some cases, the computing system further reduces the likelihood of hallucinations by incorporating an interactive question-answer process at each stage of the hierarchical classification process. For example, when executing the classification at a given layer, if the large language model determines that the contextual information and authoritative definitions provided are insufficient to confidently select a candidate classification code from the composite set, the task agent can automatically invoke the LLM via an application programming interface to generate a targeted question seeking the specific missing attribute(s) needed for disambiguation. This question is transmitted to a user interface at the requesting computing device, where a human operator or an autonomous agent of the computing device can provide the requested detail or clarification. The system can record the response, append the response to the contextual prompt, along with any prior exchanges in a message transcript, and re-execute the large language model to re-process the narrowed candidate set for that layer. If, after re-execution, sufficient confidence is still lacking, additional rounds of targeted questioning and re-execution are performed until a code is reliably selected for that hierarchical layer. This process is repeated sequentially for each subsequent, lower layer in the classification hierarchy, ensuring that the attributes needed for deeper levels of classification are accurately captured before those levels are reached, and structurally preventing the LLM from generating unsupported fine-grained codes at the bottom of the hierarchy.

Finally, the computing system updates the network graph data structure to persist the selected classification code in the relevant edge data structure representing the actual network operation between the source and destination nodes. In embodiments involving multi-layered or hierarchical classification schemes, the system iteratively performs these operations across layers until the classification granularity corresponds to the requesting entity's requirements. The architecture can also dynamically invoke an interactive question-answer workflow via the LLM when the model detects insufficient information to make a confident selection, thereby gathering additional descriptive data from a user interface and re-executing the selection process. By structurally binding the classification process to graph-validated context, authoritative code descriptions, and iterative confidence-based refinement, the computing system solves the technical problem of erroneous model hallucinations in automated classification, producing more accurate, reliable, and regulatorily-compliant outputs in the trade-network environment.

Referring now to FIG. 4D, illustrated is a sequence diagram depicting a sequence 4054 for iterative generation of a classification using an agentic hierarchical architecture, in accordance with some embodiments. A data processing system (e.g., the data processing system 306, shown and described with reference to FIG. 3A, or any other computing device described herein) can perform the operations of the sequence 4054 and/or execute any models described with reference to FIG. 4D. The operations of the sequence 4054 can be performed when performing the operations of the method 460 of FIG. 4C, in some cases. The sequence 4054 can include at least one input 421, at least one first set of candidate classification codes 423, at least one classification model 425, at least one second set of candidate classification codes 427, at least one task agent 429, at least one large language model 431, at least one user device 433, and at least one hierarchical data structure 435. The sequence 4054 can include more or fewer operations, and/or the operations can be performed in any order.

In the sequence 4054, the data processing system can receive (e.g., from a computing device) a request comprising an identification of a networked item. The request can include structured input data relevant to a classification task for classifying the networked item, such as a networked item description, a country of import, a destination name (e.g., an import facility), and a source name (e.g., an export facility). In some implementations, the request can be received as a row in a comma-separated values file, with each field corresponding to a specific attribute of the network operation or networked item. Each row in the file can correspond to a different network operation (e.g., network operation or transfer of networked items between entities represented by nodes in a network graph data structure, such as the network graph data structure 336). The data processing system can parse the request and extract the relevant network operation and networked item metadata necessary for classification (e.g., harmonized system (HS) code classification). The task agent 429 can store the parsed input in memory for subsequent processing by downstream models and agents. For example, a user may upload a file containing networked item stock keeping units to a trade compliance section of a user interface, and the task agent 429 can receive and process the file to initiate the classification workflow.

In some implementations, the data processing system can receive the request via an application programming interface or a user interface. The data processing system can validate the format of the request and determine whether the required fields are present. The required fields may include, for example, a networked item description and a country of import, among others. The data processing system can generate an error message if any required field is missing or invalid. The error message may identify the missing or invalid field and may be provided for display at the computing device that submitted the request. The data processing system can store the error message in association with the request for auditability.

The data processing system can execute the task agent 429 to perform one or more, or all, of the sequence 4054. The task agent 429 can be or include a large language model that can process received input data, generate candidate classifications for networked items, and determine subsequent operations for classification by evaluating outputs, confidence scores, or user input, among others. The task agent 429 can do so using the various modules and/or modules stored in memory of the data processing system. For example, the task agent 429 can generate one or more task execution requests based on received input data. The task agent 429 can store task execution parameters in association with a task identifier. The task agent 429 can determine a sequence of operations to perform based on the task execution parameters. The task agent 429 can select one or more computational resources for performing the operations. The task agent 429 can transmit control signals to the selected computational resources to initiate execution of the operations. The large language model of the task agent 429 can select between executing additional classification models, generating queries for user clarification, or proceeding to update a network graph data structure with a selected classification, among others. The structure of the task agent 429 can include one or more subcomponents for model inference, hybrid search, arbitration, or enrichment, among others, each invoked by the large language model based on the determined next step in the classification workflow. The data processing system can execute the task agent 429 to perform the different operations of the sequence 4054.

For example, the task agent 429 can identify an edge data structure representing a network operation of electronic components from a source in Germany to a destination in the United States. The edge data structure can include the destination node identifier, source node identifier, and a text description of the networked item. The task agent 429 can use this information to generate candidate classification codes and perform arbitration.

The task agent 429 can execute a classification model 425 using the identification of the networked item and/or any other data regarding the network operation of the networked item (e.g., the description of the networked item, location of origin, source, and/or destination) as input to generate a first set of candidate classification codes 423. The classification model 425 can be a machine learning model (e.g., a neural network, a support vector machine, a random forest, etc.) trained to predict classification codes (e.g., HS codes) based on input features such as networked item description, destination and source graph features, and historical network operation data. The classification model 425 can process the input data (e.g., using learned representations and graph-based features) to output candidate classification codes and associated confidence scores. In some implementations, the classification model 425 can include a dual encoder architecture with sentence transformers and deep and cross network blocks, or otherwise a dual encoder as described above (e.g., the dual encoder 438 and/or 440). The classification model 425 can leverage graph features including company NACE codes and network operation history to inform the HS prediction for new network operations.

For example, to generate the first set of candidate classification codes 423 for the networked item, the task agent 429 can provide the networked item description, destination graph features, and/or source graph features to the classification model 425. The classification model 425 can generate a list of candidate classification codes for the networked item, each with an associated confidence score indicating a likelihood that the respective classification codes are correct. The task agent 429 can store the candidate classification codes and confidence scores in memory for further evaluation. In some implementations, the classification model 425 can be configured or trained to generate predictions at distinct levels of the classification (HS) hierarchy, such as chapter, heading, subheading, and item levels. The task agent 429 can record the predictions for each level and use them in subsequent processing steps.

In some cases, the task agent 429 can use the identification of the networked item to query the network graph data structure to retrieve metadata regarding the networked item. The task agent 429 can do so for example, by performing the process described with reference to FIG. 4C. For instance, the task agent 429 can use the identification of the networked item to identify the node corresponding to the profile in the network graph data structure. The task agent 429 can identify one or more sub-graph data structures of the network graph data structure that are linked with (e.g., share an edge with) the node of the profile of the node for the networked item. The task agent 429 can identify one or more initial nodes (e.g., nodes of entities that provide different inputs for generating the networked item) and/or the destination node of each of one or more of the sub-graph data structures. The task agent 429 can identify the name or string identifying the entity associated with the identified nodes and use the identified names as input into the classification model 425 with any other data or metadata identifying or corresponding with the networked item. The task agent 429 can execute the classification model to generate the first set of candidate classification codes 423.

For example, the task agent 429 can execute a querying agent (e.g., a separate large language model trained to generate queries for the network graph data structure) using the identification of the networked item to identify an edge data structure in the network graph data structure corresponding to a network operation involving the networked item between a destination node and a source node of a pair of nodes of the network graph data structure. The querying agent can traverse the network graph data structure to locate the relevant edge data structure based on the networked item identifier. The task agent 429 can extract the destination node and source node identifiers and/or the text description of the networked item from the edge data structure. The task agent 429 can use the extracted information as input to the classification model 425 and the large language model 431.

For example, using the querying agent, the task agent 429 can identify an edge data structure representing a network operation of textiles from a source in India to a destination in the United Kingdom. The task agent 429 can extract the relevant node identifiers and networked item description and use them as input to the models for classification.

In some implementations the task agent 429 can execute the querying agent to identify a source node context and a destination node context, as described above. For example, the task agent 429 can execute the querying agent using the identification of the networked item to identify an edge data structure in the network graph data structure corresponding to a network operation involving the networked item between a destination node and a source node of a pair of nodes of the network graph data structure. The task agent 429 can identify, based on the execution and from the identified edge data structure, an identification of the destination node and the source node of the pair of nodes of the network operation involving the networked item, and a text description of the networked item. The task agent 429 can additionally use the edges connected with the source node to identify identifications of nodes connected with the source node, and any data regarding such connected nodes, as the source node context and the edges connected with the destination node to identify identifications of nodes connected with the destination node, and any data regarding such connected nodes, as the destination node context. The task agent 429 can execute the classification model 425 and execute the large language model 431 each using the identification of the networked item, the identification of the destination node and the source node of the pair of nodes of the network operation involving the networked item, the source node context, the destination node context, and/or the text description of the networked item.

The task agent 429 can execute the large language model 431 using the identification of the networked item and/or any other metadata of the networked item (e.g., the data identified for input into the classification model 425) to generate a second set of candidate classification codes 427. The large language model 431 can be a generative neural network model or a transformer trained to predict classification codes (e.g., HS codes) based on enriched prompts containing network operation and networked item metadata (e.g., any data identifying or regarding the networked item or the network operation involving the networked item). The large language model 431 may be trained (e.g., by the task agent 429 or otherwise the data processing system) based at least on identifications of pairs of nodes and classifications of particular networked items from edge data structures of individual pairs of nodes in the network graph data structure. In some implementations, the large language model 431 can be a finetuned Llama model trained with continued pretraining on tariff definitions, general rules of interpretation, official guides, and rulings, and/or supervised finetuning on various prediction tasks. The large language model 431 can process (e.g., by applying different weights of nodes of the large language model 431) input features such as networked item description, destination and source names, relevant tariff definitions, network operations metadata, previous classification codes, and network operation enrichments. The large language model 431 can output a set of candidate classification codes (e.g., a defined number of one or more candidate classification codes) and confidence scores for the respective candidate classification codes indicating that a likelihood that the candidate classification codes are correct.

For example, the task agent 429 can construct a prompt containing the networked item description, destination name, source name, and/or relevant tariff definitions. The task agent 429 can provide the prompt to the large language model 431 and execute the large language model 431 based on the input. Based on the execution, the task agent 429 can receive as output a set of candidate classification codes, explanations, and confidence scores. The task agent 429 can store the output in memory for further arbitration and selection.

The large language model 431 can generate the candidate classification codes for a particular geographic region or location (e.g., country), which the large language model 431 may identify based on the input location corresponding to the network operation of the prompt input. For example, the task agent 429 can receive the request by receiving the request including the identification of the networked item and an identification of a geographic location. The task agent 429 can execute the classification model 425 and execute the large language model 431 each using the identification of the networked item and the identification of the geographic location. For example, a user can submit a request containing a networked item description and a country of import. The task agent 429 can use the country of import to constrain the candidate classification codes to those applicable in the specified jurisdiction. The task agent 429 can generate country-specific predictions and explanations for the networked item.

In some implementations, the task agent 429 can receive the request comprising the identification of the networked item, an identification of a destination node and a source node of a pair of nodes of a network operation involving the networked item, and a text description of the networked item. The task agent 429 can execute the classification model 425 and execute the large language model 431 each using the identification of the networked item, the identification of the destination node and the source node of the pair of nodes of the network operation involving the networked item, and the text description of the networked item. For example, the task agent 429 can receive a request for a network operation of automotive parts from a source in Japan to a destination in Canada, with a detailed networked item description. The task agent 429 can use the destination and source node identifiers and the networked item description to generate candidate classification codes.

The task agent 429 can generate a composite set of candidate classification codes using the first set of candidate classification codes 423 and the second set of candidate classification codes 427. The composite set can include all unique candidate classification codes from both sets, or a subset based on intersection or other selection logic. In some cases, the task agent 429 can generate the composite set of candidate classification codes by comparing the first and second sets of candidate classification codes 423 and 427. Based on the comparison, the task agent 429 can generate a first list of unique candidate classification codes that are in at least one of the sets 423 and 427. The task agent 429 can generate a second list identifying classification codes are in both lists and discard (e.g., remove from memory or otherwise not include in the composite set of candidate classification codes) the classification codes of the second list to reduce the process and/or reduce the likelihood of improperly biasing any further processing towards a particular classification code that is listed twice to incur a hallucination.

In some cases, the task agent 429 can retrieve a description of each candidate classification code of the composite set from a database. The database can be stored locally or on an external computing device. The database can be a relational database that stores identifications of classification codes and descriptions of the classification codes. The task agent 429 can retrieve the descriptions for the candidate classification codes by using the candidate classification codes as a key and searching the database for definitions or descriptions that map to the classification codes. The descriptions can include official or derived tariff definitions, large language model-generated summaries, and/or subgroup definitions for each classification code. The task agent 429 can concatenate the candidate classification codes and their descriptions into a structured input.

For example, the task agent 429 can identify the candidate classification codes (e.g., all or a defined number of candidate classification codes, such as a defined number of candidate classification codes that correspond with the highest confidence scores) output from the classification model 425 and the large language model 431. If the candidate classification codes differ, the task agent 429 can include both codes in the composite set. The task agent 429 can retrieve the official tariff definitions for each code from a tariff database. The task agent 429 can generate a prompt containing the composite set of candidate classification codes and their descriptions for input to the large language model 431. In some cases, the task agent 429 can identify candidate classification codes that were included in the outputs of both of the classification model 425 and the large language model 431 in the prompt. The task agent 429 can do so with an indication (e.g., a text string indication, such as a defined word (e.g., “duplicate”) or a flag) that the identified classification codes were output twice. By doing so, the task agent 429 can cause the large language model 431 to apply separate weights for the identified candidate classification codes to make it more likely that those candidate classification codes were selected, which may be more likely since separate models generated the same output, further reducing hallucinations by the large language model 431.

The task agent 429 can execute the large language model 431 using the prompt including the composite set of candidate classification codes, confidence scores for the corresponding candidate classification codes, the retrieved description of each candidate classification code of the composite set, and/or any other data regarding the composite set of candidate classification codes to generate a selected candidate classification code from the composite set of candidate classification codes. The large language model 431 can process the candidate classification codes based on the provided descriptions and context, such as by applying the large language model 431's training to the input prompt based on the data of the network graph data structure. Based on the processing, the large language model 431 can select the most appropriate code and/or generate a confidence score for the selected code. The task agent 429 can store the selected code in memory, such as for subsequent updating of the network graph data structure.

For instance, the task agent 429 can generate the composite set of candidate classification codes by concatenating the first set of candidate classification codes and the second set of candidate classification codes into a prompt text string. The task agent 429 can provide the prompt text string into the large language model 431 through a large language model application programming interface. The task agent 429 can receive as output a selected candidate classification code and an explanation for the selection. For example, the task agent 429 can concatenate the candidate classification codes “9401.61.6011” and “9401.69.6011” with their respective descriptions into a prompt. The task agent 429 can provide the prompt to the large language model 431 and receive as output the selected code “9401.61.6011.”

In some cases, the large language model 431 can generate an explanation for the selected candidate classification code and/or confidence score for the selected candidate classification code. For example, the large language model 431 can receive the composite set of candidate classification codes as input. The large language model 431 can evaluate one or more features or attributes associated with each candidate classification code, such as legal principles, tariff definitions, or historical usage patterns, among others. The large language model 431 can reference stored data, prior classification outcomes, or related classification codes, among others, to identify contextual information relevant to each candidate classification code. The large language model 431 can select a candidate classification code from the composite set based on the evaluation of the features, attributes, and contextual information. In some implementations, the large language model 431 can generate a confidence score for the selected candidate classification code by applying one or more scoring criteria to the extracted features and contextual information. The large language model 431 can provide the selected candidate classification code and, if applicable, the relevant contextual information (e.g., the explanation) for generating the selected classification code for presentation at a user interface or for further processing by another component.

In some implementations, the task agent 429 can determine whether the selected candidate classification code meets a confidence threshold (e.g., a predefined confidence threshold). To do so, the task agent 429 can compare the confidence score generated by the large language model 431 to a user-configurable or system-defined threshold. Responsive to determining a confidence score for a selected candidate classification code of the composite set of candidate classification codes exceeds the threshold, the task agent 429 can proceed to update the network graph data structure with the selected candidate classification code and/or generate a user interface including the selected candidate classification code and/or the explanation for the selected candidate classification for presentation at the computing device. If the confidence score does not exceed the threshold, the task agent 429 can trigger further enrichment or user interaction to obtain additional information.

For example, the task agent 429 can receive a confidence score of 92 percent for a selected candidate classification code. If the threshold is set at 90 percent, the task agent 429 can accept the code and update the network graph data structure and/or generate a user interface containing the selected candidate classification code. If the confidence score is below the threshold, the task agent 429 can initiate a copilot workflow to gather more information from the user or to perform web enrichment.

Responsive to generating or accepting the selected candidate classification code for the networked item, the task agent 429 can update the network graph data structure to identify the selected candidate classification code for the networked item. For example, the network graph data structure can store a network of nodes and edges representing relationships or network operations between entities and networked items. The task agent 429 can identify the edge data structure corresponding to a network operation involving the networked item or otherwise the request identifying the networked item. The task agent 429 can insert the selected candidate classification code into a field-value pair of the edge data structure corresponding to classification codes. The task agent 429 can persist the updated edge data structure in the network graph data structure for future reference and analytics.

In some implementations, the task agent 429 can update the network graph data structure by identifying the field-value pair of the edge data structure based on the field-value pair corresponding to a layer of a plurality of defined layers of a hierarchical data structure that corresponds to an entity of the computing device. The task agent 429 can determine the appropriate layer based on the requirements of the requesting entity, such as chapter, heading, subheading, or item level. The task agent 429 can insert the selected code at the field corresponding to the appropriate layer to update the network graph data structure accordingly. For example, if the requesting entity requires classification at the HS10 level, the task agent 429 can insert the selected HS10 code in the corresponding field-value pair of the edge data structure. The task agent 429 can store the updated edge data structure in the network graph data structure.

In some implementation, the task agent 429 can iteratively generate values or classifications at different layers of a full classification code for the networked item. For example, the data processing system can store the hierarchical data structure 435. The hierarchical data structure 435 can be a structured data structure (e.g., a table or matrix) that stores a plurality of classification layers corresponding to different levels of the harmonized system (HS) code hierarchy, such as chapter, heading, subheading, and item levels, among others, which can be used for stepwise classification. Each layer of the hierarchical data structure 435 can store a set of candidate classification codes and associated metadata for the respective HS level, such as code definitions, confidence scores, or explanatory text, among others. The hierarchical data structure 435 can maintain explicit parent-child relationships between codes at adjacent HS levels, such that a code at a lower level is linked to its parent code at the next higher level, thereby enabling the task agent 429 to traverse the hierarchy and generate or select classification codes iteratively at each level quickly.

For example, the task agent 429 can generate a first candidate classification code at the HS4 level by executing a first classification model using the identification of the networked item, the identification of the destination node and the source node of the pair of nodes of the network operation involving the networked item, and/or the text description of the networked item as input to generate a first set of candidate classification codes at the HS4 level. The task agent 429 can generate a second set of candidate classification codes at the HS4 level by executing a large language model 431 using the same input (e.g., with text instructions to generate a code at the HS4 layer). The task agent 429 can generate a composite set of candidate classification codes at the HS4 level using the first set of candidate classification codes and the second set of candidate classification codes. The task agent 429 can retrieve a description of each candidate classification code of the composite set of candidate classification codes from a database. The task agent 429 can execute the large language model 431 using the composite set of candidate classification codes and the retrieved description of each candidate classification code of the composite set of candidate classification codes to generate a selected candidate classification code at the HS4 level.

Responsive to generating the selected candidate classification code at the HS4 level, the task agent 429 can determine (e.g., by identifying the next layer of classification from the hierarchical data structure 435) to generate a candidate classification code at the HS6 level. The task agent 429 can generate a first set of candidate classification codes at the HS6 level by executing a second classification model, which can be different from the first classification model because it is specifically trained to generate candidate classification codes at the HS6 level, using the identification of the networked item, the identification of the destination node the source node of the pair of nodes of the network operation involving the networked item, and/or the text description of the networked item as input. The task agent 429 can generate a second set of candidate classification codes at the HS6 level by executing the large language model 431 using the same input but with instructions (e.g., text instructions) to generate an HS6 classification code. The task agent 429 can generate a composite set of candidate classification codes at the HS6 level using the first set of candidate classification codes and the second set of candidate classification codes as described above, and can repeat the process of retrieving descriptions and executing the large language model 431 to select a candidate classification code at the HS6 level. The task agent 429 repeat this process for any number of layers of classification.

The task agent 429 can determine a number of instances, layers, or iterations to generate candidate classification codes based on a set of criteria and/or stored configurations. For example, in some cases, the task agent 429 can be configured to perform the process for a set number of layers of the hierarchical data structure 435. In some cases, the task agent 429 can determine a number of iterations based on a profile or location (e.g., geographic location, such as country) of the computing device (or an entity of the computing device) that transmitted the request for the classification for the networked item. For example, the profile or location can correspond to, contain, or otherwise be mapped to a particular number of layers, and the task agent 429 can determine to repeat the process for each layer until determining the classification code for the networked item has been generated for each layer until the identified layer. For each iteration, the task agent 429 can execute a classification machine learning model trained to generate classification codes for the corresponding layer and/or include separate instructions in the prompt to the large language model 431 indicating the layer of the hierarchical data structure 435 for which to generate a selected classification code.

For example, if the entity requires classification at the HS8 level, the task agent 429 can generate candidate classification codes at HS2, HS4, HS6, HS8, etc., levels in sequence. The task agent 429 can select the classification code at each level and use the selected code (e.g., as input into the corresponding classification model or in the prompt into the large language model 431) to constrain the candidate set at the next level. The task agent 429 can stop the process when the required level is reached.

In another example, the task agent 429 can first generate a candidate HS2 code using the large language model 431. If further granularity is required, the task agent 429 can generate a composite set of candidate HS4 codes and execute the large language model 431 to select the most appropriate HS4 code. The task agent 429 can repeat this process for HS6, HS8, HS10, etc., levels as needed, each time generating a composite set of candidate classification codes and selecting the classification code based on the context and descriptions.

In some cases, the task agent 429 can operate as a chat interface with the computing device 433 to facilitate generation of the classification code for the networked item. For example, the large language model 431 may determine a determination could not be made regarding which candidate classification code to select from a candidate set of classification codes. The large language model 431 may do so, for example, responsive to determining that highest confidence score that the large language model 431 generates for a classification code of an input prompt containing the composite set of candidate classification codes does not exceed a threshold or some other criteria. Responsive to such a determination, the task agent 429 can generate a question for more information that would aid in the determination of the correct classification code. For instance, the large language model 431 can process the prompt by evaluating the candidate classification codes, the associated descriptions, and the contextual information, and can generate a targeted question that identifies a specific attribute or detail required to disambiguate between the candidate classification codes.

For example, if the large language model 431 cannot confidently select between two candidate classification codes due to insufficient information about the material composition of a networked item, the task agent 429 can generate a question such as “What is the primary material of the networked item?” and present it to the user. The user can provide the requested information, and the task agent 429 can re-execute the large language model 431 with the updated input to select the appropriate candidate classification code.

For instance, the task agent 429 can execute, through a large language model application programming interface, the large language model 431 using the composite set of candidate classification codes and the retrieved description of each candidate classification code of the composite set as input, and to generate a question requesting more information about the networked item based on a determination by the large language model 431 that a classification code could not be selected based on the input. The task agent 429 can receive data including the question from the large language model 431 through the large language model application programming interface. Responsive to determining the data includes the question instead of a selected classification code, the task agent 429 can transmit the question for presentation on a user interface presented at the computing device. The task agent 429 can receive the requested more information from the user interface of the computing device. The task agent 429 can re-execute the large language model 431 using the received requested more information, the composite set of candidate classification codes, and the retrieved description of each candidate classification code of the composite set and/or any other relevant data. Based on the execution, the large language model 431 can determine whether a candidate classification code could be selected or otherwise generate another question requesting more information. The task agent 429 can repeat this process any number of times until the large language model 431 generates a selected classification code from the composite set of candidate classification codes.

In some cases, the large language model 431 or the task agent 429 can maintain a history of the conversation (e.g., a transcript) between the large language model 431 and the user at the computing device 433 to use as context for the classification code generation. The task agent 429 can maintain a transcript of the interactions, including all questions and responses exchanged with the user for each layer of the classification and/or only for the layer for which the task agent 429 is generating the classification code. The task agent 429 can maintain the transcript in short term memory or otherwise in a cache of the data processing system for fast and efficient retrieval. The task agent 429 can provide the transcript in the input prompt to the large language model 431 to maintain context and continuity in the classification process. The task agent 429 can execute the large language model 431 using messages previously generated by the large language model 431 and/or input by the user in a transcript of messages generated by and input into the large language model 431 regarding generating the selected candidate classification code.

For example, the task agent 429 can maintain a transcript containing the initial prompt, the candidate classification codes, the generated question, the user's response, and any follow-up questions. The task agent 429 can execute the large language model 431 with the complete transcript for the layer being classified and/or for the total conversation to generate the classification code in the prompt input to ensure that all relevant information is considered in the final code selection.

The task agent 429 can execute the large language model 431 to generate the selected candidate classification code by executing the large language model 431 using the composite set of candidate classification codes and the retrieved description of each candidate classification code of the composite set to generate a first candidate classification code at a first layer of a plurality of defined layers of a hierarchical data structure. The task agent 429 can determine to generate a second candidate classification code at a second layer of the plurality of defined layers of the hierarchical data structure. Responsive to the determination, the task agent 429 can generate a second composite set of candidate classification codes using a second classification model and the large language model 431 using the identification of the networked item, each of the second composite set of candidate classification codes corresponding to the second layer of the plurality of defined layers of the hierarchical data structure. The task agent 429 can execute the large language model 431 using the second composite set of candidate classification codes to generate the selected candidate classification code.

For example, the task agent 429 can first select a candidate HS2 code for a network operation of electronic devices. The task agent 429 can then generate a composite set of candidate HS4 codes and select the best code based on the context and descriptions. The task agent 429 can repeat this process for HS6, HS8, etc., levels as needed.

For instance, the task agent 429 can determine a layer of the hierarchical data structure that corresponds to an entity of the computing device. The task agent 429 can determine the layer of the hierarchical data structure is higher than the first layer of the first candidate classification code that the task agent 429 identifies. The task agent 429 can iteratively generate candidate classification codes for the networked item at increasing layers of the hierarchical data structure until determining a current layer of the generated candidate classification code is at the layer of the hierarchical data structure that corresponds to the entity of the computing device.

For example, if the entity requires classification at the HS10 level, the task agent 429 can generate candidate classification codes at HS2, HS4, HS6, HS8, HS10, etc., levels in sequence. The task agent 429 can select or generate (e.g., using the large language model 431) the classification code at each level and use the selected code to constrain the candidate set at the next level. The task agent 429 can stop the process when the required level is reached.

In a non-limiting example, the task agent 429 can execute, through a large language model application programming interface, the large language model 431 using the composite set of candidate classification codes and the retrieved description of each candidate classification code of the composite set as input to generate a question requesting more information about the networked item based on a determination by the large language model 431 that a classification code could not be selected based on the input. The task agent 429 can receive data including the question from the large language model 431 through the large language model application programming interface. Responsive to determining the data includes the question instead of a selected classification code, the task agent 429 can transmit the question for presentation on a user interface presented at the computing device. The task agent 429 can receive the requested more information from the user interface of the computing device. The task agent 429 can re-execute the large language model 431 using the received requested more information, the composite set of candidate classification codes, and the retrieved description of each candidate classification code of the composite set to generate the selected candidate classification code.

For example, if the large language model 431 cannot confidently select between two candidate classification codes due to insufficient information about the intended use of a networked item, the task agent 429 can generate a question such as “What is the intended use of the networked item?” and present it to the user. The user can provide the requested information, and the task agent 429 can re-execute the large language model 431 with the updated input to select the appropriate classification code.

The task agent 429 can re-execute the large language model 431 using the requested more information and one or more messages previously generated by the large language model 431 in a transcript of messages generated by and input into the large language model 431 regarding generating the selected candidate classification code. The task agent 429 can maintain a transcript of the interaction, including all questions and responses exchanged with the user. The task agent 429 can provide the transcript as input to the large language model 431 to maintain context and continuity in the classification process.

For example, the task agent 429 can maintain a transcript containing the initial prompt, the candidate classification codes, the generated question, the user's response, and any follow-up questions. The task agent 429 can re-execute the large language model 431 with the complete transcript to ensure that all relevant information is considered in the final code selection.

The task agent 429 can generate the composite set of candidate classification codes by concatenating the first set of candidate classification codes and the second set of candidate classification codes into a prompt text string. The task agent 429 can provide the prompt text string into the large language model 431 through a large language model application programming interface. The task agent 429 can receive as output a selected candidate classification code and an explanation for the selection.

For example, the task agent 429 can concatenate the candidate classification codes “6204.62.8011” and “6204.69.8011” with their respective descriptions into a prompt. The task agent 429 can provide the prompt to the large language model 431 and receive as output the selected code “6204.62.8011” with an explanation referencing the relevant tariff definition and networked item attributes.

The task agent 429 can generate the composite set of candidate classification codes by identifying a set of common candidate classification codes between the first set of candidate classification codes and the second set of candidate classification codes and a set of unique candidate classification codes between the first set of candidate classification codes and the second set of candidate classification codes. The task agent 429 can only include the unique candidate classification codes between the first set of candidate classification codes and the second set of candidate classification codes in the composite set of candidate classification codes.

For example, if both the classification model 425 and the large language model 431 generate the same top candidate classification code, the task agent 429 can include only the unique codes in the composite set to reduce redundancy. The task agent 429 can provide the composite set to the large language model 431 for arbitration and selection.

The task agent 429 can receive the request by receiving the request comprising the identification of the networked item and an identification of a geographic location. The task agent 429 can execute the classification model 425 and execute the large language model 431 each using the identification of the networked item and the identification of the geographic location.

For example, a user can submit a request containing a networked item description and a country of import. The task agent 429 can use the country of import to constrain the candidate classification codes to those applicable in the specified jurisdiction. The task agent 429 can generate country-specific predictions and explanations for the networked item.

In some implementations, the task agent 429 can receive a request comprising the identification of the networked item, an identification of a destination node and a source node of a pair of nodes of a network operation involving the networked item, and a text description of the networked item. The task agent 429 can execute the classification model 425 and execute the large language model 431 each using the identification of the networked item, the identification of the destination node and the source node of the pair of nodes of the network operation involving the networked item, and the text description of the networked item.

For example, the task agent 429 can receive a request for a network operation of medical devices from a source in France to a destination in Australia, with a detailed networked item description. The task agent 429 can use the destination and source node identifiers and the networked item description to generate candidate classification codes and perform arbitration.

The task agent 429 can execute the large language model 431 to generate the selected candidate classification code by executing the large language model 431 using the composite set of candidate classification codes and the retrieved description of each candidate classification code of the composite set to generate a first candidate classification code at a first layer of a plurality of defined layers of a hierarchical data structure. The task agent 429 can determine to generate a second candidate classification code at a second layer of the plurality of defined layers of the hierarchical data structure. Responsive to the determination, the task agent 429 can generate a second composite set of candidate classification codes using a second classification model and the large language model 431 using the identification of the networked item, each of the second composite set of candidate classification codes corresponding to the second layer of the plurality of defined layers of the hierarchical data structure. The task agent 429 can execute the large language model 431 using the second composite set of candidate classification codes to generate the selected candidate classification code.

For example, the task agent 429 can first select a candidate HS2 code for a network operation of apparel. The task agent 429 can then generate a composite set of candidate HS4 codes and select the best code based on the context and descriptions. The task agent 429 can repeat this process for HS6, HS8, etc., levels as needed.

The task agent 429 can determine a layer of the hierarchical data structure that corresponds to an entity of the computing device. The task agent 429 can determine the layer of the hierarchical data structure is higher than the first layer of the first candidate classification code. The task agent 429 can iteratively generate candidate classification codes for the networked item at increasing layers of the hierarchical data structure until determining a current layer of the generated candidate classification code is at the layer of the hierarchical data structure that corresponds to the entity of the computing device.

For example, if the entity requires classification at the HS8 level, the task agent 429 can generate candidate classification codes at HS2, HS4, HS6, HS8, etc., levels in sequence. The task agent 429 can select the best code at each level and use the selected code to constrain the candidate set at the next level. The task agent 429 can stop the process when the required level is reached.

Referring now to FIG. 4E, illustrated is a flow diagram depicting a sequence 450 for iterative generation of a classification using an agentic hierarchical architecture, in accordance with some embodiments. The sequence 450 can be performed by a data processing system (e.g., the data processing system 306, shown and described with reference to FIG. 3A, or any other computing device as described herein). The sequence 450 can include more or fewer operations. The operations can be performed in any order.

The classification orchestrator 410 can operate as a system-level component of a data processing system, such as the data processing system 306, and can coordinate a workflow for networked item classification. The classification orchestrator 410 can be or include a task agent, a workflow controller (e.g., a controller module or set of instructions or a separate computer configured to control different computing components within the system of the sequence 450), an application, service, program, task or any type and form of executable instructions for example, as described herein. The classification orchestrator 410 can control the flow of data and execution among a plurality of models, enrichment agents, and user interface components. The classification orchestrator 410 can sequence the execution of model inference, hybrid search, arbitration by a large language model, and user or agent queries, advancing through the classification code selection process until a confident prediction is reached. The classification orchestrator 410 can generate a composite set of candidate classification codes using a first set of candidate classification codes and a second set of candidate classification codes. The classification orchestrator 410 can communicate with a network graph data structure, a classification model, and a large language model. The classification orchestrator 410 can invoke dual encoder models, hybrid search, and large language model-based arbitration for classification code selection. The classification orchestrator 410 can manage the iterative classification process by invoking models, arbitration, and user or agent interaction as needed.

The classification orchestrator 410 can receive, at operation 437, input network operations such as networked item or network operation data to be classified. The input network operations can include a networked item description, an importer name, and an exporter name. The classification orchestrator 410 can receive such input network operations from a computing device, for example, through a user interface or an application programming interface. The classification orchestrator 410 can parse a comma-separated values file containing networked item descriptions, importer and exporter information, and network operation metadata. The classification orchestrator 410 can store the parsed input network operations in memory and make the data available to downstream models and agents for further processing.

At operation 439, the classification orchestrator 410 can execute a dual encoder model with graph features and a classification head to generate initial classification code predictions. The dual encoder model can receive as input the networked item description and graph-based features for the importer and exporter. The dual encoder model can process the input features using learned representations and graph-based context, such as company NACE codes and historical network operations, to output a set of candidate country-specific classification codes and associated confidence scores. The classification orchestrator 410 can receive the predictions and confidence scores from the dual encoder model and store them for subsequent arbitration or selection.

At operation 441, the classification orchestrator 410 can evaluate whether the model's prediction confidence exceeds a predefined threshold. The classification orchestrator 410 can compare the highest confidence score from the model to a user-configurable or system-defined threshold. The classification orchestrator 410 can determine whether to accept the model's prediction or to trigger further enrichment and hierarchical selection.

At operation 443, the classification orchestrator 410 can display or output the classification code prediction when the confidence threshold is met. The classification orchestrator 410 can generate a user interface identifying the classification and the networked item for presentation at the computing device. The classification orchestrator 410 can render the prediction in the user interface, group networked items by status such as classified, likely misclassified, or needs classification, and provide detailed insights for each classification, including confidence scores, general rules of interpretation analysis, and detailed explanations. The classification orchestrator 410 can allow the user to export classification results as a portable document format file or a comma-separated values file.

At operation 445, the classification orchestrator 410 can execute web enrichment to supplement the input data with additional context or attributes. The classification orchestrator 410 can invoke one or more enrichment agents or application programming interfaces to collect relevant networked item or company information for vague or low-confidence network operations. The classification orchestrator 410 can aggregate the relevant data and append it to the input for further processing. The classification orchestrator 410 can enrich the networked item description using web search application programming interfaces, collecting relevant web snippets, and can enrich importer or exporter details using web search.

At operation 447, the classification orchestrator 410 can invoke a hierarchical classification selector agent, such as a large language model, to predict the next two digits of the classification code at each iteration. The classification orchestrator 410 can use a large language model-based agent to select the next classification code segment based on enriched input and context. The classification orchestrator 410 can process the current context and candidate classification codes, selecting the next classification code segment and feeding it into the next iteration. The classification orchestrator 410 can advance the classification process through the classification code hierarchy, selecting each segment in turn.

At operation 449, the classification orchestrator 410 can determine whether the full classification code has been predicted after iterative selection. The classification orchestrator 410 can check whether all required classification code segments, such as six, eight, or ten digits, have been selected. The classification orchestrator 410 can determine whether to finalize the classification or to continue iterating through the hierarchy. The classification orchestrator 410 can output the result or loop back for further selection based on the current state of the classification.

At operation 451, the classification orchestrator 410 can display or output the final classification code prediction once the full code has been selected. The classification orchestrator 410 can render the complete classification code in the user interface or application programming interface response. The classification orchestrator 410 can present the final classification code, along with supporting details and explanations as needed. The classification orchestrator 410 can provide detailed insights for each classification, including confidence scores, general rules of interpretation analysis, and detailed explanations, and can allow manual entry of classifications and exporting results as needed.

At operation 453, the classification orchestrator 410 can determine whether the selector agent was able to predict the next two digits of the classification code. The classification orchestrator 410 can check whether the large language model-based agent was able to confidently select the next classification segment or whether more information is needed. The classification orchestrator 410 can evaluate the selector agent's output and, if uncertain, can invoke a question agent to request clarification.

At operation 455, the classification orchestrator 410 can generate one or more clarifying questions using a large language model-based question agent when the selector agent cannot confidently select the next classification segment. The classification orchestrator 410 can formulate targeted questions about networked item attributes, materials, or use cases. The classification orchestrator 410 can generate multiple-choice questions, free response questions, or other types of prompts that request clarification regarding networked item details, network operation attributes, or other metadata relevant to the classification of a networked item. The classification orchestrator 410 can present the generated questions in the user interface or transmit the questions to an answer agent for automated response.

At operation 457, the classification orchestrator 410 can answer the generated question using a large language model-based answer agent, if possible. The classification orchestrator 410 can reference available data, enrichment, and prior context to provide an automated response to the clarifying question. The classification orchestrator 410 can process the question, search available data, and return an answer if possible. If the answer agent cannot provide a sufficient response, the classification orchestrator 410 can escalate the question to the user for manual input.

At operation 459, the classification orchestrator 410 can determine whether the answer agent was able to answer the clarifying question. The classification orchestrator 410 can check whether the answer agent provided a sufficient response or whether user input is required. The classification orchestrator 410 can evaluate the answer agent's output and, if insufficient, can trigger user interaction. The classification orchestrator 410 can support reversibility for changing answers and web enrichment steps with user confirmation.

At operation 461, the classification orchestrator 410 can ask the clarifying question directly to the user via the user interface when the answer agent cannot answer. The classification orchestrator 410 can present the question in the user interface for manual user response. The classification orchestrator 410 can display the question in the user interface, collect the user's response, and feed it back into the workflow for continued processing. The classification orchestrator 410 can solicit user input to resolve ambiguity and enable further classification.

The classification orchestrator 410 can repeat operations 447, 449, 451, 453, 455, 457, 459, and 461 in a loop, each time invoking the hierarchical HS selector agent, checking whether the full classification code has been predicted, displaying the final classification code prediction, determining whether the selector agent was able to predict the next two digits of the classification code, generating clarifying questions, answering the questions, and asking clarifying questions to the user as needed. The classification orchestrator 410 can continue to iterate through the classification code hierarchy, invoking models, enrichment, and user or agent interaction, until a confident prediction is reached.

The classification orchestrator 410 can store the final classification code prediction, confidence scores, and supporting explanations in a database or memory for subsequent reporting, auditing, or export. The classification orchestrator 410 can generate reports or export classification results as a portable document format file or a comma-separated values file. The classification orchestrator 410 can provide access to the stored classification results and supporting information for downstream analysis or compliance purposes.

The classification orchestrator 410 can interface with a misclassification detection component, which can flag likely misclassifications and provide likelihood and impact assessments. The classification orchestrator 410 can receive misclassification insights from the misclassification detection component and can surface such insights in the user interface. The classification orchestrator 410 can allow the user to export misclassification insights in reports for further review or remediation.

The classification orchestrator 410 can invoke enrichment agents to supplement networked item descriptions and importer or exporter details using web search application programming interfaces. The enrichment agents can collect relevant web snippets and additional context to improve classification accuracy. The classification orchestrator 410 can determine whether to invoke enrichment agents based on scoring thresholds or the detection of vague, nonsensical, or web-enhanceable networked item descriptions.

The classification orchestrator 410 can communicate with a vagueness detection component (e.g., a vagueness detector or machine learning model trained or configured to analyze text descriptions of items to determine a vagueness score indicating a magnitude of the vagueness of the text descriptions), which can score each network operation on vagueness criteria to inform the need for enrichment or human review (e.g., based on whether the score (e.g., vagueness score) exceeds a threshold). The vagueness detection component can use models such as bidirectional encoder representations from transformers or large language models, finetuned iteratively using weak supervision and manually labeled network operations. The classification orchestrator 410 can receive vagueness scores from the vagueness detection component and can trigger enrichment or review workflows as needed.

The classification orchestrator 410 can support a copilot workflow for human-in-the-loop assisted classification. The copilot workflow can integrate machine learning predictions and human input to iteratively classify networked items at different classification levels, such as HS2, HS4, HS6, HS10, etc. The classification orchestrator 410 can generate multiple-choice and free response questions to clarify networked item details, use machine learning model predictions at each step to suggest relevant classification codes and tariff definitions, and allow reversibility for changing answers and web enrichment steps with user confirmation.

Referring now to FIG. 4F, illustrated is a flow diagram depicting a sequence 452 for iterative generation of a classification using an agentic hierarchical architecture, in accordance with some embodiments. The sequence 452 can be performed by a data processing system (e.g., the data processing system 306, shown and described with reference to FIG. 3A, or any other computing device as described herein). The sequence 452 can include more or fewer operations. The operations can be performed in any order.

In the sequence 452, the classification orchestrator 410 can receive, at operation 461, input network operations such as networked item or network operation data to be classified. The input network operations can include a networked item description, an importer name, and an exporter name. The classification orchestrator 410 can receive such input network operations from a computing device, for example, through a user interface or an application programming interface. The classification orchestrator 410 can parse a comma-separated values file containing networked item descriptions, importer and exporter information, and network operation metadata. The classification orchestrator 410 can store the parsed input network operations in memory and make the data available to downstream models and agents for further processing.

At operation 463, the classification orchestrator 410 can determine whether a networked item description requires enhancement, such as enrichment or clarification. The classification orchestrator 410 can apply one or more rules or models, such as a vagueness detection model, to assess the need for enrichment. The classification orchestrator 410 can evaluate whether the networked item description is sufficiently detailed for classification or whether enrichment is needed. The classification orchestrator 410 can determine that the networked item description is vague, nonsensical, or web-enhanceable, among others, and can trigger enrichment steps in response to such a determination.

At operation 471, the classification orchestrator 410 can execute web enrichment to supplement the input data with additional context or attributes. The classification orchestrator 410 can invoke one or more enrichment agents or application programming interfaces to collect relevant networked item or company information for vague or low-confidence network operations. The classification orchestrator 410 can aggregate the relevant data and append it to the input for further processing. The classification orchestrator 410 can enrich the networked item description using web search application programming interfaces, collecting relevant web snippets, and can enrich importer or exporter details using web search.

At operation 473, the classification orchestrator 410 can evaluate whether the web enrichment is of sufficient quality to be used in downstream processing. The classification orchestrator 410 can apply quality scoring or validation checks to the enriched data before use. The classification orchestrator 410 can assess the relevance, completeness, or accuracy of the web-enriched description. The classification orchestrator 410 can determine whether to use or discard the web-enriched description based on the applied scoring thresholds.

At operation 475, the classification orchestrator 410 can use the web-enriched description if it is determined to be of good quality. The classification orchestrator 410 can incorporate the enriched description into the input features for model inference. The classification orchestrator 410 can append or replace the original description with the enriched version for use in downstream models. The classification orchestrator 410 can use the final enrichments as context for classification.

At operation 477, the classification orchestrator 410 can ignore the web-enriched description if it is determined to be of insufficient quality. The classification orchestrator 410 can discard irrelevant or low-confidence enrichment results and can proceed with the original input or an alternative input for modeling. The classification orchestrator 410 can bypass the enrichment and continue the classification process using only high-quality enrichment data.

At operation 465, the classification orchestrator 410 can execute multiple internal models, such as an ensemble or tiered architecture, to generate initial classification code predictions. The classification orchestrator 410 can invoke a dual encoder model with graph features, an ensemble model with dual encoder, hybrid search, and a large language model arbiter, or other models, among others. The classification orchestrator 410 can process input features using learned representations and graph-based context, such as company NACE codes and historical network operations, to output candidate classification codes and associated confidence scores for each input network operation.

At operation 467, the classification orchestrator 410 can evaluate whether the model's prediction confidence exceeds a predefined threshold. The classification orchestrator 410 can compare the highest confidence score from the model to a user-configurable or system-defined threshold. The classification orchestrator 410 can determine whether to accept the model's prediction or to trigger further enrichment and hierarchical selection.

At operation 469, the classification orchestrator 410 can display or output the classification code prediction when the confidence threshold is met. The classification orchestrator 410 can generate a user interface identifying the classification and the networked item for presentation at the computing device. The classification orchestrator 410 can render the prediction in the user interface, group networked item by status such as classified, likely misclassified, or needs classification, and provide detailed insights for each classification, including confidence scores, general rules of interpretation analysis, and/or detailed explanations. The classification orchestrator 410 can allow the user to export classification results as a portable document format file or a comma-separated values file.

At operation 479, the classification orchestrator 410 can invoke a hierarchical HS selector agent, such as a large language model, to predict the next two digits of the classification code at each iteration. The classification orchestrator 410 can use a large language model-based agent to select the next classification code segment based on enriched input and context. The classification orchestrator 410 can process the current context and candidate classification codes, selecting the next classification code segment and feeding it into the next iteration. The classification orchestrator 410 can advance the classification process through the classification code hierarchy, selecting each segment in turn.

At operation 481, the classification orchestrator 410 can determine whether the full classification code has been predicted after iterative selection. The classification orchestrator 410 can check whether all required classification code segments, such as six, eight, or ten digits, have been selected. The classification orchestrator 410 can determine whether to finalize the classification or to continue iterating through the hierarchy. The classification orchestrator 410 can output the result or loop back for further selection based on the current state of the classification.

At operation 483, the classification orchestrator 410 can display or output the final classification code prediction once the full code has been selected. The classification orchestrator 410 can render the complete classification code in the user interface or application programming interface response. The classification orchestrator 410 can present the final classification code, along with supporting details and explanations as needed. The classification orchestrator 410 can provide detailed insights for each classification, including confidence scores, general rules of interpretation analysis, and detailed explanations.

At operation 485, the classification orchestrator 410 can determine whether the selector agent was able to predict the next two digits of the classification code. The classification orchestrator 410 can check whether the large language model-based agent was able to confidently select the next HS segment or whether more information is needed. The classification orchestrator 410 can evaluate the selector agent's output and, if uncertain, can invoke a question agent to request clarification.

At operation 487, the classification orchestrator 410 can ask a clarifying question directly to the user via the user interface when the agent cannot answer. The classification orchestrator 410 can present the question in the user interface for manual user response. The classification orchestrator 410 can display the question in the user interface, collect the user's response, and feed it back into the workflow for continued processing. The classification orchestrator 410 can solicit user input to resolve ambiguity and enable further classification.

The classification orchestrator 410 can repeat operations 479, 481, 483, 485, and 487 in a loop, each time invoking the hierarchical HS selector agent, checking whether the full classification code has been predicted, displaying the final classification code prediction, determining whether the selector agent was able to predict the next two digits of the classification code, and asking clarifying questions to the user as needed. The classification orchestrator 410 can continue to iterate through the classification code hierarchy, invoking models, enrichment, and user or agent interaction, until a confident prediction is reached.

The classification orchestrator 410 can store the final classification code prediction, confidence scores, and supporting explanations in a database or memory for subsequent reporting, auditing, or export. The classification orchestrator 410 can generate reports or export classification results as a portable document format file or a comma-separated values file. The classification orchestrator 410 can provide access to the stored classification results and supporting information for downstream analysis or compliance purposes.

The classification orchestrator 410 can interface with a misclassification detection component, which can flag likely misclassifications and provide likelihood and impact assessments. The classification orchestrator 410 can receive misclassification insights from the misclassification detection component and can surface such insights in the user interface. The classification orchestrator 410 can allow the user to export misclassification insights in reports for further review or remediation.

The classification orchestrator 410 can invoke enrichment agents to supplement networked item descriptions and importer or exporter details using web search application programming interfaces. The enrichment agents can collect relevant web snippets and additional context to improve classification accuracy. The classification orchestrator 410 can determine whether to invoke enrichment agents based on scoring thresholds or the detection of vague, nonsensical, or web-enhanceable networked item descriptions.

Referring now to FIG. 4G, illustrated is a flow diagram depicting a sequence 454 for iterative generation of a classification using an agentic hierarchical architecture, in accordance with some embodiments. The sequence 454 can be performed by a data processing system (e.g., the data processing system 306, shown and described with reference to FIG. 3A, or any other computing device as described herein). The sequence 454 can include more or fewer operations. The operations can be performed in any order. The sequence 454 can facilitate automated, accurate, and explainable networked item code classification by combining dual encoder predictions, hybrid search with multi-representations and misprediction avoidance, large language model arbitration, and iterative user-assisted workflows, thereby reducing language model hallucinations.

In the sequence 454, the classification orchestrator 410 can receive, at operation 489, input network operations such as networked item or network operation data to be classified. The input network operations can include a networked item description, an importer name, and an exporter name. The classification orchestrator 410 can receive such input network operations from a computing device, for example, through a user interface or an application programming interface. The classification orchestrator 410 can parse a comma-separated values file containing networked item descriptions, importer and exporter information, and network operation metadata. The classification orchestrator 410 can store the parsed input network operations in memory and make the data available to downstream models and agents for further processing.

At operation 491, the classification orchestrator 410 can execute a dual encoder model with graph features and a classification head to generate initial classification code predictions. The dual encoder model can receive as input the networked item description and graph-based features for the importer and exporter. The dual encoder model can process the input features using learned representations and graph-based context, such as company NACE codes and historical network operations, to output a set of candidate country-specific classification codes and associated confidence scores. The classification orchestrator 410 can receive the predictions and confidence scores from the dual encoder model and store them for subsequent arbitration or selection.

At operation 493, the classification orchestrator 410 can execute a hybrid search model (e.g., a computer model, machine learning model, etc.) with multi-representations and mispredictions to generate an alternative set of candidate classification codes. The hybrid search model can use multiple representations of tariff definitions, including official or derived tariff definitions, large language model-generated summaries, and subgroup definitions. The hybrid search model can maintain a mispredictions index that tracks networked item descriptions and their correct classification codes for network operations where the top prediction was not correct. During inference, the hybrid search model can search both the multi-representations index and the mispredictions index to identify the top candidate classification codes. The classification orchestrator 410 can receive the candidate classification codes generated by the hybrid search model and store them for further arbitration or selection.

At operation 495, the classification orchestrator 410 can compare the top-1 classification code predictions from the dual encoder model and the hybrid search model. The classification orchestrator 410 can determine whether the top-1 prediction from the dual encoder model matches the top-1 prediction from the hybrid search model. If the top-1 predictions are the same, the classification orchestrator 410 can proceed to operation 497. If the top-1 predictions differ, the classification orchestrator 410 can proceed to operation 499.

At operation 497, the classification orchestrator 410 can select the top-1 classification code prediction when both the dual encoder model and the hybrid search model agree on the top-1 candidate. The classification orchestrator 410 can finalize the classification result by selecting the agreed-upon top-1 classification code. The classification orchestrator 410 can store the selected classification code and associated metadata in memory for subsequent output or display.

At operation 499, the classification orchestrator 410 can invoke a large language model arbiter, such as an OpenAI GPT-4 model, to arbitrate between differing model predictions. The classification orchestrator 410 can provide the large language model arbiter with the candidate classification codes from the dual encoder model and the hybrid search model, along with the relevant tariff definitions for the top candidates. The large language model arbiter can process the candidate classification codes and supporting definitions, and can select the best option based on context and model outputs. The classification orchestrator 410 can receive the selected classification code from the large language model arbiter and store the result for further processing.

At operation 4002, the classification orchestrator 410 can select the top-1 classification code prediction as determined by the large language model arbiter. The classification orchestrator 410 can finalize the classification result by accepting the classification code selected by the large language model arbiter. The classification orchestrator 410 can store the selected classification code and associated metadata in memory for subsequent output or display.

At operation 4004, the classification orchestrator 410 can display or output the classification code prediction to the user or a downstream system. The classification orchestrator 410 can generate a user interface identifying the classification and the networked item for presentation at the computing device. The classification orchestrator 410 can render the prediction in the user interface, group networked items by status such as classified, likely misclassified, or needs classification, and provide detailed insights for each classification, including confidence scores, general rules of interpretation analysis, and detailed explanations. The classification orchestrator 410 can allow the user to export classification results as a portable document format file or a comma-separated values file.

At operation 4006, the classification orchestrator 410 can select the top-2 to top-n results alternately for further arbitration or review, as part of an iterative arbitration process. The classification orchestrator 410 can present multiple candidate classification codes to the large language model arbiter or the user for further consideration. The classification orchestrator 410 can alternately present the next-best candidate classification codes for arbitration or user selection, supporting iterative refinement of the classification result.

Referring now to FIG. 4H, illustrated is a flow diagram depicting a sequence 456 for iterative generation of a classification using an agentic hierarchical architecture, in accordance with some embodiments. The flow diagram 456 can include at least one user interface 4008, at least one classifier 4016, at least one misclassifier 4014, at least one query agent 4018, at least one vagueness detector 4020, at least one network operation enrichment agent 4022, at least one web search engine 4024, at least one LLM API 4026, at least one FT Llama classifier 4028, at least one FT Llama confidence model 4030, at least one FT Llama vagueness detector 4032, at least one set of endpoints 4010, and at least one set of throughput-based model endpoints 4012.

The user interface 4008 can be a graphical user interface or web portal through which a user may submit classification requests, check misclassifications, and review outputs. The user interface 4008 can generate a user interface for uploading networked items via a comma-separated values file, reviewing classification predictions, and exporting results. The user interface 4008 can receive, from a computing device, a request comprising an identification of a networked item. The user interface 4008 can collect user input, transmit requests to backend services, and display classification results and insights. For example, networked item stock keeping units may be uploaded to the trade compliance section via a comma-separated values file. The user interface 4008 can display classification results by grouping networked items by status, such as classified, likely misclassified, or needs classification, among others. The user interface 4008 can generate a user interface identifying the classification and the networked item for presentation at the computing device in response to a determination by the system.

The endpoints 4010 can be backend service endpoints supporting trade compliance workflows, including the classifier 4016 and the misclassifier 4014. The endpoints 4010 can receive, from a computing device, a request comprising an identification of a networked item. The endpoints 4010 can expose representational state transfer interfaces or remote procedure call interfaces for client and service communication. The endpoints 4010 can provide classification, misclassification, and related services to the user interface 4008 and other components. The endpoints 4010 can receive requests for classification, requests to check misclassification, or requests to retrieve top candidate classifications, among others.

The throughput-based model endpoints 4012 can be backend service endpoints optimized for high-throughput requests to Llama-based models, including the FT Llama classifier 4028, the FT Llama confidence model 4030, and the FT Llama vagueness detector 4032. The throughput-based model endpoints 4012 can support scalable, parallel processing of classification, confidence, and vagueness detection requests. The throughput-based model endpoints 4012 can be deployed in a scalable environment, such as a Databricks serving environment, to process large volumes of requests from orchestrators and agents. The throughput-based model endpoints 4012 can provide access to the FT Llama classifier 4028 for classification code prediction, the FT Llama confidence model 4030 for generating confidence scores, and the FT Llama vagueness detector 4032 for detecting vagueness in networked item descriptions.

The misclassifier 4014 can be a model or service for detecting and flagging networked items that are likely misclassified based on model outputs and historical data. The misclassifier 4014 can determine that a classification prediction for a historical networked item transport was a misclassification. The misclassifier 4014 can analyze classification results, compare the results to historical or ground truth data, and flag discrepancies for user review. The misclassifier 4014 can provide insights for remediation and reporting. The misclassifier 4014 can surface misclassification insights in the user interface 4008 and can generate outputs that may be exported in reports.

The classifier 4016 can be a machine learning model, such as a dual encoder with graph features, deployed for generating candidate classification codes and confidence scores. The classifier 4016 can process input data to generate top candidate classifications and associated scores. The classifier 4016 can generate candidate classification codes for networked items based at least on identifications of the networked items. The classifier 4016 can execute the classification model using the identification of the networked item as input to generate a first set of candidate classification codes. The classifier 4016 can utilize learned representations and graph-based features to output predictions. The classifier 4016 can interface with the query agent 4018 for hybrid search and tariff definitions. For example, the classifier 4016 can leverage graph features including company NACE codes and training on companies' historical network operations to inform the classification prediction for new network operations.

The query agent 4018 can be a backend service or agent that performs in-memory hybrid searches for United States tariff definitions and tariff definitions for multiple countries. The query agent 4018 can retrieve relevant tariff definitions and candidate classification codes to support classification. The query agent 4018 can generate a composite set of candidate classification codes using a first set of candidate classification codes and a second set of candidate classification codes. The query agent 4018 can access in-memory databases and hybrid search indices to provide context for the classifier 4016 and other components. The query agent 4018 can perform hybrid search using multiple representations of tariff definitions, including official or derived tariff definitions and large language model summarized tariff definitions.

The vagueness detector 4020 can be a machine learning model, such as a bidirectional encoder representations from transformers model or a Llama model, trained to score input descriptions for vagueness, nonsense-ness, and web-enhanceability. The vagueness detector 4020 can identify network operations that require enrichment or human review due to insufficient description quality. The vagueness detector 4020 can determine that the confidence score for the classification is less than a threshold. The vagueness detector 4020 can process input descriptions, apply scoring thresholds, and trigger enrichment or review workflows as needed. The vagueness detector 4020 can generate a vagueness score for each network operation to inform the need for enrichment or human review.

The network operation enrichment agent 4022 can be a backend service that enriches networked item descriptions and importer or exporter details using web search application programming interfaces and other external data sources. The network operation enrichment agent 4022 can supplement input data with relevant context to improve classification accuracy. The network operation enrichment agent 4022 can execute a search engine across the Internet using the identifier of the networked item to retrieve one or more characteristics of the networked item. The network operation enrichment agent 4022 can invoke web search engines, aggregate relevant information, and append the information to the input for downstream processing. The network operation enrichment agent 4022 can identify vague network operations and, for vague descriptions, can execute all enrichment steps. The network operation enrichment agent 4022 can use the final enrichments as context for classification.

The web search engine 4024 can be an external application programming interface or service, such as a You.com web search service, used to retrieve web results relevant to networked item descriptions or company information. The web search engine 4024 can provide web-based data to support enrichment and context generation. The web search engine 4024 can be invoked by the network operation enrichment agent 4022 to obtain web results, which may be summarized or cited in the classification workflow. The web search engine 4024 can retrieve information for networked item description enrichment by collecting relevant web snippets.

The LLM application programming interface 4026 can be an external service endpoint used to invoke large language models for summarization, explanation, or arbitration tasks. The LLM application programming interface 4026 can enable the system to leverage large language models for generating explanations, summaries, or resolving classification ambiguities. The LLM application programming interface 4026 can be called by backend agents or orchestrators to process prompts and return model outputs for use in the classification workflow. The LLM application programming interface 4026 can execute the large language model using the composite set of candidate classification codes and the retrieved description of each candidate classification code of the composite set of candidate classification codes to generate a selected candidate classification code from the composite set of candidate classification codes.

The FT Llama classifier 4028 can be a finetuned Llama model deployed as a service endpoint for generating classification code predictions. The FT Llama classifier 4028 can provide country-specific classification code predictions based on input data and enrichment. The FT Llama classifier 4028 can be invoked by backend services to process enriched prompts and output candidate classification codes and explanations. The FT Llama classifier 4028 can generate classification code predictions for multiple countries together. The FT Llama classifier 4028 can process input data including networked item description, importer and exporter names, relevant tariff definitions, network operation metadata, previous classification codes, and network operation enrichments, among others.

The FT Llama confidence model 4030 can be a finetuned Llama model endpoint dedicated to generating confidence scores for classification code predictions. The FT Llama confidence model 4030 can output confidence scores to inform acceptance, enrichment, or escalation workflows. The FT Llama confidence model 4030 can be called with input features or candidate classification codes and can return a confidence score for downstream decision-making. The FT Llama confidence model 4030 can generate confidence scores using log-probabilities or other statistical measures derived from the model's output distribution.

The FT Llama vagueness detector 4032 can be a finetuned Llama model endpoint for detecting vagueness in networked item descriptions. The FT Llama vagueness detector 4032 can identify vague or insufficient descriptions and trigger enrichment or review. The FT Llama vagueness detector 4032 can process input descriptions and return a vagueness score to the orchestrator or enrichment agent. The FT Llama vagueness detector 4032 can support confidence scoring, vagueness detection, and explanation generation.

The human input module 4029 can generate and present one or more questions in a user interface to solicit relevant and specific information from a user during a classification workflow. The human input module 4029 can generate multiple-choice questions, free response questions, or other types of prompts that request clarification regarding networked item details, network operation attributes, or other metadata relevant to the classification of a networked item. The human input module 4029 can receive responses to the generated questions from the user interface and store the responses in association with the corresponding classification task. The human input module 4029 can validate machine-generated reasoning and results by comparing the user-provided responses to the outputs of one or more machine learning models, such as a dual encoder with graph features, a hybrid search model, or a large language model, among others.

The confidence model 4030 can generate a confidence score for each candidate classification code produced by the FT Llama classifier 4028. The confidence model 4030 can receive as input a set of candidate classification codes and associated features, such as networked item description, importer and exporter names, and relevant network operation metadata. The confidence model 4030 can output a numerical confidence score for each candidate classification code, which may be used by the user interface 4008 to determine whether a classification is auto-accepted, flagged for review, or subjected to enrichment or escalation workflows, among others.

The user interface 4008 can display classification results, candidate classification codes, confidence scores, and explanations to a user. The user interface 4008 can provide interactive elements for reviewing, confirming, or overriding predicted classifications. The user interface 4008 can present additional insights for each classification, such as general rules of interpretation analysis, detailed explanations referencing official rulings, or summaries of networked item attributes, among others. The user interface 4008 can allow a user to export classification results as a comma-separated values file or a portable document format report.

The sequence 456 can represent a workflow or process for iterative generation of a classification using an agentic hierarchical architecture. The sequence 456 can include steps such as receiving input network operations, running multiple internal models, performing web enrichment, invoking a hierarchical HS selector agent, generating clarifying questions, and receiving user input, among others. The sequence 456 can coordinate the execution of the user interface 4008, the classifier 4016, the misclassifier 4014, the query agent 4018, the vagueness detector 4020, the network operation enrichment agent 4022, the web search engine 4024, the LLM application programming interface 4026, the FT Llama classifier 4028, the FT Llama confidence model 4030, and the FT Llama vagueness detector 4032 to generate and refine classification code predictions for networked item.

Referring now to FIG. 4I, illustrated is a flow diagram of a sequence 458 for iterative generation of a classification using an agentic hierarchical architecture, in accordance with some embodiments. The sequence 458 can include at least one user interface 4033, at least one classifier and misclassifier 4034, at least one metrics module 4031, at least one human input module 4029, at least one FT Llama large language model 4038, metrics 4036, at least one vagueness and enrichment module 4040, at least one vagueness detector 4042, at least one enrichment agent 4044, at least one web search engine 4046, at least one deep reasoning module 4048, and metrics 4050 and 4052.

The user interface 4033 can be a graphical user interface or web portal through which users may initiate and review classification tasks. The user interface 4033 can enable a user to submit classification requests, check misclassifications, and review outputs. In some implementations, the user interface 4033 may present a web-based dashboard for uploading networked item, reviewing classification predictions, and exporting results. The user interface 4033 can receive, from a computing device, a request comprising an identification of a networked item. In some implementations, the user interface 4033 may generate the user interface identifying the classification and the networked item for presentation at the computing device in response to a determination by the system. The user interface 4033 can collect user input, transmit requests to backend services, and display classification results and insights. For example, networked item stock keeping units may be uploaded to the trade compliance section via a comma-separated values file, and the user interface 4033 may present classification predictions and allow a user to review, confirm, or override the predicted classification, among others.

The classifier and misclassifier 4034 can be a machine learning model that may generate candidate classification codes and confidence scores for the classification codes for networked item based on input data. The classifier and misclassifier 4034 can include a dual encoder with graph features trained on data such as networked item descriptions, importer and exporter graph features, company NACE codes, and historical network operations, among others. The classifier and misclassifier 4034 can process input data to generate a set of top candidate classifications, associated confidence scores, and misclassification flags. In some implementations, the classifier and misclassifier 4034 may determine that a classification prediction for a historical networked item transport was a misclassification. The classifier and misclassifier 4034 can generate outputs by applying learned representations and graph-based features to the input data, and may interface with enrichment and vagueness detection modules to flag likely misclassifications for user review. For example, the classifier and misclassifier 4034 may leverage graph features including company NACE codes and training on companies' historical network operations to inform the classification code prediction for new network operations.

The metrics module 4031 can be a backend service or dashboard that aggregates statistics on classification volume, validation volume, and question volume. The metrics module 4031 can generate metrics such as additional volume classified, validation volume, or question volume, among others. For example, the metrics module 4031 can generate metrics including additional volume classified of 7 percent, validation volume of 4 percent, or question volume of 2 percent, among others. The metrics module 4031 can provide operational insights into the classification workflow by generating and storing statistics derived from classification events, validation events, and user interaction events. In some implementations, the metrics module 4031 can display such statistics in a user interface or dashboard for review by an operator of the system.

The metrics module 4031 can store a record of each classification prediction, the cause of the prediction, and an indication of any misclassification in a database. The metrics module 4031 can collect and display statistics from classification, validation, and user interaction events, and can feed such information into reporting and retraining workflows. In some implementations, the metrics module 4031 can surface misclassification insights in the user interface and can enable export of such insights in reports. The metrics module 4031 can thereby support quality assurance and process optimization by providing access to detailed metrics and misclassification records for downstream analysis or model improvement.

The human input module 4029 can generate and present one or more questions in a user interface to solicit relevant and specific information from a user during a classification workflow. The human input module 4029 can generate multiple-choice questions, free response questions, or other types of prompts that request clarification regarding networked item details, network operation attributes, or other metadata relevant to the classification of a networked item. In some implementations, the human input module 4029 can receive responses to the generated questions from the user interface and store the responses in association with the corresponding classification task. The human input module 4029 can validate machine-generated reasoning and results by comparing the user-provided responses to the outputs of one or more machine learning models, such as a dual encoder with graph features, a hybrid search model, or a large language model, among others. The human input module 4029 can determine whether the user-provided information resolves ambiguities in the classification process or whether additional clarification is required.

In some implementations, the human input module 4029 can integrate user responses into the classification workflow by updating the input features provided to the classification models or by generating enriched prompts for subsequent inference steps. The human input module 4029 can present follow-up questions in the user interface based on the responses received, enabling an iterative refinement of the classification prediction. The human input module 4029 can allow a user to revise or change previously provided answers, and may support web enrichment steps with user confirmation, for example, by presenting web-sourced networked item details for user validation before including such details in the classification workflow. The human input module 4029 can transmit the user-provided information to a task agent or other workflow component for further processing, such as re-executing a large language model using the updated information to generate a revised classification code. In some implementations, the human input module 4029 can receive the requested more information from the user interface of the computing device and can store the information in a transcript or message history for use in subsequent classification or audit operations.

The FT Llama large language model 4038 can be a finetuned Llama model deployed as a service endpoint for generating harmonized system (HS) code predictions, explanations, and confidence scores. The FT Llama large language model 4038 may receive as input a prompt comprising a networked item description, importer and exporter names, relevant tariff definitions, network operation metadata, previous classification codes, and/or network operation enrichments, among others. The FT Llama large language model 4038 can generate as output a set of country-specific classification code predictions, corresponding confidence scores, and textual explanations for each prediction. In some implementations, the FT Llama large language model 4038 may generate predictions for multiple countries together, such as by first generating a six-digit classification code prediction and subsequently generating country-specific predictions at greater levels of granularity, such as eight-digit, ten-digit, or twelve-digit classification codes, among others.

The FT Llama large language model 4038 can be trained based at least on identifications of the pairs of nodes and the classifications for the particular networked items from the edge data structure of each of the pairs of nodes in the network graph data structure. The FT Llama large language model 4038 may receive as training data a set of input-output pairs, where each input includes data representing a source node, a destination node, and one or more attributes of a networked item, and each output includes a label indicating a correct classification for the networked item. In some implementations, the FT Llama large language model 4038 may be further trained using continued pretraining on tariff definitions, general rules of interpretation, official tariff guides, and/or rulings for one or more countries, such as the United States or Canada, among others.

The FT Llama large language model 4038 can be further trained using supervised finetuning on a plurality of prediction tasks, such as predicting a top-1 classification code, predicting a top-5 classification code, predicting a single country classification code, predicting multi-country classification codes, predicting tariff definitions to code and vice versa, including top-5 hybrid search predicted tariff definitions as context in finetuning, predicting different types of explanations, translating classification codes between countries, detecting vagueness, generating material descriptions metadata, generating web-enriched descriptions, generating confidence scores, predicting misclassifications, and/or generating copilot sample interactions, among others. The FT Llama large language model 4038 may thereby generate output predictions that are aligned across multiple countries and levels of classification granularity.

The FT Llama large language model 4038 can support confidence scoring, vagueness detection, and explanation generation. In some implementations, the FT Llama large language model 4038 may generate a confidence score for each classification code prediction, such as by using log-probabilities or other statistical measures derived from the model's output distribution. The FT Llama large language model 4038 may generate a vagueness score for a networked item description, such as by detecting whether the description is vague, nonsensical, or web-enhanceable, among others. The FT Llama large language model 4038 may generate a textual explanation for each classification code prediction, such as by referencing tariff definitions, general rules of interpretation, official rulings, or graph-derived features, among others.

The FT Llama large language model 4038 can be invoked by backend services to process enriched prompts and output candidate classification codes, explanations, and confidence scores. In some implementations, a backend service may generate a prompt comprising features of the networked item including a networked item description, importer and exporter names, relevant tariff definitions, network operation metadata, previous classification codes, and/or network operation enrichments, among others, and transmit the prompt to the FT Llama large language model 4038 for inference. The FT Llama large language model 4038 may process the prompt and generate a set of candidate classification codes, corresponding confidence scores, and textual explanations, which may be returned to the backend service for further processing, storage, or presentation in a user interface.

The FT Llama large language model 4038 can be used in combination with other models and components of the classification system, such as a dual encoder with graph features, an ensemble model with hybrid search and a large language model arbiter, a copilot workflow for human-in-the-loop assisted classification, and/or network operation enrichment agents, among others. In some implementations, the FT Llama large language model 4038 may receive as input the output of a hybrid search module, such as a set of top candidate classification codes and corresponding tariff definitions, and may generate a final classification code prediction and explanation by arbitrating among the candidate classification codes.

The FT Llama large language model 4038 can support translation of classification codes between countries. In some implementations, the FT Llama large language model 4038 may receive as input an classification code for a first country and generate as output a corresponding classification code for a second country, such as by leveraging training data comprising aligned classification codes across multiple countries and levels of granularity. The FT Llama large language model 4038 may thereby facilitate cross-border trade compliance and classification workflows involving multiple countries of import or export.

The FT Llama large language model 4038 can be used to generate explanations and detailed insights for each classification, such as a general rules of interpretation analysis, a detailed explanation referencing official rulings, or a summary of networked item attributes, among others. In some implementations, the FT Llama large language model 4038 may generate a general rules of interpretation analysis and a detailed HS explanation analysis for supporting classification decisions, such as by referencing official rulings, audit trails, or assumptions made by the model. The FT Llama large language model 4038 may thereby reduce the burden and time of generating explainability for auditing or compliance purposes.

The FT Llama large language model 4038 can be used to generate misclassification flags and likelihood or impact assessments for predicted classification codes. In some implementations, the FT Llama large language model 4038 may generate a flag indicating a likely misclassification, a likelihood score, and/or an impact score for a predicted classification code, such as by comparing the predicted code to historical network operation data, known error cases, or regulatory risk indicators, among others. The FT Llama large language model 4038 may thereby facilitate prioritization and remediation of incorrectly classified networked items in trade compliance workflows.

The FT Llama large language model 4038 can be invoked as part of a copilot workflow for human-in-the-loop assisted classification. In some implementations, the FT Llama large language model 4038 may generate predictions iteratively at different HS levels, such as HS2, HS4, HS6, HS8, HS10, HS12, among others, and may generate multiple-choice or free response questions to solicit relevant and specific information from a user during the classification workflow. The FT Llama large language model 4038 may receive user responses and update its predictions, explanations, and confidence scores accordingly, thereby facilitating collaborative and interactive classification workflows in trade compliance systems.

FIG. 4J illustrates an example user interface showing confidence scores for different classifications for an item, in accordance with one or more embodiments. The example user interface can provide features such as generating suggestions for decision making, global HS 6, US HS 10, and Canada HS 10 auto-classification, misclassification detection with likelihood and impact, incorporation of all up-to-date standards and rulings, large language model-generated general rules of interpretation (GRI) explanations including customs rulings online search system (CROSS) rulings, and web-enriched networked item description for improved classification outcomes.

FIG. 4K illustrates an example user interface showing an explanation behind the confidence score for a classification for an item, in accordance with one or more embodiments. The example user interface can provide Large Language Model-generated Detailed Explanation and General Rules of Interpretation (GRI) Interpretation from Accepted Classifications reduce the burden and manual time of writing out explainability for auditing. The ‘Explain This Classification’ feature can output a GRI analysis and a detailed HS explanation analysis for supporting classification decisions. The user interface can provide references rulings for auditability, the ability to override or edit all detailed explanations, and configurable Classification Reporting that includes explanations. The classification and explanation model can be trained on and use at prediction time classifications done by brokers using relevant sources (CROSS, GRI, etc.) and a Quality Assurance team includes Licensed Customs Brokers who leverage their subject matter expertise and rulings as training feedback to the model. The explanation model is an agentic system that recursively investigates relevant rulings, past classifications, and the underlying trading and graph information to produce a reliable and accurate classification.

FIG. 4L illustrates an example user interface showing chatbot assisted classification, in accordance with one or more embodiments. The example user interface can provide the ability to interact with a chatbot to generate classifications for items. For example, not all classifications can be provided automatically without user clarification. To account for this, the data processing system 306 can provide a chatbot provides the ability for chapter-level prediction, grouping, and elimination for expedited classification and assisted workflows; automated web-enrichment with user confirmations for networked item clarification, which can save time of manual searches; and reversibility to accommodate changing answers.

FIGS. 4M-4BB illustrate a sequence of user interfaces 468-486 for implementing the systems and methods described herein to classify a set of items, in accordance with one or more embodiments. In the user interface 468, the left side sidebar can be used to navigate through different sections of the platform provided by the data processing system. For classification, a user can select the “Trade compliance” section. Responsive to the selection, in the user interface 470, a user can upload one or more networked item stock-keeping units (SKUs). The networked item SKUs can be uploaded via a CSV file. In some cases, the data processing system may restrict the number of SKUs that can be uploaded to a threshold (e.g., 999). To upload the SKUs, the user can select “upload entry” and then “select file” to choose a CSV to upload. The user can select a CSV template to download a template CSV for the upload, in some cases. In some embodiments, the item identifications can be uploaded via techniques, such as application programming interfaces, the user interface, etc.

The user interface 472 illustrates an example CSV file. The CSV file can include at least an item description column and a country of import column. In some cases, the CSV file can include a name of a source node and/or a destination node (e.g., a sender and/or receiver) name and/or address. The data processing system 306 can use such information to retrieve data from the network graph data structure 336 for classification.

The user interface 474 illustrates a table including information regarding the items listed in the CSV file illustrated in the user interface 472 after the CSV file has been uploaded. The user interface 474 can include a list of networked items, classifications for the networked items, and/or reports regarding the uploaded CSV file.

The user interface 476 illustrates a table after selection of the classification tab included in the user interface 474. The user interface 476 can include classifications for the items in the CSV file and three different statuses for such classifications. The statuses can be, for example, (1) classified, which can indicate the confidence in a predicted classification and that data processing system 306 is “auto-classifying” the items, (2) likely misclassified, which can indicate that the data processing system 306 has determined that the classification uploaded is likely incorrect and is confident in a different classification for the item, and (3) needs classification, which can indicate that the data processing system 306 is not confident enough in its classification, and needs a human in the loop or further context (e.g., from another data source across a network) to complete classification.

The user interface 478 illustrates the table of the user interface 476 but with further information about a selected item. The user interface 478 can be generated after a user selects an item from the table to view in-depth predictions and/or information for classification. The in-depth information can include, for example, the top predicted classifications for the item description. For instance, the data processing system 306 can generate confidence scores for different classifications for the selected item. The data processing system 306 can identify a defined number of classification for the item with the highest confidence scores and present them on the user interface 478. In some cases, a user can select an option from the top predicted classifications to indicate which classification to use for the selected item.

The user interface 480 illustrates a user interface that a user can use to manually input a classification for a selected item. The user can enter the classification by scrolling to the bottom of the depicted information of the user interface 478 and selected the button “Enter Code Manually.”

The user interface 482 illustrates an explanation button that provides ability for users to view the reasoning behind a classification. A user can select the button and the data processing system 306 can present an interpretation (e.g., GRI interpretation) and detailed explanation for the classification.

The user interface 484 illustrates insights regarding the classification for the item. The user interface 484 may be presented upon selection of the explanation button from the user interface 482. The user interface 484 can illustrate the potential PGAs the item may be subject to, the interpretation (e.g., GRI interpretation) for the item generated by the data processing system 306, and/or a detailed explanation generated by the data processing system 306 indicating how the classification was determined, which may include CROSS rulings and/or assumptions made by the data processing system.

The user interface 486 illustrates the capabilities for a user to export the classifications generated by the data processing system 306. A user can select relevant items to export. The user can then select the option “Export Selected” and select a type of output for the export of a CSV file or a PDF report. The data processing system 306 can perform the selected export according to the selections.

FIGS. 4CC and 4DD illustrate a user interface 488 including a chat interface. A user can communicate with the data processing system 306 through the chat interface that the data processing system 306 provides through the data processing system 306's platform. As illustrated, the data processing system 306 can generate questions and/or otherwise ask the user questions about items that the data processing system 306 is classifying. The data processing system 306 can do so using a large language model. The user can provide answers to the questions as inputs into the chat interface. The data processing system 306 can use the answers to generate classifications for the items. In some cases, multiple users can chat together and provide inputs for the same conversation to each other and/or to the large language model to generate classifications for items. The data processing system 306 can use the large language model and/or the chat interface to perform any other operations on the platform provided by the data processing system 306, such as navigating the platform, correcting misclassifications, updating the network graph data structure maintained by the data processing system 306, etc. In some cases, the users can collaborate with the large language model as an agent and each other to ensure correct classification, that the regulator can receive submitted classifications, audit with the same system, and interact with the private sector users to request more info, ensure correction of classifications, etc.

In one example, the data processing system 306 can use a machine learning architecture to operate as an agentic artificial intelligence customs broker. For instance, the data processing system 306 can support tariff classification, vague description enrichment, interactive assistance, and legal justification using artificial intelligence models that were trained on and backed by the network graph data structure. In some cases, the data processing system 306 can support tariff simulation, country of origin determination, and/or free-trade agreement origin determination. The data processing system 306 use the artificial intelligence models that leverages the stored network graph data structure that represents the global trade system, a massive item network connecting buyers, suppliers, insurers, trade financiers, and governments. By implementing generative artificial intelligence and agentic systems, the data processing system 306 can operate as a trusted advisor and assistant. The artificial intelligence models of the system may be specially trained on the data of the network graph data structure representing the global supply chain. The data processing system 306 can operate based on data across the value chain, operating securely, privately, and reliably on a federated item network that operates as shared source of truth. The data processing system 306 can learn and constantly improve from feedback across the public and private sector.

In some cases, the data processing system 306 can provide a multi-tenant enterprise-licensing solution provider (LSP) experience for collaborative workflows, including item clarification. In the experience, individuals or entities can be authenticated to broker's spoke with respective roles, permissions, and visibility. The data processing system can maintain information security standards and federated learning environments to avoid passing unauthorized information between spokes. Both the broker and clients can initiate and collaborate simultaneously on a copilot workflow for faster classification outcomes, such as by communicating with the large language model and/or other models maintained by the data processing system 306 for item classification. The data processing system 306 can assign/tag other entities or individuals to jobs and/or questions. The data processing system 306 can use the large language model to generate and maintain a question and answer thread with an audit trail of the conversation and a timestamp that can later be referenced during an inquiry into the reasoning for a particular classification for an item.

Referring now to FIG. 4EE, depicted is a flowchart illustrating a sequence 4054 of classifying an item using a combination of classification models, large language models, and network graph data updates. A data processing system, such as the data processing system 306 or any other computing device as described herein, can perform the sequence 4054. The sequence 4054 can include any number of operations, and the operations can be performed in any order. In some cases, a task agent (e.g., the model 333) can perform the operations 4058-4068 to facilitate execution of different software modules and/or models, such as large language models. By performing the sequence 4054, a computing system may facilitate automated classification of a networked item using a large language model, thereby reducing hallucinations of the output of the large language model.

At operation 4056, the data processing system receives a request comprising an identification of an item. Receiving the request may involve obtaining, at a server or data processing system, a message or data structure that includes an identifier for a networked item to be classified. For example, the request may be received from a remote computing device or user interface, and may specify an item for which a classification is to be generated. This operation may occur as an initial step, prior to any classification processing, and may be triggered by an external event such as a file upload or API call. For instance, the request may be received when a user uploads a CSV file containing item descriptions to a user interface. The request may be parsed to extract the item identifier, which may be used as input for subsequent model execution and graph traversal. For example, the system may extract a networked item description, stock keeping unit, or other unique identifier from the request for downstream processing.

At operation 4058, the data processing system executes a classification model. Executing the classification model can involve running a machine learning model, such as a dual encoder or neural network, to generate candidate classification codes for the identified item. For example, the classification model may receive as input the item description, source node, and/or destination node, and output a set of candidate classification codes and corresponding confidence scores. This step can occur after the request is received and the item identifier is extracted, and may be performed in parallel with or prior to large language model execution. For instance, the classification model may be invoked immediately after parsing the request, generating an initial prediction for the item. The classification model can process input features using learned representations and graph-based context to output candidate classification codes. For example, the model may leverage company NACE codes and historical network operation data to inform the prediction.

At operation 4060, the data processing system executes a large language model. Executing the large language model can involve running a generative neural network model or transformer to generate a second set of candidate classification codes for the networked item. For example, a finetuned Llama model may be executed using the networked item description and network operation metadata to output candidate classification codes and explanations. This step can occur after or in parallel with the execution of the classification model, and may use the same or similar input features. For instance, the large language model may be invoked after the classification model, generating an alternative prediction for the networked item. The large language model can process enriched prompts containing network operation and item metadata to generate candidate classification codes. For example, the model may use prompt templates including source and destination names, tariff definitions, and shipment metadata.

At operation 4062, the data processing system generates a composite set of candidate classification codes. The composite set of candidate classification codes can be a vector or a string identifying or including the first and/or second set of classification codes. Generating the composite set can involve combining the outputs of the classification model and the large language model to form a unified set of candidate classification codes. For example, the composite set may include all unique codes from both models, or may be formed by concatenating the two sets and removing duplicates. This step can occur after both models have generated their respective candidate classification codes, and may be performed prior to code description retrieval or arbitration. For instance, the system may generate the composite set immediately after receiving outputs from both models, preparing for downstream arbitration or selection. The composite set can be generated by comparing the candidate classification codes from each model and forming a list of unique candidates for further evaluation. For example, the system may identify codes present in both outputs and flag them for increased weighting in subsequent arbitration.

At operation 4064, the data processing system retrieves a description of each candidate classification code. Retrieving a description can involve obtaining, from a database or external source, textual or structured definitions for each candidate classification code in the composite set. For example, the system may query a tariff database to retrieve official or derived definitions for each code. This step can occur after the composite set is generated, and may be performed prior to final code selection or arbitration by the large language model. For instance, the system may retrieve code descriptions immediately after forming the composite set, appending them to the prompt for the next model execution. The descriptions can be retrieved by using the candidate classification codes as keys to search the database, and concatenating the results with the composite set for input to the large language model. For example, the system may retrieve both official tariff definitions and large language model-generated summaries for each code.

At operation 4066, the data processing system executes the large language model. Executing the large language model at this stage can involve running the model using the composite set of candidate classification codes and their descriptions to select a final classification code. For example, the large language model may receive as input the composite set and code descriptions, and output a selected code and explanation. This step can occur after code descriptions are retrieved, and may serve as an arbitration or selection phase to determine the most appropriate code. For instance, the model may be executed immediately after the composite set and descriptions are prepared, generating the final code for the item. The model can process the input prompt, evaluate the candidate classification codes and their definitions, and select a code based on context and model outputs. For example, the model may generate a confidence score and explanation for the selected code, referencing relevant tariff definitions and item attributes.

At operation 4068, the data processing system updates the network graph data structure. Updating the network graph data structure can involve storing the selected classification code in the appropriate edge or node of the network graph representing the item network operation. For example, the system may insert the selected code into a field-value pair of the edge data structure corresponding to the item's network operation. This step can occur after the final code is selected by the large language model, and may be the concluding operation of the classification workflow. For instance, the system may update the graph data structure immediately after code selection, persisting the result for future analytics or compliance reporting. The update can be performed by identifying the relevant edge or node in the graph, and writing the selected code and any associated metadata to the data structure. For example, the system may update the edge data structure for a shipment network operation to include the new classification code, confidence score, and explanation.

In one illustrative embodiment, a server-based data processing system is configured to reduce hallucinations during machine-assisted classification of networked items by integrating graph-grounded relationship data with combined outputs from multiple classification engines. The server stores in memory a network graph data structure consisting of nodes representing entities and networked items, and edges representing relationships and operations between these entities. Each edge connecting a pair of nodes includes, among other fields, one or more classification codes associated with an identified networked item transferred from a source entity associated with a source node to a destination entity associated with a destination node. The system additionally stores and executes a classification model capable of independently generating candidate classification codes based solely on an identifier for a networked item, a large language model (LLM) trained with source-destination pair identifications and corresponding ground truth classifications from the network graph, and a task agent that orchestrates communication between the models and the network graph for classification decision-making.

Upon receiving, from a remote computing device, a request comprising an identification of a networked item, the data processing system executes its task agent. The task agent first uses the identification as input to the classification model to produce a first set of candidate classification codes. The same networked item identification is then provided to the large language model, which generates a second set of candidate classification codes based on its trained understanding of classification domains and the relationships contained in the network graph. The task agent aggregates these outputs into a composite set of candidate classification codes by combining the unique suggestions from both sets. This composite set is then used as a narrowed, fact-grounded candidate pool.

The task agent proceeds to retrieve descriptive metadata for each classification code in the composite set from a classification code reference database. Such descriptions may include regulatory definitions, networked item scope boundaries, or contextual usage examples. Using both the composite set and the retrieved descriptions, the task agent constructs an input prompt for the large language model to score, rank, and select a single best-fit classification code from the candidate pool. For example, where the networked item is identified as a “Precision Optical Sensor,” and both models have proposed overlapping and distinct codes from different manufacturing standards hierarchies, the LLM evaluates both semantic relevance and graph-derived relationship context to choose the most probable correct classification.

In some cases, the classification task may require hierarchical navigation through layered classification schemes, such as multi-tier industry standard taxonomies. If the task agent determines that an initial selection at a first layer is insufficient for the classification depth required by the requesting entity, the task agent generates a refined second composite set by invoking both the classification model and LLM again, now targeting candidate classification codes corresponding specifically to the next layer in the hierarchy. This iterative approach continues until either the required layer in the hierarchy is reached. The system can apply such iterative refinement based on whether the entity associated with the computing device operates at a broader or narrower layer within the classification structure.

If the large language model cannot unambiguously select a final classification code from the composite set and descriptions for a layer, the task agent uses the LLM to generate a clarifying question. This question is transmitted to the user interface of the remote computing device for human guidance (e.g., “Does the optical sensor include an integrated autofocus motor?”). Upon receiving the user's answer, the task agent re-executes the LLM with the supplemental information, the composite code set, and the associated descriptions to produce a final selected classification code for the layer. This conversational refinement can also preserve prior dialog messages, enabling context-rich re-execution to improve accuracy compare with other systems.

Once the final classification code for the final layer is selected, the task agent updates the network graph data structure to store the determined classification directly within the edge data structure connecting the corresponding source and destination nodes of the associated networked item network operation. This record may also be stored in alignment with the correct hierarchical layer for that classification code, ensuring compatibility with structured analytics. Over time, the accumulation of precise, graph-anchored classification data from this system fosters continuous enrichment of both the LLM and classification model training sets, thereby reinforcing the reduction of hallucinations and blocking spurious or contextually irrelevant code selections in future classification workflows.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the networked items listed thereafter, equivalents thereof, and additional networked items, as well as alternate implementations consisting of the networked items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional networked items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system for reduced hallucination classification by constraining a large language model based on a network graph data structure, comprising:
a server comprising, in memory:
a network graph data structure storing a network of nodes and edges between the network of nodes, the network graph data structure digitally representing types of relationships between entities represented by the network of nodes and networked items,
the network of nodes comprising pairs of nodes each including a source node connected with a destination node by an edge data structure including at least a classification for a particular networked item transferred from a source entity of the source node to a destination entity of the destination node;
a classification model configured to generate candidate classification codes for networked items based at least on identifications of the networked items;
a large language model trained based at least on identifications of the pairs of nodes and the classifications for the particular networked items from the edge data structure of each of the pairs of nodes in the network graph data structure; and
a task agent in communication with the network graph data structure, the classification model, and the large language model; and
the server configured to:
receive, from a computing device, a request comprising an identification of a networked item;
execute the task agent to:
execute the classification model using the identification of the networked item as input to generate a first set of candidate classification codes;
execute the large language model using the identification of the networked item to generate a second set of candidate classification codes;
generate a composite set of candidate classification codes using the first set of candidate classification codes and the second set of candidate classification codes;
retrieve a description of each candidate classification code of the composite set of candidate classification codes from a database;
execute the large language model using the composite set of candidate classification codes and the retrieved description of each candidate classification code of the composite set of candidate classification codes to generate a selected candidate classification code from the composite set of candidate classification codes; and
update the network graph data structure to identify the selected candidate classification code for the networked item.

2. The system of claim 1, wherein the classification model is a dual encoder architecture,
wherein the server is configured to receive the request by:
receiving the request comprising the identification of the networked item, an identification of a source node and a destination node of a pair of nodes of a network operation involving the networked item, and a text description of the networked item, and
wherein the server is configured to execute the task agent to execute the dual encoder architecture and execute the large language model each using the identification of the networked item, the identification of the source node and the destination node of the pair of nodes of the network operation involving the networked item, and the text description of the networked item.

3. The system of claim 1, wherein the server is configured to execute the task agent to:
execute a querying agent using the identification of the networked item to identify an edge data structure in the network graph data structure corresponding to a network operation involving the networked item between a source node and a destination node of a pair of nodes of the network graph data structure;
identify, based on the execution and from the identified edge data structure, an identification of the source node and the destination node of the pair of nodes of the network operation involving the networked item, and a text description of the networked item; and
wherein the server is configured to execute the task agent to execute the classification model and execute the large language model each using the identification of the networked item, the identification of the source node and the destination node of the pair of nodes of the network operation involving the networked item, and the text description of the networked item.

4. The system of claim 1, wherein the server is configured to execute the task agent to execute the large language model to generate the selected candidate classification code by executing the task agent to:
execute the large language model using the composite set of candidate classification codes and the retrieved description of each of candidate classification code of the composite set of candidate classification codes to generate a first candidate classification code at a first layer of a plurality of defined layers of a hierarchical data structure;
determine to generate a second candidate classification code at a second layer of the plurality of defined layers of the hierarchical data structure;
responsive to the determination, generate a second composite set of candidate classification codes using a second classification model and the large language model using the identification of the networked item, each of second composite set of candidate classification codes corresponding to the second layer of the plurality of defined layers of the hierarchical data structure; and
execute the large language model using the second composite set of candidate classification codes to generate the selected candidate classification code.

5. The system of claim 4, wherein the server is configured to execute the task agent to determine to generate the second candidate classification code by executing the task agent to:
determine a layer of the hierarchical data structure that corresponds to an entity of the computing device; and
determine the layer of the hierarchical data structure is higher than the first layer of the first candidate classification code.

6. The system of claim 5, wherein the server is configured to execute the task agent to execute the large language model to generate the selected candidate classification code by executing the task agent to:
iteratively generate candidate classification codes for the networked item at increasing layers of the hierarchical data structure until determining a current layer of the generated candidate classification code is at the layer of the hierarchical data structure that corresponds to the entity of the computing device.

7. The system of claim 1, wherein the server is configured to execute the task agent to execute the large language model to generate the selected candidate classification code by executing the task agent to:
execute, through a large language model application programming interface (API), the large language model using the composite set of candidate classification codes and the retrieved description of each of candidate classification code of the composite set of candidate classification codes as input to generate a question requesting more information about the networked item based on a determination by the large language model that a classification code could not be selected based on the input;
receive data including the question from the large language model through the large language model API;
responsive to determining the data includes the question instead of a selected classification code, transmit the question for presentation on a user interface presented at the computing device;
receive the requested more information from the user interface of the computing device; and
re-execute the large language model using the received requested more information, the composite set of candidate classification codes, and the retrieved description of each of candidate classification code of the composite set of candidate classification codes to generate the selected candidate classification code.

8. The system of claim 7, wherein the server is configured to execute the task agent to re-execute the large language model using the requested more information and one or more messages previously generated by the large language model in a transcript of messages generated by and input into the large language model regarding generating the selected candidate classification code.

9. The system of claim 1, wherein the server is configured to execute the task agent to update the network graph data structure by:
identifying an edge data structure corresponding to a network operation involving the networked item; and
inserting the selected candidate classification code in a field-value pair of the edge data structure corresponding to classification codes.

10. The system of claim 9, wherein the server is configured to execute the task agent to update the network graph data structure by:
identifying the field-value pair of the edge data structure based on the field-value pair corresponding to a layer of a plurality of defined layers of a hierarchical data structure that corresponds to an entity of the computing device.

11. The system of claim 1, wherein the server is configured to execute the task agent to generate the composite set of candidate classification codes by:
concatenating the first set of candidate classification codes and the second set of candidate classification codes into a prompt text string; and
wherein the server is configured to execute the task agent to provide the prompt text string into the large language model through a large language model application programming interface (API).

12. The system of claim 1, wherein the server is configured to execute the task agent to generate the composite set of candidate classification codes by:
identifying a set of common candidate classification codes between the first set of candidate classification codes and the second set of candidate classification codes and a set of unique candidate classification codes between the first set of candidate classification codes and the second set of candidate classification codes; and
only including the unique candidate classification codes between the first set of candidate classification codes and the second set of candidate classification codes in the composite set of candidate classification codes.

13. The system of claim 1, wherein the server is configured to receive the request by:
receiving the request comprising the identification of the networked item and an identification of a geographic location, and
wherein the server is configured to execute the task agent to execute the classification model and execute the large language model each using the identification of the networked item and the identification of the geographic location.

14. The system of claim 1, wherein the server is further configured to:
determine that a classification prediction for a historical networked item transport was a misclassification;
store a record of the classification prediction, the cause of the prediction, and an indication of the misclassification in a database; and
execute the large language model using the composite set of candidate classification codes and the retrieved description of each candidate classification code, or the classification model using the identification of the networked item as input, based on the stored indication of the misclassification.

15. A method for reduced hallucination classification using a large language model based on a network graph data structure, comprising:
receiving, by one or more processors from a computing device, a request comprising an identification of a networked item;
executing, by the one or more processors executing a task agent in communication with the network graph data structure, the classification model, and the large language model, a classification model using the identification of the networked item as input to generate a first set of candidate classification codes for the networked item, the classification model configured to generate candidate classification codes for networked items based at least on identifications of the networked items;
executing, by the one or more processors executing the task agent, a large language model using the identification of the networked item to generate a second set of candidate classification codes for the networked item, the large language model trained based at least on identifications of pairs of nodes and classifications for particular networked items from edge data structure of each of the pairs of nodes in a network graph data structure;
generating, by the one or more processors executing the task agent, a composite set of candidate classification codes using the first set of candidate classification codes and the second set of candidate classification codes;
retrieving, by the one or more processors executing the task agent, a description of each candidate classification code of the composite set of candidate classification codes from a database;
executing, by the one or more processors executing the task agent, the large language model using the composite set of candidate classification codes and the retrieved description of each of candidate classification code of the composite set of candidate classification codes to generate a selected candidate classification code from the composite set of candidate classification codes; and
updating, by the one or more processors executing the task agent, the network graph data structure to identify the selected candidate classification code for the networked item.

16. The method of claim 15, wherein receiving the request comprises:
receiving, by the one or more processors, the request comprising the identification of the networked item, an identification of a source node and a destination node of a pair of nodes of a network operation involving the networked item, and a text description of the networked item, and
wherein executing the task agent to execute the classification model and execute the large language model comprises executing the task agent to execute the classification model and execute the large language model each using the identification of the networked item, the identification of the source node and the destination node of the pair of nodes of the network operation involving the networked item, and the text description of the networked item.

17. The method of claim 15, comprises executing the task agent to:
execute a querying agent using the identification of the networked item to identify an edge data structure in the network graph data structure corresponding to a network operation involving the networked item between a source node and a destination node of a pair of nodes of the network graph data structure;
identify, based on the execution of the querying agent and from the identified edge data structure, an identification of the source node and the destination node of the pair of nodes of the network operation involving the networked item, and a text description of the networked item; and
wherein executing the task agent to execute the classification model and execute the large language model comprises executing the task agent to execute the classification model and execute the large language model each using the identification of the networked item, the identification of the source node and the destination node of the pair of nodes of the network operation involving the networked item, and the text description of the networked item.

18. The method of claim 15, wherein executing the task agent to execute the large language model to generate the selected candidate classification code comprises executing the task agent to:
execute the large language model using the composite set of candidate classification codes and the retrieved description of each of candidate classification code of the composite set of candidate classification codes to generate a first candidate classification code at a first layer of a plurality of defined layers of a hierarchical data structure;
determine to generate a second candidate classification code at a second layer of the plurality of defined layers of the hierarchical data structure;
responsive to the determination, generate a second composite set of candidate classification codes using a second classification model and the large language model using the identification of the networked item, each of second composite set of candidate classification codes corresponding to the second layer of the plurality of defined layers of the hierarchical data structure; and
execute the large language model using the second composite set of candidate classification codes to generate the selected candidate classification code.

19. A non-transitory computer-readable medium comprising instructions that, when executed by one or more processors, cause the one or more processors to:
receive, from a computing device, a request comprising an identification of a networked item;
execute a task agent in communication with a network graph data structure, a classification model, and a large language model, to:
execute the classification model using the identification of the networked item as input to generate a first set of candidate classification codes for the networked item, the classification model configured to generate candidate classification codes for networked items based at least on identifications of the networked items;
executing, by the one or more processors executing the task agent, the large language model using the identification of the networked item to generate a second set of candidate classification codes for the networked item, the large language model trained based at least on identifications of pairs of nodes and classifications for particular networked items from edge data structure of each of the pairs of nodes in a network graph data structure;
generate a composite set of candidate classification codes using the first set of candidate classification codes and the second set of candidate classification codes;
retrieve a description of each candidate classification code of the composite set of candidate classification codes from a database;
execute the large language model using the composite set of candidate classification codes and the retrieved description of each of candidate classification code of the composite set of candidate classification codes to generate a selected candidate classification code from the composite set of candidate classification codes; and
update the network graph data structure to identify the selected candidate classification code for the networked item.

20. The non-transitory computer-readable medium of claim 19, wherein executing the instructions causes the one or more processors to receive the request by:
receiving the request comprising the identification of the networked item, an identification of a source node and a destination node of a pair of nodes of a network operation involving the networked item, and a text description of the networked item, and
wherein executing the instructions causes the one or more processors to execute the task agent to execute the classification model and execute the large language model comprises executing the task agent to execute the classification model and execute the large language model each using the identification of the networked item, the identification of the source node and the destination node of the pair of nodes of the network operation involving the networked item, and the text description of the networked item.
